(19) United States
(12) Patent Application Publication
(10) Pub. No.: US 2012/0118722 A1
(43) Pub. Date: May 17, 2012

(54) HEAT EXCHANGER SYSTEM AND METHOD OF USE

(76) Inventors: Mark T. HOLTZAPPLE, College Station, TX (US); Jorge R. Lara, College Station, TX (US)

(21) Appl. No.: 13/294,970

(22) Filed: Nov. 11, 2011

Related U.S. Application Data
(60) Provisional application No. 61/413,265, filed on Nov. 12, 2010.

(51) Int. Cl. F28F 1/00; C02F 1/04; F28D 15/00; F28F 13/12; F28F 13/18

(52) U.S. Cl. 203/11; 165/172; 165/109.1; 165/133; 165/104.11; 165/104.13

(57) ABSTRACT

Herein disclosed is a heat exchanger. The heat exchanger comprises at least one pipe having a centerline, an inlet and an outlet; and a multiplicity of tubes, wherein each tube comprises a centerline, an inner surface, an outer surface, and groves; wherein the multiplicity of tubes are placed inside the pipe and the centerline of each tube is perpendicular to the centerline of the pipe. Herein also disclosed is a heat exchange system. Such a system comprises the heat exchanger as described herein, wherein the heat exchanger is configured to receive an incoming feed stream and to discharge a vapor stream. Herein also described is a process that utilizes the heat exchanger disclosed herein. Such a process comprises the separation of a volatile component from a non-volatile component in a mixture. In some cases, the non-volatile component comprises a salt or a sugar and the volatile component comprises water.

### CROSS-REFERENCE TO RELATED APPLICATIONS

This application claims the benefit under 35 U.S.C. §119(e) of U.S. Provisional Patent Application No. 61/413,265 filed Nov. 12, 2010, the disclosure of which is hereby incorporated herein by reference.

### STATEMENT REGARDING FEDERALLY SPONSORED RESEARCH OR DEVELOPMENT

Not applicable.

### BACKGROUND

This invention generally relates to heat exchange systems. More particularly, this invention relates to heat exchanger designs that enhance heat transfer coefficients.

### SUMMARY

Herein disclosed is a heat exchanger comprising at least one pipe having a centerline, an inlet and an outlet; and a multiplicity of tubes, wherein each tube comprises a centerline, an inner surface, an outer surface, and groves in the direction of the centerline of the tubes; wherein the multiplicity of tubes are placed inside the pipe and the centerline of each tube is perpendicular to the centerline of the pipe. In some embodiments, the thickness of the tube wall is no greater than 0.01 inch. In some embodiments, the pipe is set up horizontally.

In some embodiments, the heat exchanger comprises a multiplicity of baffles wherein the spacing between the baffles decreases in the direction of from the inlet to the outlet of the pipe. In some embodiments, the tubes are made of a metal or alloy with a thermal conductivity that is no less than that of copper. In some cases, it is allowable to use alloys with a thermal conductivity less than copper, such as naval brass.

In some embodiments, the heat exchanger further comprises a galvanic protection mechanism. In some embodiments, the heat exchanger further comprises a hydrophobic coating on the outer surface of each of the tubes or on both the inner surface and the outer surface of each of the tubes. In some embodiments, the hydrophobic coating comprises electroless nickel (Ni) or carbon nanotubes or both. In some cases, the hydrophobic coating further comprises Teflon (PTFE), phosphorous (P), boron (B), boron nitride (BN), silica (Si), or combinations thereof. In some cases, the hydrophobic coating comprises Ni-PTFE, Ni—P-PTFE, Ni—B-PTFE, Ni—P—BN, or Ni—B—BN.

In some embodiments, the heat exchanger further comprises a jet ejector. In some embodiments, the jet ejector is on the liquid-phase side. In some embodiments, the heat exchanger further comprises inflatable seals. In some embodiments, the inner surface of the tubes comprises sand-blasted surface. In some embodiments, the heat exchanger further comprises boiling chips placed inside of the tubes during use of the heat exchangers. In some embodiments, the heat exchanger comprises both the sand-blasted surface on the inner surface of the tubes and the boiling chips during use.

In some embodiments, the heat exchanger further comprises a multiplicity of fittings configured to attach each of the tubes to a tube sheet, wherein the fitting comprises an attaching mechanism configured to attach the fitting to each of the tubes; and a penetration mechanism configured to penetrate the tube sheet, wherein the penetration mechanism comprises a sealing mechanism and a securing mechanism.

In some embodiments, the tubes are replaced with plates having a top surface and a bottom surface. In some embodiments, the plates have dimples. In some embodiments, the heat exchanger comprises a hydrophobic coating on the top surface or on both the top surface and the bottom surface of each of the plates. In some embodiments, the bottom surface of each of the plates comprises sand-blasted surface.

In some embodiments, the heat exchanger further comprises a nucleation promoter. In some embodiments, the nucleation promoter comprises a salt nucleation promoter or a sugar nucleation promoter.

Also disclosed herein is a heat exchange system comprising the heat exchanger disclosed herein, wherein the heat exchanger is configured to receive an incoming feed stream and to discharge a vapor stream. In some embodiments, the heat exchange system further comprises a nucleation promoter fluidly connected to the heat exchanger. In some embodiments, the heat exchange system further comprises a filter utilized in conjunction with the boiling chips. In some embodiments, at least a portion of the discharged vapor stream from the heat exchanger exchanges heat with the incoming feed stream or is mixed with the incoming feed stream or both.

In some embodiments, the heat exchange system further comprises a jet ejector configured to promote vapor circulation. In some embodiments, the heat exchange system further comprises a preheater configured to receive the incoming feed stream upstream of the heat exchanger and to receive the discharged vapor stream from the heat exchanger, wherein the incoming feed stream is heated by the discharged vapor stream.

Disclosed further is a process wherein the heat exchanger as disclosed herein is utilized. In some embodiments, such a process comprises separation of a volatile component from a non-volatile component in a mixture. In some embodiments, the non-volatile component comprises a salt or a sugar. In some embodiments, the volatile component comprises water. In some embodiments, dropwise condensation occurs in the process. In some embodiments, desalination takes place. In some embodiments, the process comprises liquid-gas separation.

Herein disclosed is a method of using a heat exchanger, wherein an aqueous solution and steam are present in the heat exchanger; wherein the heat exchanger comprises a hydrophobic coating; and wherein the operating pressure of the heat exchanger is greater than 50 psia. In some embodiments, the hydrophobic coating comprises electroless nickel (Ni) or carbon nanotubes or both. In some cases, the hydrophobic coating further comprises Teflon (PTFE), phosphorous (P), boron (B), boron nitride (BN), silica (Si), or combinations thereof. In some cases, the hydrophobic coating comprises Ni-PTFE, Ni—P-PTFE, Ni—B-PTFE, Ni—P—BN, or Ni—B—BN.

In some embodiments, the hydrophobic coating is exposed to the steam in the heat exchanger. In some embodiments, the hydrophobic coating promotes drop-wise condensation.

In some embodiments, the method further comprises utilizing a nucleation promoter. In some embodiments, the method further comprises utilizing boiling chips in conjunction with a filter. In some embodiments, the method further comprises discharging steam from the heat exchanger; and utilizing at least a portion of the discharged steam to preheat the aqueous solution or mixing at least a portion of the discharged steam with the aqueous solution or both. In some embodiments, the method further comprises utilizing a jet ejector on the solution side or a jet ejector to promote steam circulation or both.

Herein also disclosed is a method of using a heat exchanger, wherein a vapor phase and a liquid phase are present in the heat exchanger; wherein the heat exchanger comprises a hydrophobic coating; and wherein the overall heat exchange coefficient is greater than 3000 Btu/(h·ft²·° F.).

In some embodiments, the hydrophobic coating comprises electroless nickel (Ni) or carbon nanotubes or both. In some cases, the hydrophobic coating further comprises Teflon (PTFE), phosphorous (P), boron (B), boron nitride (BN), silica (Si), or combinations thereof. In some cases, the hydrophobic coating comprises Ni-PTFE, Ni—P-PTFE, Ni—B-PTFE, Ni—P—BN, or Ni—B—BN.

In some embodiments, the heat exchanger comprises a multiplicity of tubes or plates. In some embodiments, the tubes or plates are made of copper. In some embodiments, the hydrophobic coating is exposed to the vapor phase in the heat exchanger. In some embodiments, the hydrophobic coating promotes drop-wise condensation.

In some embodiments, the method further comprises utilizing a nucleation promoter. In some embodiments, the method further comprises utilizing boiling chips in conjunction with a filter. In some embodiments, the method further comprises discharging a vapor stream from the heat exchanger; and utilizing at least a portion of the discharged vapor stream to preheat the liquid phase or mixing at least a portion of the discharged steam with the liquid phase or both. In some embodiments, the method further comprises utilizing a jet ejector on the liquid-phase side or a jet ejector to promote vapor circulation or both.

Herein disclosed is a heat exchanger. The heat exchanger comprises at least one pipe having a centerline, an inlet and an outlet; and a multiplicity of tubes, wherein each tube comprises a centerline, an inner surface, an outer surface, and groves; wherein the multiplicity of tubes are placed inside the pipe and the centerline of each tube is perpendicular to the centerline of the pipe. Herein also disclosed is a heat exchange system. Such a system comprises the heat exchanger as described herein, wherein the heat exchanger is configured to receive an incoming feed stream and to discharge a vapor stream. Herein also described is a process that utilizes the heat exchanger disclosed herein. Such a process comprises the separation of a volatile component from a non-volatile component in a mixture. In some cases, the non-volatile component comprises a salt or a sugar and the volatile component comprises water.

The foregoing has outlined rather broadly the features and technical advantages of the invention in order that the detailed description of the invention that follows may be better understood. Additional features and advantages of the invention will be described that form the subject of the claims of the invention. It should be appreciated by those skilled in the art that the conception and the specific embodiments disclosed may be readily utilized as a basis for modifying or designing other structures to accomplish the same purposes of the invention. It should also be realized by those skilled in the art that such equivalent constructions do not depart from the spirit and scope of the invention as set forth in the appended claims.

### BRIEF DESCRIPTION OF THE DRAWINGS

FIG. 1 shows the process of mechanical vapor-compression desalination.

FIG. 2 shows the process of jet ejector vapor-compression desalination.

FIG. 3 shows the process of multi-effect evaporator desalination.

FIG. 4 shows heat exchanger tubes with vertical ribs.

FIG. 5 shows methods for joining heat exchanger tube to the tube sheet. (a) thick, (b). thin.

FIG. 6 shows a heat exchanger. (a) side view, (b) front view, (c) top view, (d) jet ejector detail.

FIG. 7 (a) shows the compression ratio as a function of salinity and ΔT across the heat exchanger. (P_{cond}=120 psia=0.8274 MPa, T_{cond}=341.31° F.=445 K, ΔT in 0.2 K increments)

FIG. 7 (b). Compression ratio as a function of salinity and ΔT across the heat exchanger. Operating point is typical of a seawater desalination system. (P_{cond}=120 psia=0.8274 MPa, T_{cond}=341.31° F.=445 K, ΔT in 0.2 K increments)

FIG. 7 (c) shows the compression ratio as a function of salinity and ΔT across the heat exchanger. Operating point is typical of a brackish water desalination system. (P_{cond}=120 psia=0.8274 MPa, T_{cond}=341.31° F.=445 K, ΔT in 0.2 K increments)

FIG. 8(a) shows the compression ratio as a function of salinity and ΔT across the heat exchanger. (P_{cond}=60 psia=0.4137 MPa, T_{cond}=292.75° F.=418 K, ΔT in 0.2 K increments)

FIG. 8(b) shows the compression ratio as a function of salinity and ΔT across the heat exchanger. Operating point is typical of a seawater desalination system. (P_{cond}=60 psia=0.4137 MPa, T_{cond}=292.75° F.=418 K, ΔT in 0.2 K increments)

FIG. 8(c) shows the compression ratio as a function of salinity and ΔT across the heat exchanger. Operating point is typical of a brackish water desalination system. (P_{cond}=60 psia=0.4137 MPa, T_{cond}=292.75° F.=418 K, ΔT in 0.2 K increments)

FIG. 9(a) shows the compression ratio as a function of salinity and ΔT across the heat exchanger. (P_{cond}=10 psia=0.06895 MPa,

T_{cond}=193.2° F.=362.7 K, ΔT in 0.2 K increments)

FIG. 9(b) shows the compression ratio as a function of salinity and ΔT across the heat exchanger. Operating point is typical of a seawater desalination system. (P_{cond}=10 psia=0.06895 MPa, T_{cond}=193.2° F.=362.7 K, ΔT in 0.2 K increments)

FIG. 9(c) shows the compression ratio as a function of salinity and ΔT across the heat exchanger. Operating point is typical of a brackish water desalination system. (P_{cond}=10 psia=0.06895 MPa. T_{cond}=193.2° F.=362.7 K, ΔT in 0.2 K increments)

FIG. 10(a) shows the compression ratio as a function of mass flow ratio for various velocities of motive steam as determined by computational fluid dynamic (CFD) simulation.

FIG. 10(b) shows the compression ratio as a function of mass flow ratio for various velocities of motive steam as determined by computational fluid dynamic (CFD) simulation.

FIG. 11 shows the analysis of jet ejector evaporator system.

FIG. 12 is the schematic of experimental apparatus.

FIG. 13 shows the measured overall heat transfer coefficient for bare naval brass 464 test plate with sand-blasted water-side surface (T=331° F., P=104.7 psia. R=1.0 lb shear steam/lb condensate). Natural convection on pool boiling side.

FIG. 14 shows the heat transfer coefficient (a) as a function of flow ratio R, and (b) as a function of steam velocity ν (ΔT=0.84° F., P=104.7 psia). Ni—P-PTFE hydrophobic coating. Natural convection.

FIG. 15 shows the heat transfer coefficient (a) as a function of flow ratio R, and (b) as a function of steam velocity ν (ΔT=1.1° F., P=76.7 psia). Hydrophobic coating. Natural convection.

FIG. 16 shows the heat transfer coefficient. (a) as a function of flow ratio R, and (b) as a function of shearing steam velocity ν (ΔT=1.33° F., P=59.7 psia). Hydrophobic coating. Natural convection.

FIG. 17 shows the overall heat transfer for naval brass with 0.000025-in hydrophobic coating on both sides. Sand-blasted surface on liquid side. Natural convection pool boiling. Shear steam on dropwise condensation surface. R is the optimal value for each condition (see FIGS. 14 to 16).

FIG. 18 shows the performance of uncoated and coated naval brass plates (0.000025-in coating). Both plates sand-blasted on water side. P=104.7 psia. Natural convection pool boiling. R=optimal value for each condition.

FIG. 19 shows the overall heat transfer coefficients are corresponding to different ΔT. Sand-blasted and fully coated plate with 0.000025-in hydrophobic coating. Forced-convection saturated pool boiling. R is the optimal value shown in FIG. 20. Smooth curves were interpolated using Equations 3.4-3.6

FIG. 20 shows the optimal shearing steam ratio R corresponding to saturated steam pressure P and temperature differential across the test plate ΔT. Sand-blasted and fully coated with 0.000025-in hydrophobic coating. Forced convection saturated pool boiling.

FIG. 21 shows the heat flux corresponding to different ΔT. Sand-blasted and fully coated plate with 0.000025-in hydrophobic coating. Forced-convection saturated pool boiling. R is the optimal value shown in FIG. 20. Smooth curves were interpolated using Equations 3.4-3.6. Dashed line is a projection to desired operating pressure using Equations 3.7-3.11.

FIG. 22 shows the overall heat transfer coefficient related to operating pressure. Naval brass plate is sand-blasted on boiling side and fully coated, with 0.000025-in hydrophobic coating. Forced convection saturated pool boiling. Smooth curves were determined using Equations 3.7-3.11. Solid line is interpolation. Dashed line is extrapolation.

FIG. 23 shows the overall heat transfer coefficients correspond to different ΔT. Fully coated 0.008-in copper plate with 0.000025-in hydrophobic coating. Forced-convection saturated pool boiling (ν_{sat liq}=5.15 ft/s). Optimal shearing steam on the condensing surface (see FIGS. 26 to 28).

FIG. 24 shows the optimal shearing steam ratio R corresponding to saturated steam pressure P and temperature differential across the test plate ΔT. Fully coated 0.008-in thick copper plate with 0.000025-in hydrophobic coating. Forced convection saturated pool boiling.

FIG. 25 shows the heat flux corresponding to different ΔT. Fully coated 0.008-in-thick copper plate with 0.000025-in hydrophobic coating. Forced-convection saturated pool boiling. R is the optimal corresponding value. Smooth curves were calculated using Equations 4.2 to 4.7. Dashed line is a projection to desired operating pressure using Equations 4.8 to 4.12.

FIG. 26 shows the heat transfer coefficient (a) as a function of flow ratio R, and (b) as a function of steam velocity ν (ΔT=0.35° F., P=104.7 psia). Hydrophobic coating. Forced convection.

FIG. 27 shows the heat transfer coefficient (a) as a function of flow ratio R, and (b) as a function of steam velocity ν (ΔT=0.35° F., P=82.7 psia). Hydrophobic coating. Forced convection.

FIG. 28 shows the heat transfer coefficient (a) as a function of flow ratio R, and (b) as a function of steam velocity ν (ΔT=0.35° F., P=62.7 psia). Hydrophobic coating. Forced convection.

FIG. 29 shows the overall heat transfer coefficient related to operating pressure. Fully coated 0.008-in-thick copper with 0.000025-in hydrophobic coating. Forced convection saturated pool boiling (ν_{sat liq}=5.15 ft/s). Smooth curves were determined using Equations 4.8-4.12. Solid line is interpolation. Dashed line is extrapolation.

FIG. 30 shows the overall heat transfer coefficients are corresponding to different ΔT. Fully coated 0.008-in copper plate with 0.000025-in hydrophobic coating. Forced-convection saturated pool boiling (ν_{sat liq}=5.15 ft/s). Optimal shearing steam on the condensing surface (see FIGS. 33 to 35).

FIG. 31 shows the optimal shearing steam ratio R corresponding to saturated steam pressure P and temperature differential across the test plate ΔT. Fully coated 0.008-in-thick copper with 0.000025-in hydrophobic coating. Forced convection in saturated pool boiling.

FIG. 32 shows the heat flux corresponding to different ΔT. Fully coated 0.008-in-thick copper plate with 0.000025-in hydrophobic coating. Forced-convection saturated pool boiling with PTFE boiling stones. R is the optimal value (see FIGS. 33 to 35). Smooth curves were calculated using Equations 4.13 to 4.18. Dashed line is a projection to desired operating pressure using Equations 4.19 to 4.23.

FIG. 33 shows the heat transfer coefficient (a) as a function of flow ratio R, and (b) as a function of steam velocity ν (ΔT=0.35° F., P=104.7 psia). Hydrophobic coating. Forced convection with PTFE boiling stones (3.6 wt %) in saturated-liquid side.

FIG. 34 shows the heat transfer coefficient (a) as a function of flow ratio R, and (b) as a function of steam velocity ν (ΔT=0.35° F., P=79.7 psia). Hydrophobic coating. Forced convection with PTFE boiling stones (3.6 wt %) in saturated-liquid side.

FIG. 35 shows the heat transfer coefficient (a) as a function of flow ratio R, and (b) as a function of steam velocity ν (ΔT=0.35° F., P=62.7 psia). Hydrophobic coating. Forced convection with PTFE boiling stones (3.6 wt %) in the saturated-liquid side.

FIG. 36 shows the overall heat transfer coefficient related to operating pressure. Fully coated 0.008-in-thick copper with 0.000025-in hydrophobic coating. Forced convection saturated pool boiling (ν_{sat liq}=5.15 ft/s). Smooth curves were determined using Equations 4.19 to 4.23. Solid line is interpolation. Dashed line is extrapolation.

FIG. 37 shows the overall heat transfer coefficients are corresponding to different ΔT. Uncoated 0.005-in-thick titanium grade-2 plate. Forced-convection saturated pool boiling (ν_{sat liq}=5.15 ft/s). Optimal shearing steam on the condensing surface (see FIGS. 40 to 42).

FIG. 38 shows the optimal shearing steam ratio R corresponding to saturated steam pressure P and temperature differential across the test plate ΔT. Uncoated 0.005-in-thick titanium plate. Forced convection in saturated pool boiling.

FIG. 39 shows the heat flux across the plate corresponding to different ΔT. Forced-convection in saturated pool boiling ν_{sat liq}=5.1 ft/s. R is the optimal value (see FIGS. 40 to 42). Smooth curves were calculated using Equations 5.4-5.6. Dashed line is a projection to desired operating pressure using Equations 5.7-5.11.

FIG. 40 shows the heat transfer coefficient (a) as a function of flow ratio R, and (b) as a function of steam velocity ν (ΔT=0.35° F., P=104.7 psia). Bare titanium grade-2 plate. Forced convection in saturated liquid side, and forced-convection shearing steam on the condensing surface.

FIG. 41 shows the heat transfer coefficient (a) as a function of flow ratio R, and (b) as a function of steam velocity ν (ΔT=0.35° F., P=79.7 psia). Bare titanium grade-2 plate. Forced convection in saturated liquid side, and forced-convection shearing steam on the condensing surface.

FIG. 42 shows the heat transfer coefficient (a) as a function of flow ratio R, and (b) as a function of steam velocity ν (ΔT=0.35° F., P=62.7 psia). Bare titanium grade-2 plate. Forced convection in saturated liquid side, and forced-convection shearing steam on the condensing surface.

FIG. 43 shows the overall heat transfer coefficient related to operating pressure. Uncoated 0.005-in-thick titanium grade-2 plate. Shearing steam on the condensing surface and forced convective saturated pool boiling (ν_{sat liq}=5.15 ft/s). Smooth curves were determined using Equations 5.7-5.11. Solid line is interpolation. Dashed line is extrapolation.

FIG. 44 shows the overall heat transfer coefficients corresponding to different ΔT. Fully coated 0.008-in-thick copper plate with round-shaped vertical grooves. Forced-convection saturated pool boiling (ν_{sat liq}=5.15 ft/s). Optimal shearing steam on the condensing surface (see FIGS. 47 to 49). Condensing steam at different pressures.

FIG. 45 shows the optimal shearing steam ratio R corresponding to saturated steam pressure P and temperature differential across the test plate ΔT. Experiments conducted on 0.008-in thick copper plate with round-shaped vertical grooves. Forced convection in the saturated pool boiling side (ν_{sat liq}=5.15 ft/s).

FIG. 46 shows the heat flux across the plate corresponding to different ΔT. Forced convection in saturated pool boiling. R is the optimal corresponding value (see FIGS. 47 to 49) Smooth curves were calculated using Equations 6.4 to 6.6. Dashed line is a projection to desired operating pressure using Equations 6.7 to 6.1.1.

FIG. 47 shows the heat transfer coefficient (a) as a function of flow ratio R, and (b) as a function of steam velocity ν (ΔT=0.35° F., P=104.7 psia). Copper plate 0.0008-in-thick with vertical grooves. Forced convection in saturated liquid side, and forced-convection shearing steam on the condensing surface.

FIG. 48 shows the heat transfer coefficient (a) as a function of flow ratio R, and (b) as a function of steam velocity ν (ΔT=0.38° F., P=93.7 psia). Copper plate 0.008-in-thick with round-shaped vertical grooves. Forced convection in saturated liquid side, and forced-convection shearing steam on the condensing surface.

FIG. 49 shows the heat transfer coefficient (a) as a function of flow ratio R, and (b) as a function of steam velocity ν (ΔT=0.59° F., P=74.7 psia). Cooper plate 0.008-in with round-shaped vertical grooves. Forced convection in saturated liquid side, and forced-convection shearing steam on the condensing surface.

FIG. 50 shows the overall heat transfer coefficient related to operating pressure. Copper plate 0.008-in-thick with round-shape vertical grooves coated with 0.000025-in Ni—P-PTFE hydrophobic coating. Force-convection shearing steam on the condensing surface and forced convective saturated pool boiling (ν_{sat liq}=5.15 ft/s). Smooth curves were determined using Equations 6.7 to 6.11. Solid line is interpolation. Dashed line is extrapolation.

FIG. 51 shows the thermal performances of 0.008-in copper substrates coated with hydrophobic Ni—P-PTFE coating of different thickness. Saturated steam at constant pressure P=104.7 psia. Forced convective saturated liquid (ν_{sat liq}=5.15 ft/s). Optimal forced-convection shearing steam.

FIG. 52 shows the heat fluxes across 0.008-in-thick copper substrates coated with hydrophobic Ni—P-PTFE coatings of different thickness. Saturated steam at P=104.7 psia. Forced convection saturated liquid (ν_{sat liq}=5.15 ft/s). Optimal forced-convection shearing steam was used, but the values were not collected.

FIG. 53 shows the variation of overall heat transfer coefficients on 0.008-in-thick copper substrate with respect to hydrophobic Ni—P-PTFE coating thicknesses. Saturated steam at P=104.7 psia with ΔT=0.35° F. across the plate. Forced convective pool boiling with ν_{sat liq}=5.15 ft/s. Optimal forced-convection shearing steam was used, but the values were not collected.

FIG. 54 shows the overall heat transfer coefficients corresponding to different ΔT. Fully coated 0.008-in-thick copper plate with round dimples and 0.0001-in lead-free hydrophobic coating. Forced convection saturated pool boiling (ν_{sat liq}=5.15 ft/s). Optimal shearing steam on the condensing surface (see FIGS. 57 to 59). Condensing steam at different pressures.

FIG. 55 shows the optimal shearing steam ratio R corresponding to saturated steam pressure P and temperature differential across the test plates ΔT. Experiments conducted on 0.008-in-thick copper plate with round dimples fully coated with 0.0001-in lead-free hydrophobic coating. Forced convection in the saturated pool boiling side (ν_{sat liq}=5.15 ft/s).

FIG. 56 shows the heat flux across the plate corresponding to different ΔT. Forced convection in saturated pool boiling. R is the optimal corresponding value (see FIGS. 57 to 59) Smooth curves were calculated using Equations 8.4 to 8.6. Dashed line is a projection to desired operating pressure using Equations 8.7 to 8.11.

FIG. 57 shows the heat transfer coefficient (a) as a function of flow ratio R, and (b) as a function of steam velocity ν (ΔT=0.35° F., P=104.7 psia). Copper plate 0.0008-in-thick with round dimples coated with 0.0001-in lead-free Ni—P-PTFE. Forced convection in saturated liquid side, and forced-convection shearing steam on the condensing surface.

FIG. 58 shows the heat transfer coefficient (a) as a function of flow ratio R, and (b) as a function of steam velocity ν (ΔT=0.35° F., P=92.7 psia). Copper plate 0.0008-in-thick with round dimples coated with 0.0001-in lead-free Ni—P-PTFE. Forced convection in saturated liquid side, and forced-convection shearing steam on the condensing surface.

FIG. 59 shows the heat transfer coefficient (a) as a function of flow ratio R, and (b) as a function of steam velocity ν (ΔT=0.42° F., P=84.7 psia). Copper plate 0.0008-in-thick with round dimples coated with 0.0001-in lead-free Ni—P-PTFE. Forced convection in saturated liquid side, and forced-convection shearing steam on the condensing surface.

FIG. 60 shows the overall heat transfer coefficient related to operating pressure. Copper plate 0.008-in-thick with round dimples coated with 0.0001-in Ni—P-PTFE lead-free hydrophobic coating. Force-convection shearing steam on the condensing surface and forced convective saturated pool boiling (ν_{sat liq}=5.15 ft/s). Smooth curves were determined using Equations 8.7 to 8.11. Solid line is interpolation. Dashed line is extrapolation.

FIG. 61 shows the overall heat transfer coefficients corresponding to different ΔT. Fully coated 0.008-in-thick copper plate with round-shaped vertical grooves. Forced-convection saturated pool boiling (ν_{sat liq}=5.15 ft/s). Optimal shearing steam on the condensing surface (see FIGS. 64 to 66). Condensing steam at different, pressures.

FIG. 62 shows the optimal shearing steam ratio R corresponding to saturated steam pressure P and temperature differential across the test plate ΔT. Experiments conducted on 0.008-in thick copper plate with round-shaped vertical grooves. Forced convection in the saturated pool boiling side (ν_{sat liq}=5.15 ft/s).

FIG. 63 shows the heat flux across the plate corresponding to different ΔT. Forced convection in saturated pool boiling. R is the optimal corresponding value (see FIGS. 64 to 66) Smooth curves were calculated using Equations 8.15 to 8.17. Dashed line is a projection to desired operating pressure using Equations 8.18 to 8.22.

FIG. 64 shows the heat transfer coefficient (a) as a function of flow ratio R, and (b) as a function of steam velocity ν (ΔT=0.35° F., P=104.7 psia). Copper plate 0.0008-in thick with vertical grooves. Forced convection in saturated liquid side, and forced-convection shearing steam on the condensing surface.

FIG. 65 shows the heat transfer coefficient (a) as a function of flow ratio R, and (b) as a function of steam velocity ν (ΔT=0.38° F., P=94.7 psia). Copper plate 0.008-in thick with round-shaped vertical grooves. Forced convection in saturated liquid side, and forced-convection shearing steam on the condensing surface.

FIG. 66 shows the heat transfer coefficient (a) as a function of flow ratio R, and (b) as a function of steam velocity ν (ΔT=0.6° F., P=64.7 psia). Cooper plate 0.008-in thick with round-shaped vertical grooves. Forced convection in saturated liquid side, and forced-convection shearing steam on the condensing surface.

FIG. 67 shows the overall heat transfer coefficient related to operating pressure. Copper plate 0.008-in thick with round-shape vertical grooves coated with lead-free 0.0001-in Ni—P-PTFE hydrophobic coating. Force-convection shearing steam on the condensing surface and forced convective saturated pool boiling (ν_{sat liq}=5.15 ft/s). Smooth curves were determined using Equations 8.18 to 8.22. Solid line is interpolation. Dashed line is extrapolation.

### DETAILED DESCRIPTION

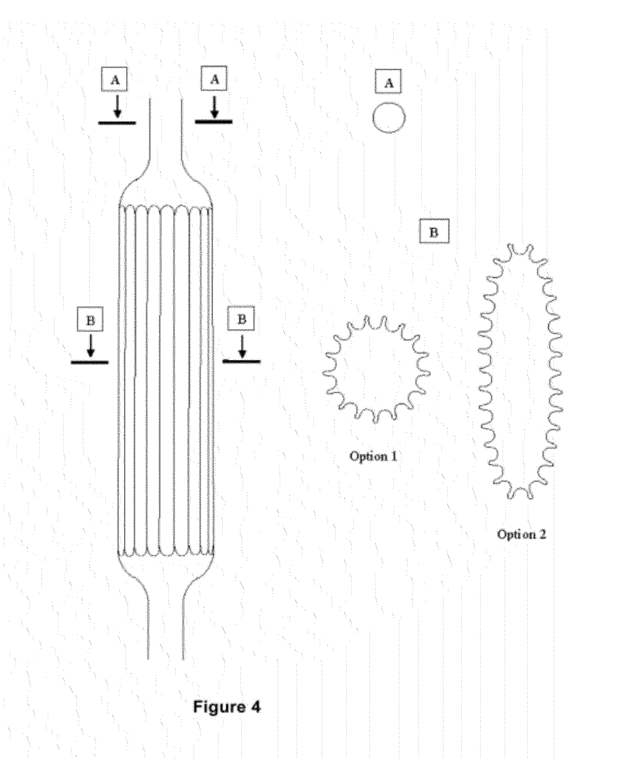

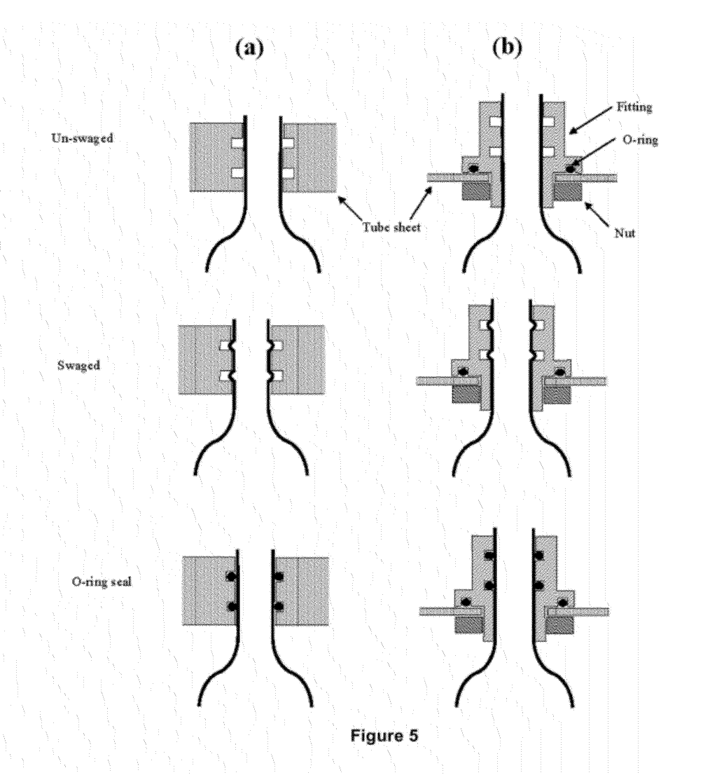

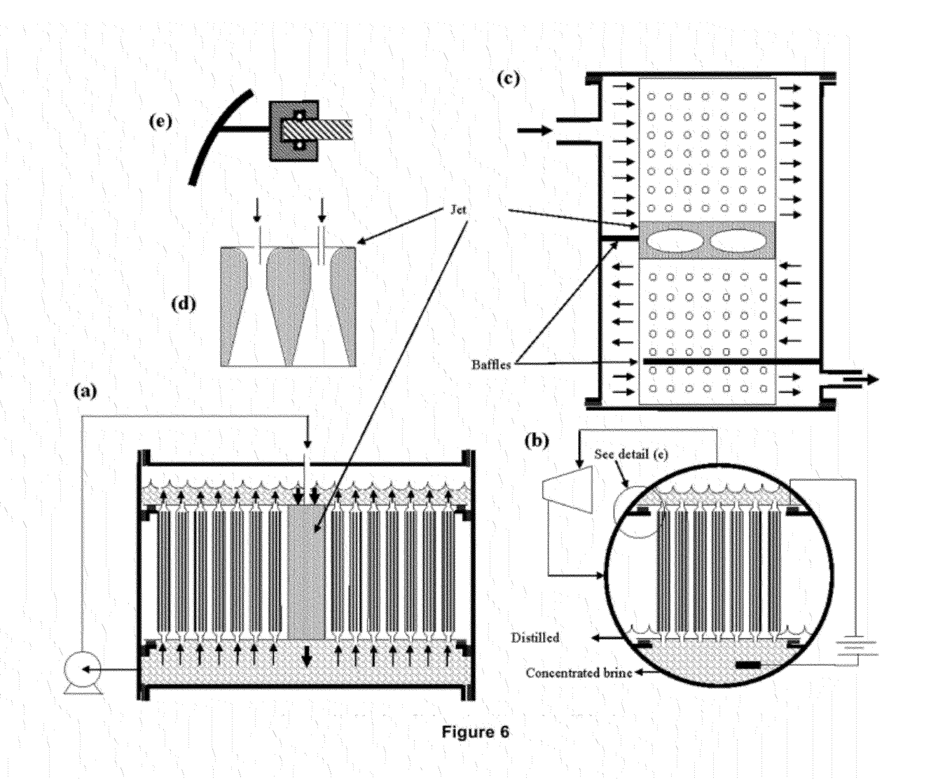

Overview. Herein disclosed is a heat exchanger. En an embodiment, the heat exchanger comprises at least one pipe having a centerline, an inlet and an outlet; and a multiplicity of tubes, wherein each tube comprises a centerline, an inner surface, an outer surface, and vertical groves; wherein the multiplicity of tubes are placed inside the pipe and the centerline of each tube is perpendicular to the centerline of the pipe. For example, FIG. 4 shows the tubes with vertical groves; FIG. 5 shows the joining of tubes to tube sheets; and FIG. 6 shows how the sheets are inserted into a pipe. The tubes with vertical groves are created using hydro-forming.

In a further embodiment, the heat exchanger comprises a multiplicity of baffles wherein the spacing between the baffles decreases in the direction of from the inlet to the outlet of the pipe. For example, FIG. 6c shows such baffles with decreasing spacing from the inlet to the outlet of the heat exchanger. These baffles help to maintain a nearly constant vapor velocity.

In another embodiment, the tubes of the heat exchanger are made of a metal or alloy with a thermal conductivity that is no less than that of copper. In some cases, it is allowable to use alloys with a thermal conductivity less than copper, such as naval brass. In an embodiment, the heat exchanger further comprises a galvanic protection mechanism.

In yet another embodiment, the heat exchanger further comprises a hydrophobic coating on the outer surface of each of the tubes or on both the inner surface and the outer surface of each of the tubes. The coating on the outside surface of the tubes promotes vapor condensation or vapor nucleation, which increases the heat transfer coefficient. In some embodiments, the heat exchanger is used as an evaporator. In some cases, the hydrophobic coating comprises electroless nickel or carbon nanotubes or both.

In an embodiment, the heat exchanger further comprises a jet ejector. As shown in FIG. 6, the jet ejector included in the heat exchanger produces forced convection for both the liquid phase and the vapor phase in the heat exchanger. In a further embodiment, the heat exchanger further comprises inflatable seals. Such inflatable seals are configured to conveniently attach and detach the tubes for installation and maintenance of the heat exchanger. As shown in FIG. 6(e), the circular parts may be rubber or silicon tubing.

In a further embodiment, the inner surface of the tubes comprises sand-blasted surface. Such sand-blasted surface promotes nucleation for the liquid phase. In yet another embodiment, the heat exchanger comprises boiling chips placed inside of the tubes during use of the heat exchanger. Such boiling chips comprise insoluble material, porous material, or rough material, e.g., Teflon chips. The boiling chips also promote nucleation in the liquid phase. In an embodiment, the heat exchanger comprises both the sand-blasted surface on the inner surface of the tubes and the boiling chips during use.

In another embodiment, the heat exchanger further comprises a multiplicity of fittings configured to attach each of the tubes to a tube sheet, wherein the fitting comprises an attaching mechanism configured to attach the fitting to each of the tubes; and a penetration mechanism configured to penetrate the tube sheet, wherein the penetration mechanism comprises a sealing mechanism and a securing mechanism. An example of such fittings is show in FIG. 5.

In an embodiment, the tubes of the heat exchanger are replaced with plates having a top surface and a bottom surface. In some cases, the plates have dimples. In some cases, the heat exchanger further comprises a hydrophobic coating on the top surface or on both the top surface and the bottom surface of each of the plates. In some cases, the bottom surface of each of the plates comprises sand blasted surface.

Herein also disclosed is a heat exchange system. Such a system comprises the heat exchanger as described herein, wherein the heat exchanger is configured to receive an incoming feed stream and to discharge a vapor stream. In some cases, the heat exchange system further comprises a salt nucleation promoter fluidly connected to the heat exchanger. Such a salt nucleation promoter is configured to cause the salt in the liquid phase to precipitate continuously and be removed. In some further cases, the heat exchange system further comprises a preheater configured to receive the incoming feed stream upstream of the heat exchanger and to receive the discharged vapor stream from the heat exchanger, wherein the incoming feed stream is heated by the discharged vapor stream.

Herein also described is a process that utilizes the heat exchanger disclosed herein. In some cases, such a process comprises the separation of a volatile component from a non-volatile component in a mixture. In some cases, the non-volatile component comprises a salt or a sugar. In some cases, the volatile component comprises water. In some cases, dropwise condensation occurs in the process. In some cases, desalination occurs in the process. In some cases, the process comprises liquid-gas separation.

Herein disclosed is a method of using a heat exchanger, wherein an aqueous solution and steam are present in the heat exchanger; wherein the heat exchanger comprises a hydrophobic coating; and wherein the operating pressure of the heat exchanger is greater than 50 psia. In some cases, the hydrophobic coating comprises electroless nickel or carbon nanotubes or both. In some embodiments, the hydrophobic coating is exposed to the steam in the heat exchanger. In some cases, the hydrophobic coating promotes vapor nucleation.

Herein further described is a method of using a heat exchanger, wherein a vapor phase and a liquid phase are present in the heat exchanger; wherein the heat exchanger comprises a hydrophobic coating; and wherein the overall heat transfer coefficient is greater than 3000 Btu/(h·ft²·° F.). Table 4 and Table 5 show the comparison of heat transfer coefficients between the heat exchanger of this disclosure and conventional heat exchangers (the first row in Table 4 shows the results without the coating). In some cases, the hydrophobic coating comprises electroless nickel or carbon nanotubes or both. In some cases, the heat exchanger comprises a multiplicity of tubes or plates. In some cases, the tubes or plates are made of copper. In some cases, the hydrophobic coating is exposed to the vapor phase in the heat exchanger. In some embodiments, the hydrophobic coating promotes vapor nucleation.

In an embodiment, nickel-Teflon coating is used in a heat exchanger that operates at high pressures (for example, P>45 psia or P>50 psia).

This technology may be used to desalinate water (e.g., brackish water, seawater), remove water from fermentation broth, concentrate sugar solutions, concentrate protein syrup, and other applications involving the separation of a volatile component from a nonvolatile component. For simplicity, in the descriptions below, the application is assumed to be water desalination.

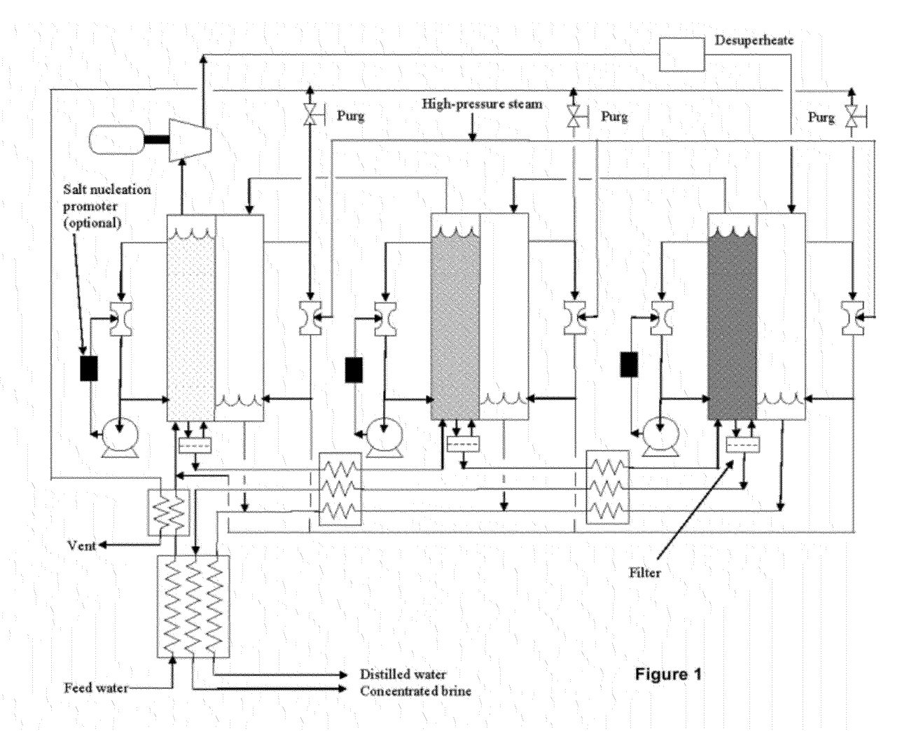

FIG. 1 shows a vapor-compression desalination system that uses a mechanical compressor. In this example, three evaporator stages are illustrated, but fewer or more could be employed. In this illustration, the left-most evaporator is at the lowest pressure and the right-most evaporator is at the highest pressure. In the left-most evaporator, the vapor space above the boiling water is connected to the compressor inlet. The work added to the compressor causes the discharged steam to be superheated. The superheat may be removed in the desuperheater, which may be accomplished by contacting the superheated steam with liquid water. When the liquid and vapor equilibrate, the steam becomes saturated (i.e., desuperheated). To facilitate heat transfer from the superheated steam to the liquid water, the liquid water may be added as a fine mist. Alternatively, in a packed column, the liquid water may countercurrently contact the superheated steam.

The saturated high-pressure steam that exits the desuperheater enters the condensing side of the right-most evaporator. As this steam condenses, it evaporates water from the boiling side thereby producing steam that may be fed to the middle evaporator. In the middle evaporator, the steam condenses, which causes more steam to be produced on the boiling-water side. This steam then enters the left-most evaporator where it condenses and evaporates water from boiling side. The water evaporated from the boiling side enters the compressor, as previously described.

The evaporators are operated at elevated temperature and pressure, which accomplishes the following: (1) the physical size of the compressor is reduced, thereby reducing its cost; and (2) in the evaporators, high heat transfer coefficients are obtained.

The primary disadvantage of operating at elevated temperature is that it promotes scaling on heat exchanger surfaces, primarily from salts with “reverse solubility,” i.e., those salts in which the solubility decreases at elevated temperature. Examples of reverse solubility salts are calcium carbonate, magnesium carbonate, calcium sulfate, and magnesium sulfate. Commonly, to limit scaling, the maximum heat exchanger temperature is ˜120° C.; however, at this temperature and pressure, the compressor is physically large and heat transfer coefficients are poor. It is highly desirable to increase the operating temperature, which requires methods to address scale formation such as the following: (1) Remove carbonates from the feed water by acidification and stripping the resulting carbon dioxide; (2) Remove sulfates via ion exchange; (3) Promote salt nucleation in the bulk fluid rather than on surfaces; (4) Abrade heat exchanger surfaces with circulating “cleaning balls” commonly made from rubber; and (5) Apply non-stick coatings to heat exchanger surfaces.

To preheat the feed to the evaporators, a sensible heat exchanger is employed, which exchanges thermal energy between the incoming feed water and the discharged distilled water and concentrated brine. As shown in FIG. 1, the preheated feed water is fed to the left-most evaporator. In a countercurrent series manner, the brine exiting the left-most evaporator is directed to the middle evaporator and the brine exiting the middle evaporator is directed to the right-most evaporator. As the brine flows from left to right, it becomes ever more concentrated. In the left-most evaporator (lowest brine concentration), the pressure ratio between the condensing steam and boiling water is minimal. In the right-most evaporator (highest brine concentration), the pressure ratio between the condensing steam and boiling water is maximal.

In an alternative embodiment, in a co-current series manner, the preheated feed water could be added to the right-most evaporator. In this arrangement, as the brine flows from right to left, it becomes ever more concentrated. In the right-most evaporator (lowest brine concentration), the pressure ratio between the condensing steam and boiling water is minimal. In the left-most evaporator (highest brine concentration), the pressure ratio between the condensing steam and boiling water is maximal.

In another embodiment, in a parallel manner, the preheated feed water could be divided into three portions and added to each of the evaporators. In this embodiment, each evaporator has the maximum salt concentration; therefore, the pressure ratio between the condensing steam and boiling water is maximal in each evaporator, which adversely affects energy efficiency because the compressor has the maximum compression ratio.

Regardless of the flow arrangement, each evaporator operates at a different temperature; therefore, to conserve energy, sensible heat exchangers are employed between each evaporator.

Because noncondensible gases are present in the feed water, it will be necessary to purge them from the system. The purged steam is most steam with small amounts of noncondensibles. The purge stream may be simply vented to the atmosphere; however, this wastes the energy in the steam. Alternatively, as shown in FIG. 1, the purge stream may be sent to a heat exchanger that helps preheat the incoming feed.

In the evaporators, the steam-side heat transfer coefficient improves by inducing a circulating flow. This is accomplished by using a jet ejector driven by high-pressure steam. A portion of this circulating flow may be bled and fed directly into the incoming feed, thereby assisting with preheating.

In the evaporator, the liquid-side heat transfer coefficient improves by circulating liquid. This may be accomplished using a jet ejector powered by a pump.

As brine concentrates, there is the potential for fouling as salts attach to the heat exchanger surface. To prevent this, a salt nucleation promoter—such as the Colloid-A-Tron produced by Fluid Dynamics—may be incorporated into the circulating flow. The salt nucleation promoter encourages salts to preferentially precipitate in the bulk liquid rather than on solid surfaces, and thus avoid fouling.

To promote vapor nucleation in the circulating liquid, “boiling chips” (e.g., Teflon boiling chips sold by CR Scientific) may be added. A further advantage of introducing boiling chips is that they abrade against the heat exchanger surface and therefore help remove scale. If boiling chips are employed, a separator (e.g., filter) is needed to retain them within the evaporator.

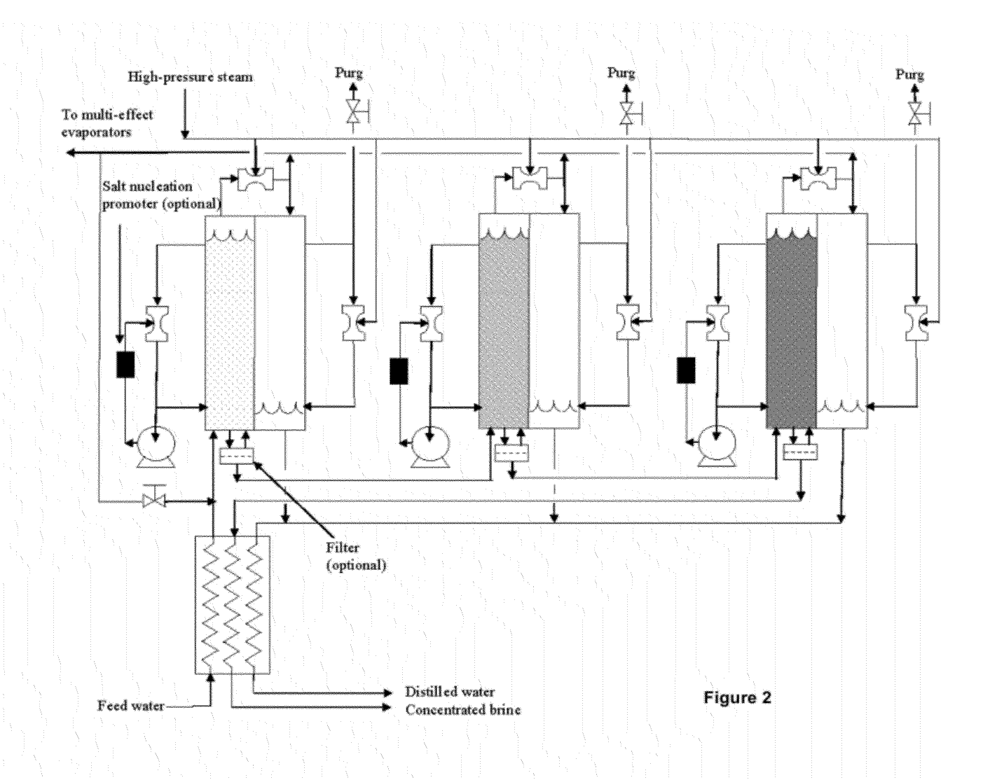

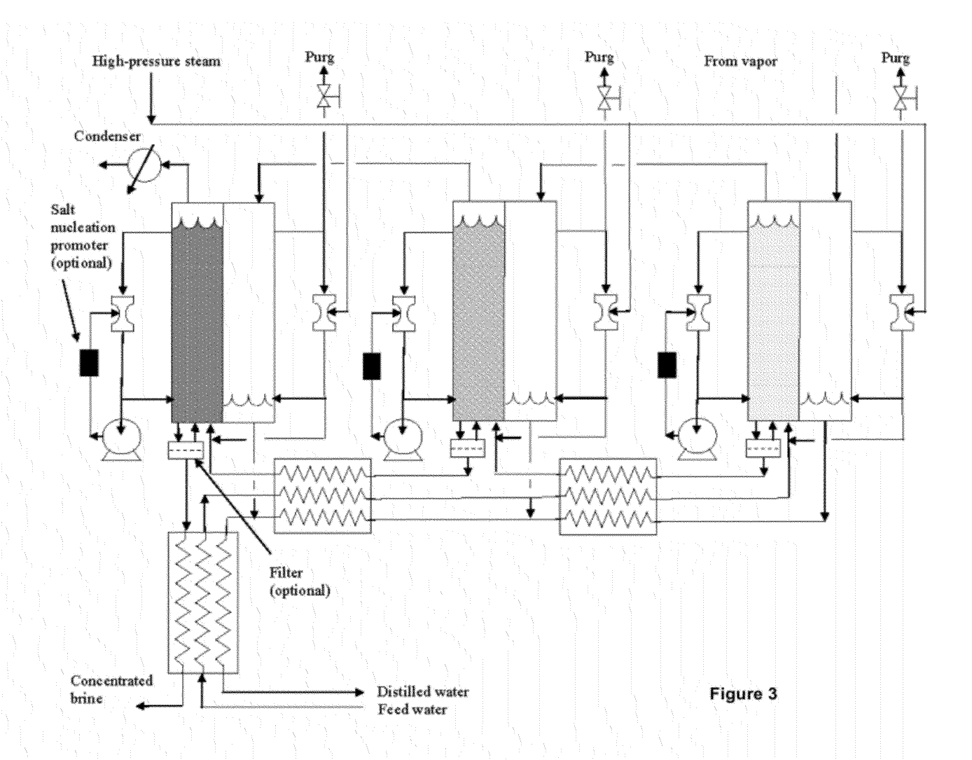

FIG. 2 shows an analogous system to the one shown in FIG. 1, except that jet ejectors replace the mechanical compressor. Each evaporator has its own jet ejector, so each evaporator may be operated at the same temperature and thus eliminates the need for sensible heat exchangers between each evaporator. In FIG. 2, the purged noncondensibles are vented directly to the atmosphere. Alternatively, the purged steam could be directed to a heat exchanger that preheats the feed water, as shown in FIG. 1. The steam that powers the jet ejectors must be purged from the system. By operating the evaporators at high temperature, the purged steam may be sent to multi-effect evaporators (FIG. 3) to desalination additional feed water. Alternatively, if the desalination system is employed in a chemical plant, the purged steam may be used for other purposes, such as distillation.

FIG. 3 shows the multi-effect evaporator system. High-pressure steam from the vapor-compression system enters the right-most evaporator, which operates at the highest pressure. When this steam condenses, it transfers heat to the boiling liquid, where additional steam is produced but at lower pressure. This steam is fed to the middle evaporator where the same process occurs. The steam produced in the middle evaporator is sent to the left-most evaporator. In FIG. 3, three multi-effect evaporators are shown; however, many more may be used. As the steam flows from right to left, the temperature lowers. Ultimately, the temperature is too low to be useful, so the steam produced from the last stage is condensed in a condenser that rejects the heat to cooling water of air. The high-pressure steam used in the jet ejector that circulates steam on the condensing side must be vented; it may be added directly to the incoming feed to preheat it to saturation conditions.

FIG. 4 shows an individual heat exchanger tube. Using hydroforming, the vertical grooves may be created by placing a cylindrical tube in a mold and increasing the internal pressure beyond the yield point. The experimental data indicate that vertical grooves have superior heat transfer coefficients. Presumably, this occurs because liquid droplets that form at the top of the groove flow downward in the vertical channel and clear the liquid adhering to the surface at the lower portions of the tube. Ideally, the tube is made from a high thermal conductivity material (e.g., copper). Optionally, the tube interior may be sand blasted to create nucleation sites. The entire tube may be coated with nickel-Teflon to promote dropwise condensation and to resist fouling. Alternatively, the nickel coating may incorporate carbon nanotubes, which are also hydrophobic. Advantageously, the carbon nanotubes have a high thermal conductivity, unlike Teflon. At Section A, the geometry is circular. At Section B, the geometry is circular (Option 1) or oval (Option 2).

FIG. 5 shows various methods for joining the hydroformed tube to the tube sheet. Column (a) shows methods where the tube sheet is thick. Grooves are placed inside the hole in the tube sheet. As shown in Row 1, the tube is placed in the tube sheet. As shown in Row 2, the tube is swaged to make a seal, preferably using HydroSwage technology from Haskel. As shown in Row 3, sealing may alternatively be accomplished using O-rings. Column (b) shows joining methods where the tube sheet is thin. A fitting is installed into the tube sheet, which allows the same joining methods to be employed as in Column (a).

FIG. 6 shows an assembled heat exchanger that employs the heat exchanger tubes described in FIGS. 4 and 5. As shown in front view (FIG. 6b), the shell has tabs on the interior wall that allow the tube sheets to be sealed using a gasket. The tube exterior is the steam condenser whereas the tube interior is the boiler. Salt water from the lower portion of the heat exchanger flows upward through the tube interior. When it emerges from the top, the vapors disentrain and are sent to the compressor inlet. The compressed vapor is directed to the tube exterior where it condenses and is collected as distilled water. Some high-thermal conductivity metals (e.g., copper) may be corroded in a salt environment. Corrosion may be prevented by using galvanic protection, such as by imposing an impressed current (shown here) or using a sacrificial electrode (not shown). Alternatively, no galvanic protection is required if the tube, tube sheet, and fittings are all made from the same alloy and the assembly is electrically isolated from dissimilar metals.

Side view (FIG. 6a) shows a jet ejector incorporated into the heat exchanger assembly. Using a pump, liquid is drawn from the bottom and pumped into a nozzle located at the throat of the jet ejector (FIG. 6d). The jet ejector forces water from the top portion of the heat exchanger into the bottom portion. The liquid returns to the top through the tube interiors. The jet ejector imposes forced circulation, which improves heat transfer.

Top view (FIG. 6c) shows baffles that provide a uniform velocity as the steam flows past the tubes. The baffle spacing reduces as the steam flows to the exit. This flow pattern also forces noncondensibles to accumulate at the exit, where they may be purged.

FIG. 6e shows an alternative method for sealing the tube sheet to the shell. A C-shaped extrusion is attached to the inside shell wall. The inside of the extrusion has one or more grooves that allow an inflatable linear seal to be inserted. During assembly, when the tube sheet is slid into the C-shaped extrusion, the linear seals are not inflated. Once the tube sheet is inserted, the linear seals are inflated. The advantage of this sealing system is that it allows heat exchangers to be rapidly installed or replaced without the difficultly of accessing bolts, as would be needed in a conventional gasket seal.

In FIG. 6, the shell axis and the tube axis are at right angles, which is a nontraditional arrangement. In an alternative embodiment (not shown), the shell axis and tube axis are parallel, which is the traditional arrangement for shell-and-tube heat exchangers.

The presence of salt lowers the vapor pressure of water according to the following formula

$${log}_{10} ( \frac{P}{{P}_{o}} ) = - 2.1609 \times {10}^{- 4} S - 3.5012 \times {10}^{- 7} {S}^{2} \qquad ( 1 )$$

where
P=actual vapor pressure above the salt solution at temperature T (kPa)
Pₒ=vapor pressure above pure water at temperature T (kPa)
S=salinity (g salt/kg solution)

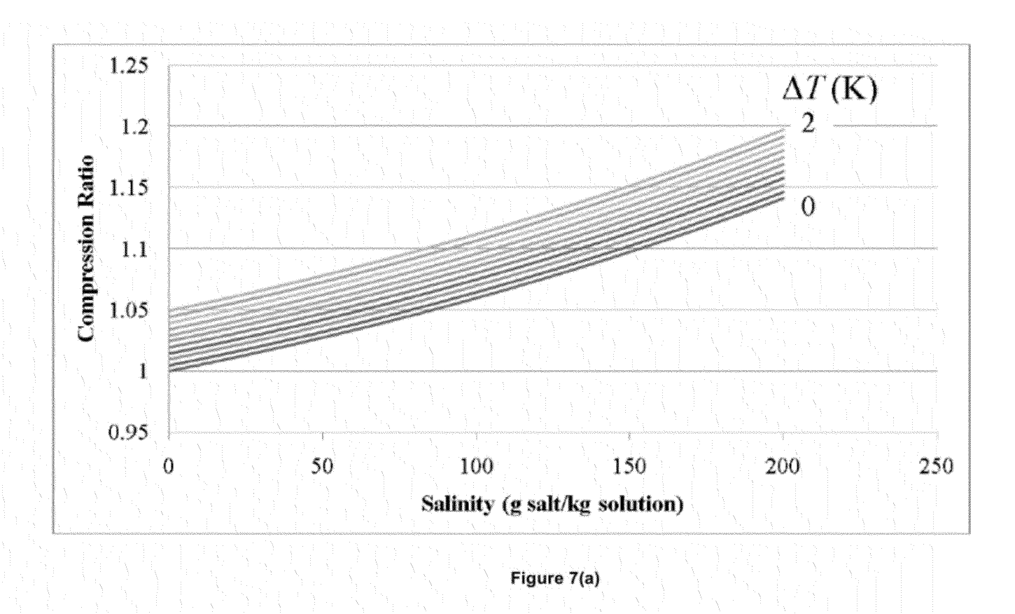

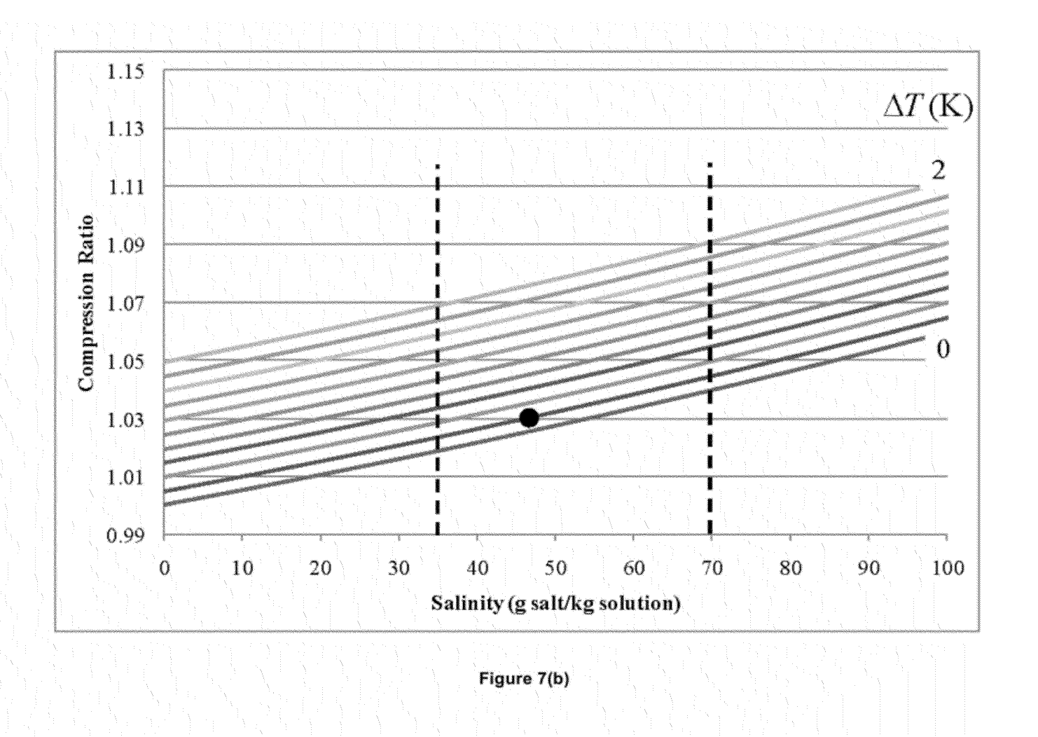

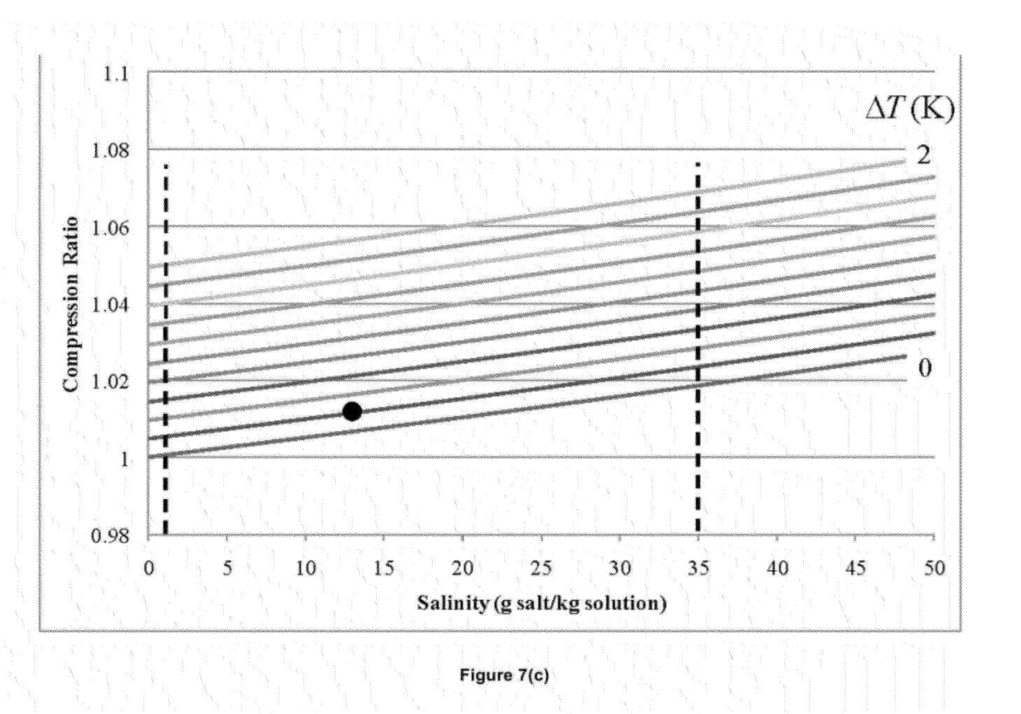

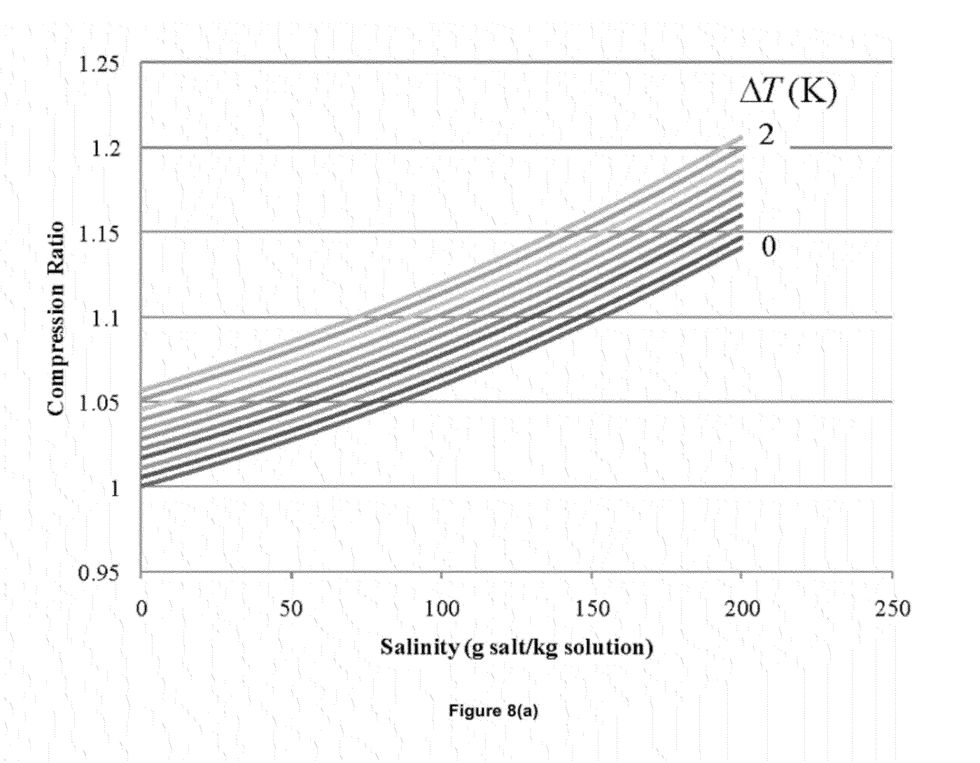

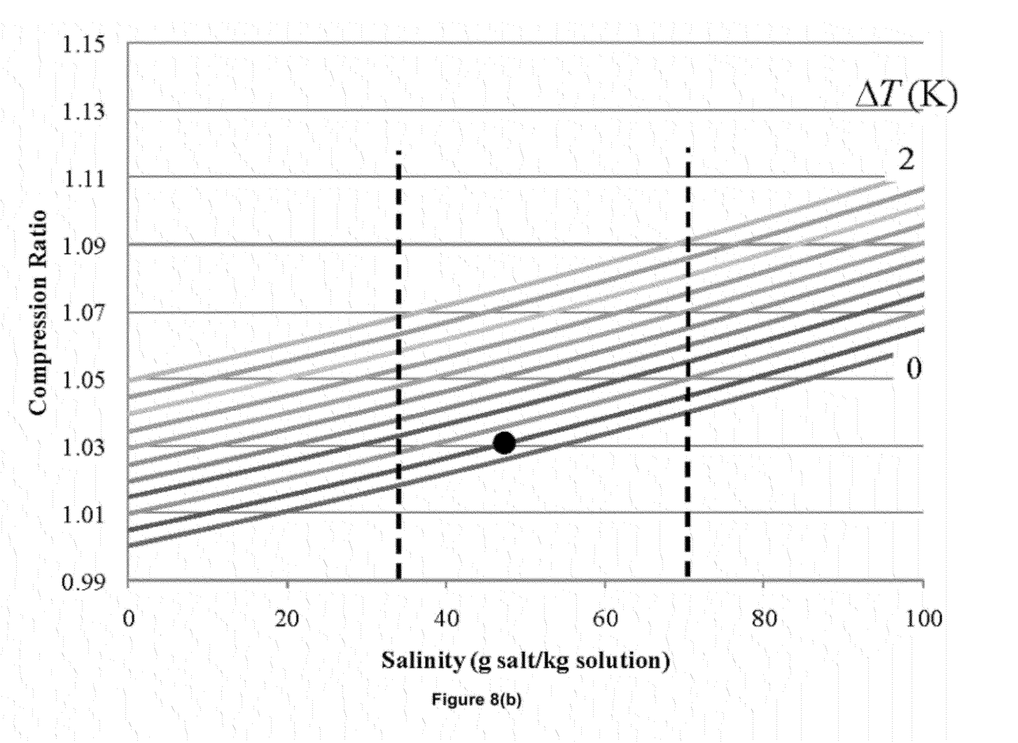

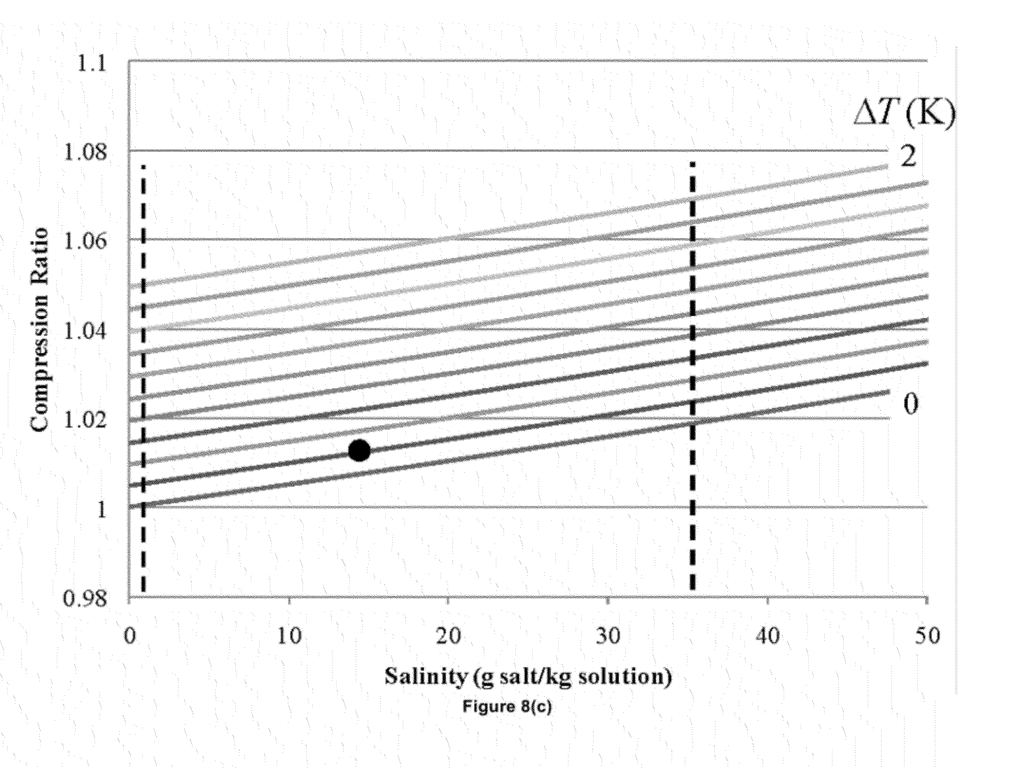

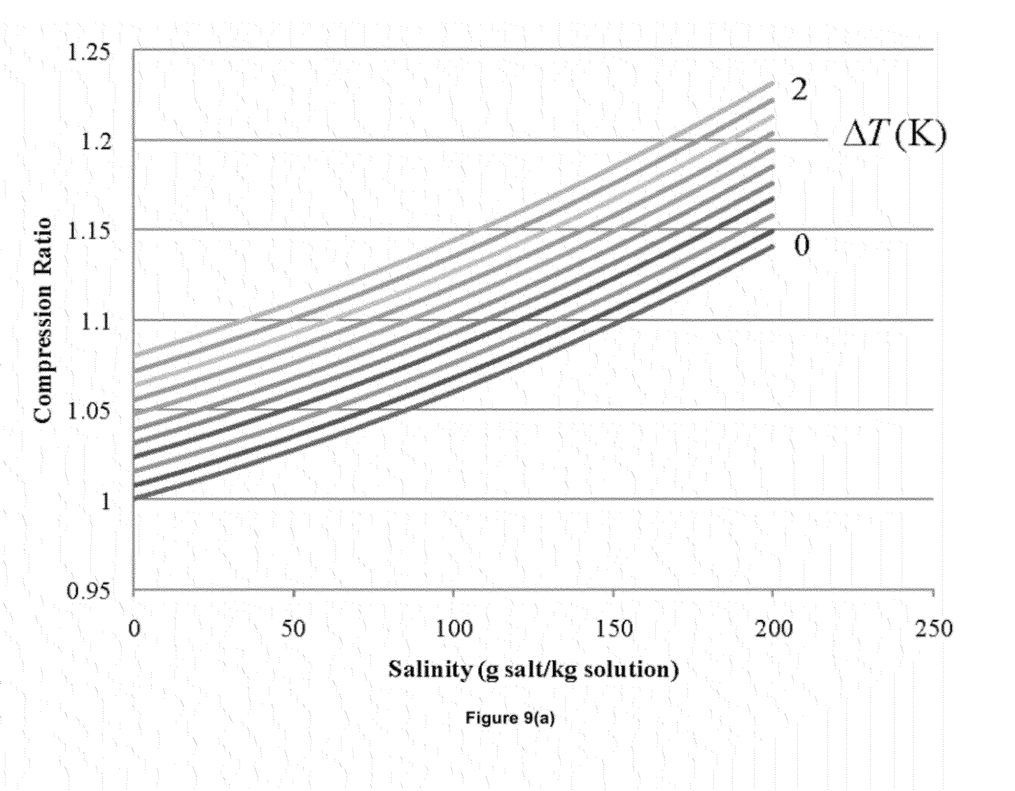

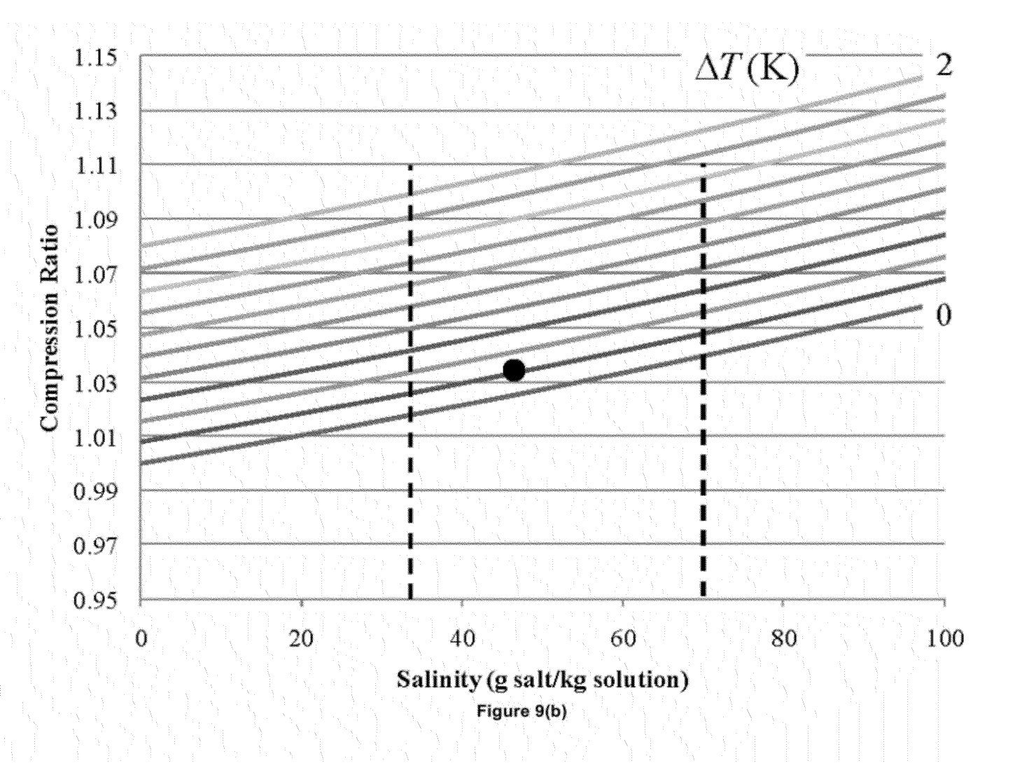

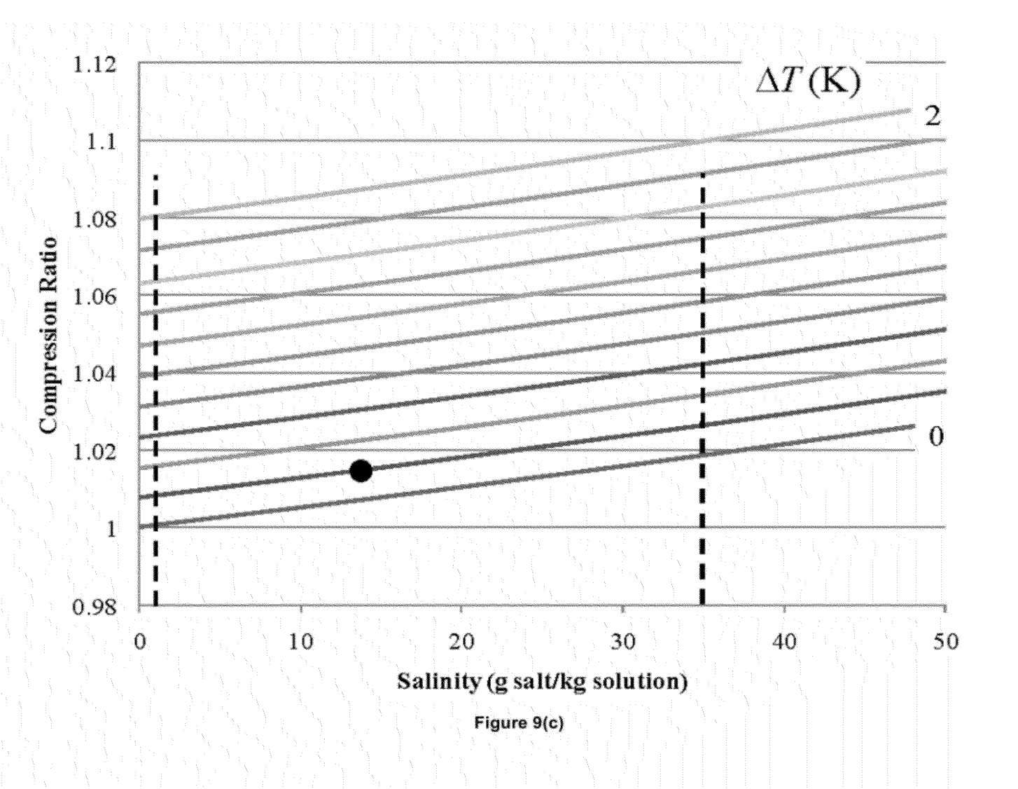

Using this relationship, the required compression ratio may be calculated as a function of salt concentration, condenser temperature, and heat exchanger ΔT (FIGS. 7 to 9). These figures are structured as follows:

| | Maximum Salinity | | |
|---|---|---|---|
| | (g salt/kg solution) | | |
| Condenser Temperature (K) | 250 | 100 | 50 |
| 445 | FIG. 7a | FIG. 7b | FIG. 7c |
| 418 | FIG. 8a | FIG. 8b | FIG. 8c |
| 363 | FIG. 9a | FIG. 9b | FIG. 9c |

FIGS. 7b, 8b, and 9b describe the required compression ratios for typical seawater conditions (feed=35 g salt/kg solution, discharge=70 g salt/kg solution). FIGS. 7c, 8c, and 9c describe the required compression ratios for typical brackish water conditions (feed=2 g salt/kg solution, discharge=35 g salt/kg solution). In each of these figures, the dot describes the compression ratio for a typical evaporator in a multi-evaporator train with salt water flowing in series, either countercurrently or co-currently. In all cases, the evaporator is assumed to operate with ΔT□=0.2 K, which is typical of the experimental data.

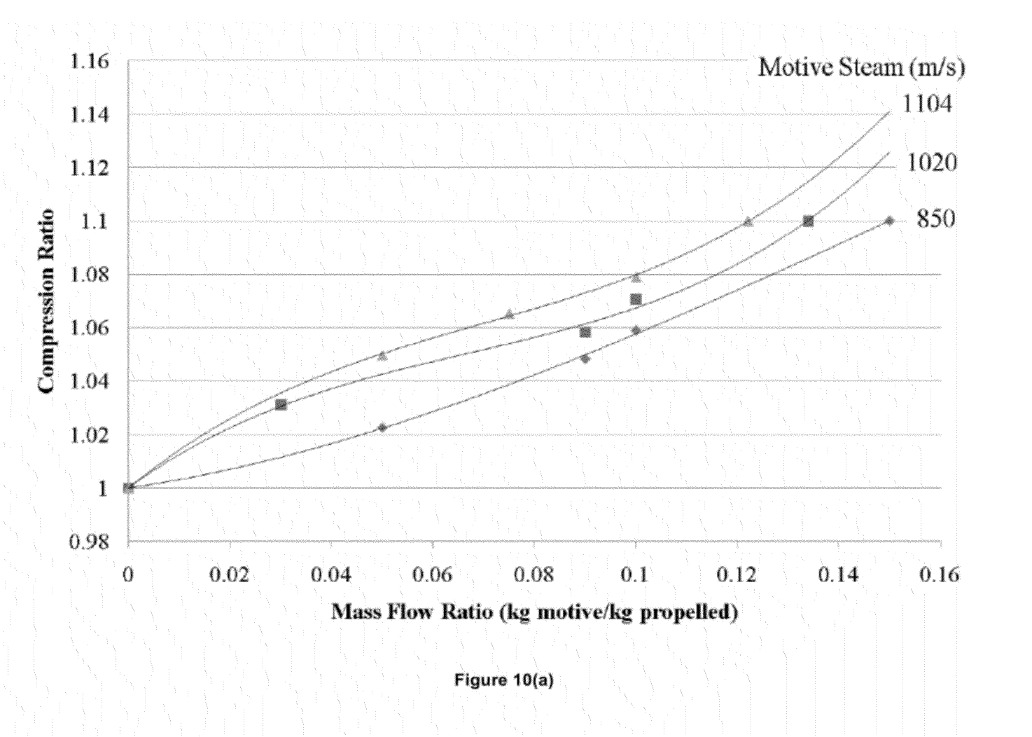

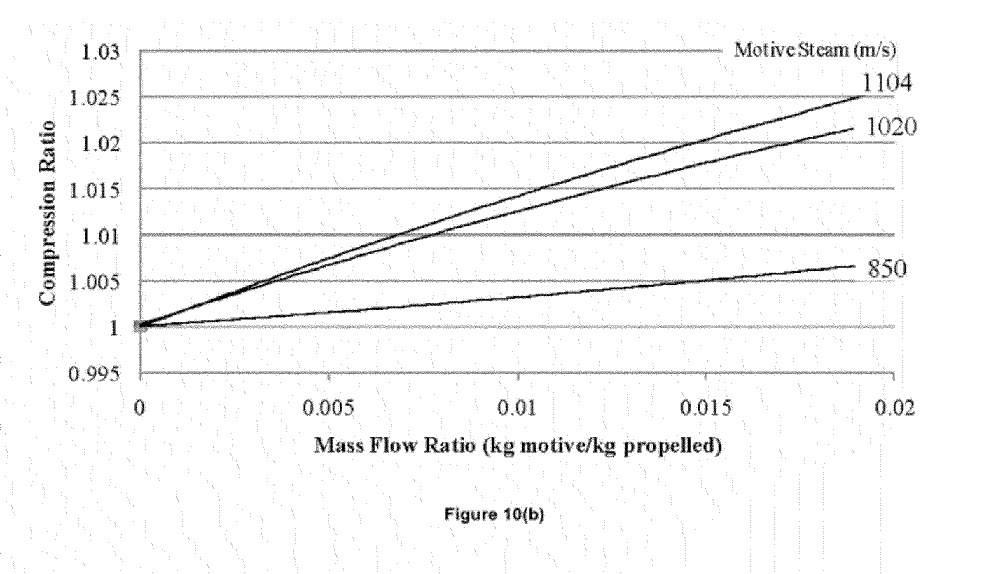

FIGS. 10a and 10b show computational fluid dynamic (CFD) simulations for steam jet ejectors operating at low compression ratios.² The following equations are valid for M<0.15 kg motive/kg propelled

CR=70.089M³−14.68M²+1.5657M+1 ν_{nozzle}=1104 m/s (2)

CR=68.099M³−13.732M²+1.3648M+1 ν_{nozzle}=1020 m/s (3)

CR=−7.9692M³+3.7961M²+0.2767M+1 ν_{nozzle}=850 m/s (4)

where

$$CR = compression ratio ( k Pa outlet \text{/} k Pa inlet )$$

$$\begin{matrix}M = mass flow ratio ( kg motive \text{/} kg propelled ) \\ = \frac{{\dot{m}}_{motive}}{{\dot{m}}_{propelled}}\end{matrix}$$

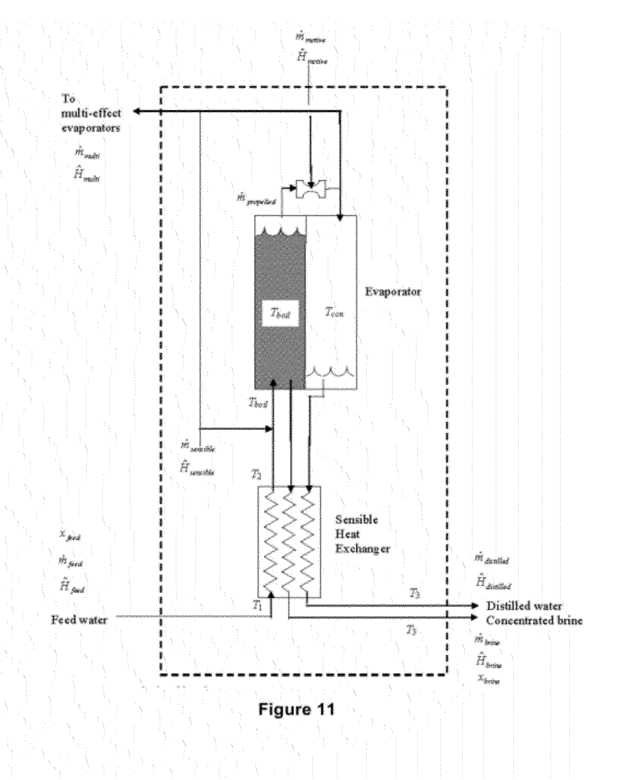

FIG. 11 shows an analysis of the jet ejector evaporator system. Mass balances reveal the following relationships:

\dot{m}_{feed}+\dot{m}ₘₒₜᵢᵥₑ=\dot{m}_{distilled}+\dot{m}_{brine}+\dot{m}ₘᵤₗₜᵢ (5)

where \dot{m}=mass flow rate (kg/s)
To a close approximation, the following are true:

\dot{m}_{propelled}=\dot{m}_{distilled} (6)

\dot{m}ₘₒₜᵢᵥₑ=\dot{m}_{sensible}+\dot{m}ₘᵤₗₜᵢ (7)

As previously defined,

$$M ≡ \frac{{\dot{m}}_{motive}}{{\dot{m}}_{propelled}} = \frac{{\dot{m}}_{motive}}{{\dot{m}}_{distilled}} \qquad ( 8 )$$

The recovery R of distilled water from brine is defined as follows:

$$R ≡ \frac{{\dot{m}}_{distilled}}{{\dot{m}}_{feed}} \qquad ( 9 )$$

A water balance around the system reveals

(1−x_{feed})\dot{m}_{feed}+\dot{m}ₘₒₜᵢᵥₑ+\dot{m}_{distilled}+(1−x_{brine})\dot{m}_{brine}+\dot{m}ₘᵤₗₜᵢ (10)

where

x=salt mass fraction (kg salt/kg solution)

Assuming that the motive and multi-effect evaporator streams are small relative to the feed stream, this equation simplifies to

$$( 1 - {x}_{feed} ) {\dot{m}}_{feed} = {\dot{m}}_{distilled} + ( 1 - {x}_{brine} ) {\dot{m}}_{brine} \\ ( 1 - {x}_{feed} ) {\dot{m}}_{feed} = {\dot{m}}_{distilled} + ( 1 - {x}_{brine} ) ( {\dot{m}}_{feed} - {\dot{m}}_{distilled} ) \\ ( 1 - {x}_{feed} ) {\dot{m}}_{feed} = {\dot{m}}_{distilled} + ( 1 - {x}_{brine} ) {\dot{m}}_{feed} - ( 1 - {x}_{brine} ) {\dot{m}}_{distilled} \\ ( 1 - {x}_{feed} ) {\dot{m}}_{feed} - ( 1 - {x}_{brine} ) {\dot{m}}_{feed} = {\dot{m}}_{distilled} - ( 1 - {x}_{brine} ) {\dot{m}}_{distilled} \\ ( {x}_{brine} - {x}_{feed} ) {\dot{m}}_{feed} = {x}_{brine} {\dot{m}}_{distilled} \\ R ≡ \frac{{\dot{m}}_{distilled}}{{\dot{m}}_{feed}} = \frac{{x}_{brine} - {x}_{feed}}{{x}_{brine}} = 1 - \frac{{x}_{feed}}{{x}_{brine}} \qquad ( 11 )$$

The velocity of the motive steam in the jet ejector is determined by performing an energy balance around the jet ejector nozzle, which is assumed to be 95% efficient

$$\frac{1}{2} {\dot{m}}_{motive} ( {v}_{nozzle}^{2} - {v}_{in}^{2} ) = 0.95 {\dot{m}}_{motive} ( {\hat{H}}_{motive} - {\hat{H}}_{cond} ) \qquad ( 12 )$$

Assuming the inlet velocity is negligible, this becomes

$$\frac{1}{2} {v}_{nozzle}^{2} = 0.95 ( {\hat{H}}_{motive} - {\hat{H}}_{cond} ) \\ {v}_{nozzle}^{2} = 2 ( 0.95 ) ( {\hat{H}}_{motive} - {\hat{H}}_{cond} ) = 1.9 ( {\hat{H}}_{motive} - {\hat{H}}_{cond} ) \\ {v}_{nozzle} = \sqrt{1.9 ( {\hat{H}}_{motive} - {\hat{H}}_{cond} )} \qquad ( 13 )$$

if the condenser enthalpy is known and the nozzle velocity is specified, then the required motive enthalpy may be calculated

$${\hat{H}}_{motive} = {\hat{H}}_{cond} + \frac{1}{1.9} {v}_{nozzle}^{2} \qquad ( 14 )$$

The jet ejector nozzle is very efficient, so it is nearly isentropic.

A new definition is introduced

$$\begin{matrix}r ≡ \frac{{\dot{m}}_{sensible}}{{\dot{m}}_{motive}} = 1 - \frac{{\dot{m}}_{multi}}{{\dot{m}}_{motive}} & ( 15 ) \\ {\dot{m}}_{sensible} = r {\dot{m}}_{motive} & ( 16 ) \\ {\dot{m}}_{multi} = ( 1 - r ) {\dot{m}}_{motive} & ( 17 )\end{matrix}$$

Prior to entering the evaporator, steam is added directly to the feed stream to raise the temperature from T₂ to T_{boil}. An energy balance around this point reveals

\dot{m}_{feed}Cₚ(T_{boil}−T₂)=\dot{m}_{sensible}λ (18)

where

λ=latent heat of vaporization for steam

Assuming the approach temperature in the heat exchanger is approximately the same at all points, the following is true:

(T₃−T₁)≅(T_{boil}−T₂)≅(T_{cond}−T₂) (19)

This relation may be substituted into Equation 18

$${\dot{m}}_{feed} {C}_{p } ( {T}_{3} - {T}_{1} ) = {\dot{m}}_{sensible} λ \\ \frac{{\dot{m}}_{sen sible}}{{\dot{m}}_{feed}} = \frac{{C}_{p} ( {T}_{3} - {T}_{1} )}{λ} \qquad ( 20 )$$

Substituting relationships for R (Equation 9) and M(Equation 8) gives

$$\frac{{\dot{m}}_{sen sible}}{{\dot{m}}_{feed}} \frac{{\dot{m}}_{feed}}{{\dot{m}}_{distilled}} \frac{{\dot{m}}_{distilled}}{{\dot{m}}_{motive}} = \frac{{\dot{m}}_{feed}}{{\dot{m}}_{distilled}} \frac{{\dot{m}}_{distilled}}{{\dot{m}}_{motive}} \frac{{C}_{p} ( {T}_{3} - {T}_{1} )}{λ} \\ \frac{{\dot{m}}_{sen sible}}{{\dot{m}}_{motive}} = \frac{1}{R} \frac{1}{M} \frac{{C}_{p} ( {T}_{3} - {T}_{1} )}{λ} \\ r = \frac{{C}_{p} ( {T}_{3} - {T}_{1} )}{R M λ} \qquad ( 21 )$$

Any steam not sent to the sensible heat exchanger is available for the multi-effect evaporators. The number of evaporator stages N is calculated as follows:

$$P {R}_{overall} = {( P {R}_{i} )}^{N} \\ N = \frac{ln P {R}_{overall}}{ln P {R}_{i}} \qquad ( 22 )$$

where

N=number of multi-effect evaporator stages

PRₒᵥₑᵣₐₗₗ=pressure ratio of the entire multi-effect evaporator system

PRᵢ=pressure ratio of a single stage in a multi-effect evaporator

PRᵢ is obtained from FIGS. 7 to 9.

The total amount of distilled water that may be produced from both the vapor-compression system and multi-effect evaporator is

$$\frac{{\dot{m}}_{total}}{{\dot{m}}_{motive}} = \frac{{\dot{m}}_{distilled}}{{\dot{m}}_{motive}} + N \frac{{\dot{m}}_{multi}}{{\dot{m}}_{motive}} \\ \frac{{\dot{m}}_{total}}{{\dot{m}}_{motive}} = \frac{1}{M} + N ( 1 - r ) \qquad ( 23 )$$

Advantages. In various embodiments, the heat exchange system of this disclosure has the following advantages. The heat exchanger has a hydrophobic coating made from nickel-Teflon, which promotes dropwise condensation and resists fouling. The nickel coating can incorporate carbon nanotubes (with or without Teflon) to promote dropwise condensation and high heat transfer coefficients. The heat exchanger tube has vertical groves that channel the condensed liquid in a vertical path, thus coalescing liquid adhering to the heat exchanger surface, which promotes high heat transfer coefficients. The heat exchanger tube has thin walls and is constructed of high-thermal-conductivity metal (e.g., copper), which promotes high heat transfer coefficients. In some cases, the thickness of the tube wall is no greater than 0.01 inch. To protect the metal from corrosion, galvanic protection may be incorporated into the system. Special fittings are employed that allow the heat exchanger tubes to seal against a thin tube sheet. On the boiling water side, the heat exchanger surface is sandblasted to promote vapor nucleation, which improves the heat transfer coefficient. On the boiling water side, “boiling chips” can be incorporated to promote vapor nucleation, which improves the heat transfer coefficient and scours the heat exchanger surface to keep it clean. An appropriate recovery system (e.g., filter) is employed to retain the boiling chips within the system. On the boiling water side, nucleation promoters can be employed to encourage solids to precipitate in the bulk liquid rather than on solid surfaces. On the boiling water side, forced convection is induced with a jet ejector powered by a liquid pump. On the condensing side, steam is circulated, which promotes high heat transfer coefficients. Although a mechanical means could be employed, a steam-powered jet ejector is preferred. On the condensing side, baffles are employed to maintain a high steam velocity past the tubes. As the steam flows, the baffles are more closely spaced to maintain a near-uniform velocity past the tubes. A heat exchanger is incorporated to allow purged steam to preheat incoming feed water. Appropriate piping is incorporated to preheat incoming feed water with the same steam used in the steam-powered jet ejector. An optimized jet ejector may be employed to compress vapors. An inflatable seal for rapid and easy installation of heat exchangers.

In Tables 1 and 5, the operating conditions explored by researchers prior to this disclosure resulted in very low heat transfer coefficients for nickel-Teflon coatings. In these prior studies, the operating pressure was low (P<45 psia). We achieved surprisingly high heat transfer coefficients because we operate at high pressures where the vapor density is sufficiently high to achieve exceptional performance.

### EXAMPLES

### Design Example 1

### Brackish Water

Assumptions

x_{feed}=1500 ppm=1.5 g salt/kg solution
x_{brine}=35,000 ppm=35 g salt/kg solution

### T_{cond}=445 K=341.3° F.

P_{cond}=0.8274 MPa=120 psia

### T₃−T₁=0.3 K=0.54° F.

### T_{cond}−T_{boil}=0.2 K=0.36° F.

T_{N}=50° C.=323.15 K (Nth stage of multi-effect evaporator)
P_{N}=0.012345 MPa=0.122 atm=1.79 psia (Nth stage of multi-effect evaporator)

Calculations

$$\begin{matrix} R = 1 - \frac{{x}_{feed}}{{x}_{brine}} = 1 - \frac{1.5 g \text{/} kg}{35 g \text{/} kg} = 9.96 \\ CR = 1.012 ( Figure 7 ( c ) ) \\ M = 0.008 kg motive \text{/} kg propelled @ 1104 m \text{/} s ( Figure 10 ( b ) ) \\ {T}_{1} = 25 ° C . = 298.15 K \\ {\hat{H}}_{feed} = 104.18 k J \text{/} kg ( steam table ) \\ {\hat{H}}_{cond} = {\hat{H}}_{multi} = {\hat{H}}_{sensible} = 2769 kJ \text{/} kg ( steam table ) \\ {\hat{S}}_{cond} = {\hat{S}}_{multi} = {\hat{S}}_{sensible} = 6.6472 kJ \text{/} ( kg \cdot K ) ( steam table ) & ( Equation 11 ) \\ \begin{matrix} {\hat{H}}_{motive} = {\hat{H}}_{cond} + \frac{1}{1.9} {v}_{nozzle}^{2} \\ = 2 , 769 , 000 J \text{/} kg + \frac{1}{1.9} {( 1104 m \text{/} s )}^{2} \\ = 3 , 410 , 482 J \text{/} kg \\ = 3410 kJ \text{/} kg\end{matrix} & ( Equation 14 )\end{matrix}$$

Assuming the nozzle is nearly isentropic, this enthalpy may be obtained with the following conditions:

$$\begin{matrix}{P}_{motive} = 8.9 M Pa = 87.8 atm = 1291 psia \\ {T}_{motive} = 783 K = 509.9 ° C . = 949.7 ° F . \\ \begin{matrix}r = \frac{{C}_{p} ( {T}_{3} - {T}_{1} )}{RM λ} \\ = \frac{( 4.19 \frac{kJ}{kg \cdot K} ) ( 0.3 K )}{( 0.96 ) ( 0.008 ) ( 2042.47 kJ \text{/} kg )} \\ = 0.080\end{matrix} \\ {PR}_{overall} = \frac{0.8274 M Pa}{0.012345 M Pa} = 67 \\ {PR}_{i} = 1.015 ( typical , Figure 9 ( c ) ) & ( Equation 21 ) \\ N = \frac{ln {PR}_{overall}}{ln {PR}_{i}} = \frac{ln 67}{ln 1.015} = 282 \\ \begin{matrix}\frac{{\dot{m}}_{total}}{{\dot{m}}_{motive}} = \frac{1}{M} + N ( 1 - r ) \\ = \frac{1}{0.008} + 282 ( 1 - 0.080 ) \\ = 385\end{matrix} & ( Equation 22 )\end{matrix}$$

This calculation shows that theoretically, 1 kg of motive steam may produce 385 kg of distilled water. In reality, this number will be reduced because of heat losses and pressure drops.

### Design Example 2

### Seawater

Assumptions

x_{feed}=35,000 ppm=35 g salt/kg solution
x_{brine}=70,000 ppm=70 g salt/kg solution

### T_{cond}=445 K=341.3° F.

P_{cond}=0.8274 MPa=120 psia

### T₃−T₁=0.3 K=0.54° F.

### T_{cond}−T_{boil}=0.2 K=0.36° F.

T_{N}=50° C.=323.15 K (Nth stage of multi-effect evaporator)
P_{N}=0.012345 MPa=0.122 atm=1.79 psia (Nth stage of multi-effect evaporator)

Calculations

$$\begin{matrix} R = 1 - \frac{{x}_{feed}}{{x}_{brine}} = 1 - \frac{35 g \text{/} kg}{70 g \text{/} kg} = 0.50 \\ CR = 1.03 ( Figure 7 ( b ) ) \\ M = 0.024 kg motive \text{/} kg propelled @ 1104 m \text{/} s ( Figure 10 ( a ) ) \\ {T}_{1} = 25 ° C . = 298.15 K \\ {\hat{H}}_{feed} = 104.18 k J \text{/} kg ( steam table ) \\ {\hat{H}}_{cond} = {\hat{H}}_{multi} = {\hat{H}}_{sensible} = 2769 kJ \text{/} kg ( steam table ) \\ {\hat{S}}_{cond} = {\hat{S}}_{multi} = {\hat{S}}_{sensible} = 6.6472 kJ \text{/} ( kg \cdot K ) ( steam table ) & ( Equation 11 ) \\ \begin{matrix} {\hat{H}}_{motive} = {\hat{H}}_{cond} + \frac{1}{1.9} {v}_{nozzle}^{2} \\ = 2 , 769 , 000 J \text{/} kg + \frac{1}{1.9} {( 1104 m \text{/} s )}^{2} \\ = 3 , 410 , 482 J \text{/} kg \\ = 3410 kJ \text{/} kg\end{matrix} & ( Equation 14 )\end{matrix}$$

Assuming the nozzle is nearly isentropic, this enthalpy may be obtained with the following conditions:

$$\begin{matrix}{P}_{motive} = 8.9 M Pa = 87.8 atm = 1291 psia \\ {T}_{motive} = 783 K = 509.9 ° C . = 949.7 ° F . \\ \begin{matrix}r = \frac{{C}_{p} ( {T}_{3} - {T}_{1} )}{RM λ} \\ = \frac{( 4.19 \frac{kJ}{kg \cdot K} ) ( 0.3 K )}{( 0.50 ) ( 0.024 ) ( 2042.47 kJ \text{/} kg )} \\ = 0.051\end{matrix} \\ {PR}_{overall} = \frac{0.8274 M Pa}{0.012345 M Pa} = 67 \\ {PR}_{i} = 1.033 ( typical , Figure 9 ( b ) ) & ( Equation 21 ) \\ N = \frac{ln {PR}_{overall}}{ln {PR}_{i}} = \frac{ln 67}{ln 1.015} = 129 \\ \begin{matrix}\frac{{\dot{m}}_{total}}{{\dot{m}}_{motive}} = \frac{1}{M} + N ( 1 - r ) \\ = \frac{1}{0.024} + 129 ( 1 - 0.051 ) \\ = 164\end{matrix} & ( Equation 22 )\end{matrix}$$

This calculation shows that theoretically, 1 kg of motive steam may produce 164 kg of distilled water. In reality, this number will be reduced because of heat losses and pressure drops.

### Example 3

Heat transfer coefficients were measured in vertical heat exchangers. Two different square, thin-sheet plate designs were tested. One had round-dimpled spacers, and the other had round-shaped vertical-grooved spacers. In both cases, the experimental plates were mounted in a sealed two-chamber apparatus with condensing saturated steam on one side and boiling liquid water on the other. The liquid-side heat transfer mechanism employed either natural or forced convection pool boiling of saturated water. The steam-side heat transfer mechanism was condensing saturated steam with either filmwise or dropwise condensation.

Three different plate materials were tested: (1) 0.030-in-thick naval brass 464 (2) 0.008-in thick copper, and (3) 0.005-in-thick titanium grade 2.

The first plate was round-dimpled 0.030-in-thick naval brass (k=67 Btu/(h⊙ft⊙° F.)), which was roughened via sand-blasting on the liquid side to promote nucleation. The condensing metal surface was either bare (filmwise condensation) or coated with 0.000025-in-thick layer of Ni—P-PTFE (dropwise condensation). Shearing steam on the condensing surface enhanced the overall heat transfer coefficient by 1.6 times and forced liquid convection increased it by additional 1.4 times. Interestingly, excessive shearing steam reduced the overall heat transfer coefficient. Presumably, this occurred because a film formed that increased the thermal resistance across the plate and disrupted the dropwise condensation mode. Without coating, the best operating point delivered U=2,900 Btu/(h·ft²·° F.) (saturated steam T=331° F., P=104.7 psia, ΔT=0.35° F.). With 0.000025-in Ni—P-PTFE hydrophobic coating, the best operating point delivered an overall heat transfer coefficient U=17,500 Btu/(h·ft²·° F.) (Saturated steam T=331° F., P=104.7 psia, ΔT=0.35° F., shearing steam ν=0.53 ft/s, R≈1 lb shearing steam/lb condensate, saturated liquid side ν=5.15 ft/s).

The second plate was round-dimpled 0.008-in-thick copper (k=231 Btu/(h⊙ft⊙° F.)). The plate surfaces in both chambers were modified with 0.000025-in Ni—P-PTFE hydrophobic layer. Experiments on this plate were performed under two different conditions in the saturated liquid chamber: (1) forced convection and (2) forced convection with PTFE boiling stones as a dynamic nucleation agent. For the first condition, the best operating point delivered an overall heat transfer coefficient U=28,000 Btu/(h·ft²·° F.) (saturated steam T=331° F., P=104.7 psia, ΔT=0.35° F., shearing steam ν=1.4 ft/s, R≈1 lb shearing steam/lb condensate, saturated liquid side ν=5.15 ft/s). For the second condition, the best operating point delivered an overall heat transfer coefficient U=32,000 Btu/(h·ft²·° F.) (saturated steam T=331° F., P=104.7 psia, ΔT=0.35° F., steam velocity ν=1.6 ft/s, R≈1 lb shearing steam/lb condensate, saturated liquid velocity ν=5.15 ft/s).

The third round-dimpled plate was made of grade-2 bare 0.005-in-thick titanium (k=12.65 Btu/(h⊙ft⊙° F.)). The best design point delivered U=13,700 Btu/(h⊙ft²⊙° F.) (saturated steam T=331° F., P=104.7 psia, ΔT=0.35° F., steam velocity ν=0.5 ft/s, R=1.5 lb shearing steam/lb, saturated liquid velocity ν=5.15 ft/s).

The fourth plate was vertical-grooved 0.008-in-thick copper (k=231 Btu/(h⊙ft⊙F)) coated with 0.000025-in Ni—P-PTFE hydrophobic coating. The best design point delivered U=33,800 Btu/(h⊙ft²⊙° F.) (saturated steam T=331° F., P=104.7 psia, ΔT=0.35° F., steam velocity ν=0.53 ft/s, R≈0.43 lb shearing steam/lb condensate, saturated liquid velocity ν=5.15 ft/s). The last experiment was performed on the copper plate previously described but with a modified chemistry for the coating. Lead-free 0.0001-in-thick hydrophobic Ni—P-PTFE delivered 21% better heat transfer coefficient. For this case, the best design point was U=42,400 Btu/(h⊙ft²⊙° F.) (saturated steam T=331° F., P=104.7 psia, ΔT=0.35° F., steam velocity ν=0.76 ft/s, R≈0.6 lb shearing steam/lb condensate, saturated liquid velocity ν=5.15 ft/s).

### Section 1

### Introduction

1.1 Heat Transfer Enhancement Techniques

Active and passive heat transfer enhancement techniques for heat exchangers have been investigated intensively. Fourth-generation heat transfer technology involves simultaneous application of several techniques to produce an enhancement larger than the individual techniques operating separately. Dropwise condensation has been studied for the past 60 years. Experiments with brass tubes show dropwise condensation has heat transfer coefficients 1.6-28.6 times greater than filmwise condensation.

The experiments in this disclosure enhanced heat transfer by simultaneously employing the following: (1) passive electroless Ni—P-PTFE thin-hydrophobic coating to promote dropwise condensation on the steam side and to inhibit fouling in the boiling side, (2) passive roughened surface and active nucleation sites with suspended PTFE boiling stones to promote nucleation in the saturated liquid side, (3) active forced convection circulating saturated liquid in the boiling chamber, and (4) active shearing steam on the condensing surface.

This study measures the heat transfer with pool boiling (liquid side) and dropwise condensation (steam side). The following factors were investigated:
Nucleation sites
sand blasting
Teflon boiling stones
Saturated steam temperature
Temperature differential ΔT across the plate
Plate material
Plate thickness
Hydrophobic coating thickness
Shearing steam
Shearing liquid

1.2. Theoretical Calculation

Neglecting fouling, theoretical calculation of the overall heat transfer coefficient may be performed using

$$U = \frac{1}{\frac{1}{{h}_{cond}} + \frac{1}{{h}_{boiling}} + ( \frac{x}{k} )} \qquad ( 1.1 )$$

where

U=overall heat transfer coefficient (Btu/(h⊙ft2⊙° F.))

x=plate thickness (ft)

k=thermal conductivity (Btu/(h⊙ft⊙° F.))

h_{cond}=condensation heat transfer coefficient (Btu/(h⊙ft²⊙° F.))

h_{boiling}=boiling heat transfer coefficient (Btu/(h⊙ft²⊙° F.))

Measured heat transfer coefficients U are obtained from

$$\begin{matrix}U = ( \frac{q}{Δ T} ) \\ and & ( 1.2 ) \\ q = ( m {h}_{fg} ) \text{/} A & ( 1.3 )\end{matrix}$$

where:

q=heat flux (Btu/(h⊙ft²))

m=condensate collected from the apparatus (lb/h)

h_{fg}=latent heat of condensation (Btu/lb)

A=effective heat transfer area=0.694 ft²

ΔT=temperature differential across the plate (° F.)

Using data from the literature, Lara estimated the heat transfer coefficient of an innovative sheet-shell heat exchanger with passive surface modifications on the condensing heat transfer surface. Lara assumed the surface was modified with self-assembled monolayer (SAM) of an organic hydrophobic coating. On the steam side, he estimated h_{cond}=57,000 Btu/(h⊙ft²⊙° F.) for gravity-controlled dropwise condensation of steam. On the liquid side, he estimated h_{boiling}=180,000 Btu/(h⊙ft²\grave{◯}⊙° F.) for natural convection pool boiling. Using 0.007-in-thick naval brass plate with a monolayer of PTFE hydrophobic coating, he estimated an overall heat transfer coefficient U=31,500 Btu/(h⊙ft²⊙° F.).

In pool boiling; heat flux across the plate evaporates micro and macro layers of the vertical surface during bubble growth. The level of turbulence imposed by forced convection helps coalesce small bubbles with large bubbles carrying upwards the maximum possible amount of latent heat. In the pool boiling side, the total heat transfer coefficient increases by adding forced convection. Trends for forced convective boiling of water indicate that operating at high pressure increases the critical heat flux (CHF) (i.e., the maximum heat flux attainable) compared to low-pressure operation. It is well known that increasing surface roughness is a cost-effective way to enhance nucleate boiling compared to other more sophisticated techniques.

During dropwise condensation, the heat transfer process is controlled by the developed intermolecular force field, which is composed of surface tension, gravity, and free surface energy. The positive influence of sweeping steam on the condensing surface has been studied. This innovative sheet-shell heat exchanger has a unique ability to sweep steam on its vertical condensation surface. Additionally, literature shows that for a vertically grooved surface, the heat flux increased up to 80% in a shear-steam dropwise condensation process.

Factors leading to enhanced boiling on surfaces are surface microroughness and porous microstructures, which provide the following benefits: (1) sufficient active nucleation sites at low wall superheats, (2) evaporation of liquid films within a very small confined space, and (3) increase in the effective heat transfer area.

Dropwise condensation performs best at higher pressures and small temperature differentials across the plate. Moreover, high operating pressures increase steam density which allows mechanical vapor-compression (MVC) desalination systems to use smaller compressors. The StarRotor compressor is a key component of the MVC system because of its low energy consumption and low capital cost.

Table 1 summarizes the most recent literature in Ni—P-PTFE coatings applications on condensers.

TABLE 1
Literature review of Ni—P-PTFE hydrophobic coatings

| | | | | Base metal | | Coating | | Liquid- | |
|---|---|---|---|---|---|---|---|---|---|
| | | Pₛₐₜ | Substrate | thickness | | thickness | Shear | side | Nucleation |
| No | ΔT | (psi) | metal | (inches) | Coating | (inches) | steam | agitation | Sites |
| 1 | NR | Pool | Cu | 0.014 | Ni—Cu—P- | 0.0009 | No | No | No |
| | | boiling | SS 304 | | PTFE | | | | |
| | | 14.7 | | | | | | | |
| 2 | NR | Pool | Cu | 0.014 | Ni—Cu—P- | 0.00001-0.0001 | No | No | No |
| | | boiling | SS 304 | | PTFE | | | | |
| | | 14.7 | LC steel | | | | | | |
| 3 | NR | Pool | Cu | 0.014 | Ni—P-PTFE | Various | No | No | No |
| | | boiling | SS 304 | | | | | | |
| | | 14.7 | | | | | | | |
| 4 | 2-7 | 29 | SS 316 | NR | Ni—P-PTFE | NR | No | Yes | No |
| | K | | | | | | | (Oil) | |
| 5 | NR | 14.5 | SS 304 | 0.04 | Ni—Cu—P- | 0.0009 | No | No | No |
| | | | | | PTFE | | | | |
| 6 | NR | 14.5 | Cu | 0.014 | Ni—P-PTFE | NR | No | No | No |
| | | | SS 304 | | | | | | |
| 7 | NR | 14.5 | SS 304 | NR | Ni—P-PTFE | NR | No | No | No |
| 8 | NR | 14.5 | SS 316 | NR | Ni—P-PTFE | 0.00005-0.0009 | No | No | No |
| 9 | NR | 14.5 | Cu | 0.014 | Ni—Cu—P- | 0.0009 | No | No | No |
| | | | | | PTFE | | | | |

| | | Heat | | | |
|---|---|---|---|---|---|
| | Surface | transfer | | | Dropwise |
| | geometry | coefficient | | Corrosion | condensation |
| No | (inches) | (Btu/h ft² F.) | Antifouling | resistance | (DWC) |
| 1 | 0.6 × 0.4 | NR | Yes | superior to | NR |
| | Vertical | | | Ni—P-PTFE | |
| | coupon | | | Coating | |
| 2 | 0.6 × 0.4 | 1,230 | inhibited | Yes | No |
| | Vertical | | formation of | | |
| | coupon | | CaSO4 scale | | |
| 3 | 0.6 × 0.4 | NR | reduced | NR | No |
| | Vertical | | adhesion | | |
| | coupon | | of CaSO₄ | | |
| | | | scale | | |
| 4 | corrugated | 3,000 | Yes | Yes | Yes |
| | plate-and- | | | | |
| | frame HX | | | | |
| 5 | 0.6 × 0.4 | NR | minimized | Yes | No |
| | Vertical | | microbial | | |
| | coupon | | adhesion by | | |
| | | | over 96-98% | | |
| 6 | 0.6 × 0.4 | 890 on coated | Yes | Yes | NR |
| | Vertical | SS 304 | | | |
| | coupon | heater | | | |
| 7 | rotating | Not reported | high | NR | NR |
| | cylinder | | wear | | |
| | | | resistance | | |
| 8 | conventional | Ni—P-PTFE | NR | NR | NR |
| | heat | improved | | | |
| | exchangers | processing | | | |
| | | skim milk and | | | |
| | | tomato juice | | | |
| 9 | 0.6 × 0.4 | NR | Yes | Yes | NR |
| | Vertical | | | | |
| | coupon | | | | |

NR = Not reported; SS = Stainless steel; Cu = copper; LC = Low carbon

Section 2. Experimental Apparatus and Procedure

Test surfaces. The hydrophobic Ni—P-PTFE coating resists fouling, corrosion, and friction while promoting dropwise condensation. Ni—P-PTFE electroless composite plating was made of 75 to 80 vol % high-phosphorus nickel matrix and 20 to 25 vol % of PTFE (polytetrafluoroethylene). Microplating Inc. applied the thin hydrophobic coating. Two types of coating were applied: Ni—P-PTFE and lead-free Ni—P-PTFE (see Table 2).

The electroless hydrophobic coating thickness (h) is governed by the coating deposition rate (γ) and deposition time (t) by the expression: h=γ⊙t. Therefore, a thin coating may be obtained by using a short deposition time. Because of the high thermal resistance of PTFE, a very thin hydrophobic coat is desired. A 0.000025-in-thick hydrophobic Ni—P-PTFE coating (k=3.141 Btu/(h⊙ft⊙° F.)) has negligible thermal resistance (x/k=7.96×(h⊙ft²⊙° F.)/Btu).

The experiments were conducted by condensing saturated steam on 12 in×12 in square vertical plate that had 100 equally distributed round dimples that are 0.75-in diameter and 0.125-in deep separated by 1-in centers. Because the mounting mechanism blocked some of the plate, the effective heat transfer area was 10 in×10 in or 0.694 ft². (Note. This area does not include the additional area from the surface features such as dimples or grooves.)

TABLE 2
Bath composition for electroless
Ni—P-PTFE hydrophobic coating

| Ni—P—PTFE^{a} | | | Lead-free Ni—P—PTFE^{b} | | |
|---|---|---|---|---|---|
| NiSO₄ [symbol] 6H₂O | 25 | g/L | NiSO₄ [symbol] 6H₂O | 30 | g/L |
| NaH₂PO₂ [symbol] H₂O | 30 | g/L | NaH₂PO₂ [symbol] H₂O | 30 | g/L |
| *Na₃C₆H₅O₇ [symbol] 2H₂O | 18 | g/L | Lactic acid | 25 | mL/L |
| Sodium acetate | 18 | g/L | Sodium acetate | 10 | g/L |
| (CH₂) CS | 1 | ppm | Accelerator | 4 | g/L |
| Lead acetate (stabilizer) | 3 | ppm | KIO₃ (stabilizer) | 5 | ppm |
| PTFE (60 wt %) | 10 | mL/L | PTFE (60 wt %) | 4-50 | mL/L |
| C₂₀H₂₀F₂₃N₂O₄I (FC-4) | 0.4 | g/L | | | |

| | | | |
|---|---|---|---|
| pH | 4.8 | pH | 4.6-5 |
| T (° C.) | 88 | T (° C.) | 90 ± 2 |

*Sodium citrate

Four plate substrates were tested:

(1) 0.030-in-thick naval brass 464 plate, the entire surface was modified with 0.000025-in-thick Ni—P-PTFE hydrophobic coating. Prior to coating, the boiling surface was sand blasted.

(2) 0.008-in-thick copper, which was fully coated with 0.000025-in-thick Ni—P-PTFE hydrophobic layer. Because it buckled the plate, no sand blasting was employed.

(3) bare 0.005-in-thick titanium grade 2. Because it buckled the plate, no sand blasting was employed.

(4) 0.008-in-thick vertical grooved copper, which was fully coated with 0.000025-in-thick Ni—P-PTFE hydrophobic layer. The last experiment was performed on this plate with lead-free 0.0001-in-thick hydrophobic Ni—P-PTFE coating. Because it buckled the plate, no sand blasting was employed. The bottoms of the grooves were ˜0.12 inches in diameter.

Apparatus and Procedure

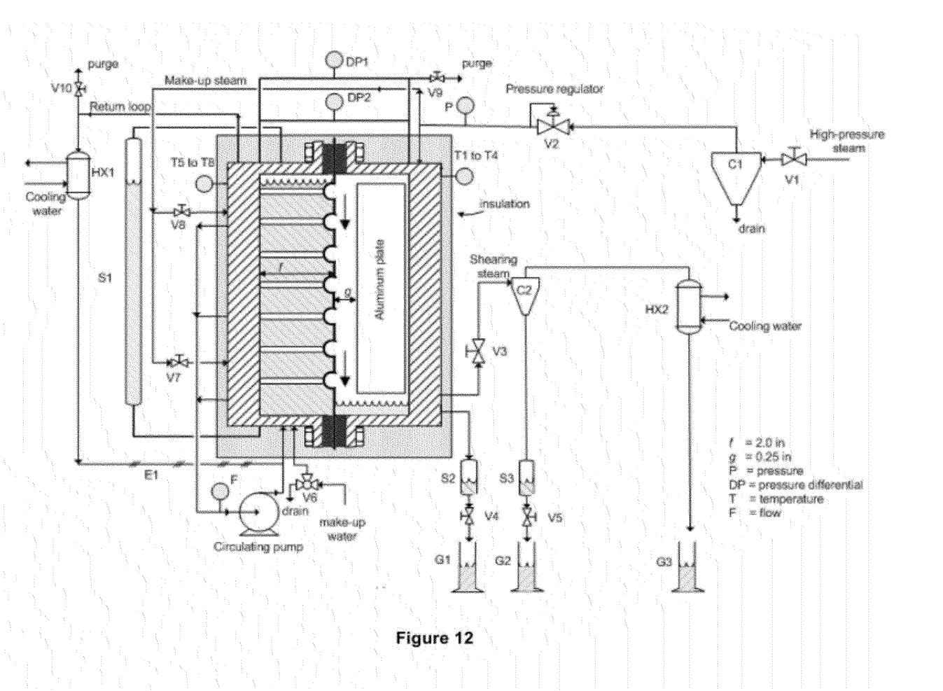

The experimental apparatus was tailored to observe and manipulate key heat transfer variables. FIG. 12 depicts a schematic drawing of the apparatus, which consists of two sections: (1) a boiling water chamber and (2) a condensing steam chamber. Both chambers are made of stainless steel 304 and are divided by the test plate. The whole assembly is bolted together. To prevent leakage, a gasket (Style NA1001, manufactured by TEADIT N.A., compressed non-asbestos sheet gasket material produced from a combination of aramid and other synthetic fibers and bonded with nitrile rubber) was placed between each side of the test plate and frame.

To prevent the test plate from deforming under high differential pressure, a support system was required. Two types were employed:

a) A pin grid extended to the housing wall. This was used for Plates 1 and 2.

b) A solid aluminum plate wrapped with a thin copper plate emulating the actual channel configuration in both the liquid and the steam sides. This was used for Plates 3 and 4.

High-pressure steam enters valve V1 into cyclone C1 where liquid is separated, thus ensuring the steam quality entering the apparatus is 1.0. Pressure regulator V2 sets the condenser pressure, which is measured by pressure gauge P. The steam enters the condenser, which has a 0.125-in gap that is set by the thickness of the aluminum plate inserted into the condenser. At the bottom of the condenser, condensate flows into sight glass S2. By manually opening valve V4, the liquid level in sight glass. S2 may be maintained constant. The drained liquid is collected in graduated cylinder G1 and is measured over a 90-s interval. (Note: This manual method of collecting condensate was more reproducible than steam traps.)

The rate of shearing steam flowing past the plate is regulated by valve. Cyclone separates liquid entrained with the shearing steam. The collected liquid enters sight glass; by manually opening valve, the liquid level in sight glass is kept constant. The drained liquid collected in graduated cylinder is measured over a 90-s interval. The sum of the liquid collected in graduated cylinders is m in Equation 1.3. The steam exiting cyclone enters heat exchanger where it condenses and is collected in graduated cylinder over a 90-s interval. The amount of liquid collected in graduated cylinder is compared to the amount of liquid collected in graduated cylinders so that the ratio R of each flow may be measured. Knowing the gap g (0.125 in), the plate depth, and the steam density allows the velocity of the shearing steam ν to be measured.

In separate outlets, the experimental apparatus may collect the shearing steam condensate and the condensate exiting the condensing chamber. The flow ratio R between the shearing steam condensate and the condensing chamber condensate provides an index of how fast the shearing steam travels along the condensing surface while inducing forced-convection heat transfer.

The boiling side is flooded with tap water; sight glass ensures the liquid level is kept constant. If necessary, excess liquid may be drained or make up water added by manually opening three-way valve. The steam evaporated from the boiler enters heat exchanger where it condenses. The condensate is heated to saturation using electric resistance heater. If necessary, make-up steam may be added to the boiler by opening valves.

To induce forced convection in the boiler, a pump (Cole-Parmer No. 7301-40, 115 GPM, high-temperature rated, with stainless steel impeller, with Viton seals) circulates the liquid. An all-metal flow meter (Flow Line Options, Model 12ABH120DLT, max temp=400° F.) measures the rate of circulating liquid. Knowing the gap f and the plate dimensions, the liquid velocity may be calculated.

To ensure that non-condensable gases are removed from the system, valves allow a small stream to be purged to the atmosphere. The differential pressure between the two chambers is measured using differential pressure gauges (Orange Research, diaphragm-type, rotary magnet sensor scales). One operates from 0 to 2 psid and the other operates from 0 to 10 psid. The measured pressure differential ΔP between chambers and the steam pressure P allows ΔT to be determined using steam tables.

Four thermocouples (Type J/316 stainless steel sheath, ⅛-in diameter) measure the temperatures in each quadrant of the condenser. Similarly, four thermocouples measure the temperatures in each quadrant of the boiler. Because thermocouples are not particularly accurate, they were not used to measure ΔT across the test plate. Instead, their purpose was to ensure uniform temperatures in each quadrant of the boiler and of the condenser. Using steam tables, the thermocouple readings were found to be consistent with the readings taken by the pressure gauge P and differential pressure gauges.

Thermal losses from insulation are calculated by opening valves, which equalizes the pressures in both chambers with saturated steam so there is no temperature difference across the plate. The condensate is collected and used to determine the heat loss through the steam-side insulation. This collected steady-state condensate serves as the baseline, which is subtracted from the condensate collected during experiments; the net condensate collected (m) is substituted in Equation 1.3 to calculate heat flux. This allows the heat transfer through the plate to be measured without interference from heat loss through the insulation.

The temperature differential ΔT between the steam side and the liquid side is set by the amount of cooling water flowing through the heat exchanger, the amount of make-up steam added through valves, and the heat added through resistance heater. The apparatus is allowed to operate until steady state is reached. Condensate is collected for 90-s periods. Five similar readings are required before the mean value is recorded.

Sample Calculation:

The overall heat transfer coefficient is calculated from Equation 1.2

$$U = ( \frac{q}{Δ T} )$$

where the heat flux q is calculated from Equation 1.3

q=(m⊙h_{fg})/A

The latent heat of condensation h_{fg} is determined from steam tables based on the condensing steam pressure reading. For ΔT=0.35° F. and P=104.7 psia

h_{fg}=(1188.9−301.97)Btu/lbₘ=886.93 Btu/lbₘ

The effective heat transfer area without area adjustments due to dimpling is 0.694 ft².

During the experiment, the collected condensate was 110 mL/90 s (i.e., 1.22 mL/s) and the condensate collected during the heat loss evaluation was 22 mL/90 s (i.e., 0.24 mL/s); therefore,

$$\begin{matrix}q = \frac{[ \begin{matrix}( 1.22 \frac{mL}{s} - 0.24 \frac{mL}{s} ) \times ( \frac{1 kg}{1000 mL} ) \times \\ ( \frac{2.2 {lb}_{m}}{ 1 kg} ) \times ( \frac{3600 s}{1 h} ) \times 8863.93 \frac{Btu}{{lb}_{m}}\end{matrix} ]}{0.694 {ft}^{2}} \\ = \frac{[ 7.76 \frac{{lb}_{m}}{h} \times 886.93 \frac{Btu}{{lb}_{m}} ]}{0.694 {ft}^{2}} \\ = 9917 \frac{Btu}{h \cdot {ft}^{2}}\end{matrix}$$

The overall heat transfer coefficient is

$$U = ( \frac{9917 \frac{Btu}{h \cdot {ft}^{2}}}{0.35 ° F .} ) = 28 , 340 \frac{Btu}{h \cdot {ft}^{2} \cdot ° F .}$$

To avoid plate damage during start-up and shut-down, the pressure differential should not exceed 2 psid. This is accomplished by opening valves, which ensures pressures are equal during start-up and shut-down

Overall heat transfer coefficient measurements were performed within a steam pressure range from 55 to 105 psia. For each experiment performed at a constant steam pressure P, various temperature differentials ΔT were employed across the plate. This allows U or q to be measured as a function of P and ΔT.

The experimental apparatus may create both gravity-controlled and steam shearing-controlled condensation with varying shearing steam velocities over the condensing surface. In this fashion, it is possible to measure U and q at different shearing velocities and compare both modes of condensation.

Some experiments included dynamic nucleation sites in the saturated liquid chamber by circulating Teflon boiling stones (Saint-Gobain Chemware D1069103 boiling stones).

Table 3 summarizes the experimental conditions.

TABLE 3
Summary of experimental conditions used in this disclosure

| | | | | | | | | | | | Min. |
|---|---|---|---|---|---|---|---|---|---|---|---|
| | | | | | | | | | Max. | Max. | ΔT |
| | | Coating | Hydrophobic | | Shearing | Liquid | Liquid- | | steam | steam | across |
| | | thickness | coating | Surface | steam | convection | side | Boiling | pressure | temp | plates |
| Fig. | Substrate | (inches) | chemistry | geometry | (ft/s) | (ft/s) | nucleation | stones | (psia) | (° F.) | (° F.) |
| 13 | Naval brass | No | Ni—P-PTFE | Round | 0.25 | No | Sand | No | 104.7 | 331 | 0.5 |
| | 464 | | | dimples | | | blasted | | | | |
| | 0.030-in- | | | | | | | | | | |
| | thick | | | | | | | | | | |
| 17 | Naval brass | 0.000025 | Ni—P-PTFE | Round | 0.25 | No | Sand | No | 104.7 | 331 | 0.35 |
| | 464 | | | dimples | | | blasted | | | | |
| | 0.030-in- | | | | | | | | | | |
| | thick | | | | | | | | | | |
| 19 | Naval brass | 0.000025 | Ni—P-PTFE | Round | 0.25 | 10.3 | Sand | No | 104.7 | 331 | 0.35 |
| | 464 | | | dimples | | | blasted | | | | |
| | 0.030-in- | | | | | | | | | | |
| | thick | | | | | | | | | | |
| 23 | Copper | 0.000025 | Ni—P-PTFE | Round | 1.4 | 5.15 | No | No | 104.7 | 331 | 0.35 |
| | 0.008-in- | | | dimples | | | | | | | |
| | thick | | | | | | | | | | |
| 30 | Copper | 0.000025 | Ni—P-PTFE | Round | 1.6 | 5.15 | No | Yes | 104.7 | 331 | 0.35 |
| | 0.008-in- | | | dimples | | | | | | | |
| | thick | | | | | | | | | | |
| 37 | Titanium | No | Ni—P-PTFE | Round | 0.5 | 5.15 | No | No | 104.7 | 331 | 0.35 |
| | 0.005-in- | | | dimples | | | | | | | |
| | thick | | | | | | | | | | |
| 44 | Copper | 0.000025 | Ni—P-PTFE | Vertical | 0.53 | 5.15 | No | No | 104.7 | 331 | 0.35 |
| | 0.008-in- | | | grooves | | | | | | | |
| | thick | | | | | | | | | | |
| 51 | Copper | 0.00005 | Ni—P-PTFE | Round | Yes/NR | 5.15 | No | No | 104.7 | 331 | 0.35 |
| | 0.008-in- | | | dimples | | | | | | | |
| | thick | | | | | | | | | | |
| 51 | Copper | 0.0005 | Ni—P-PTFE | Round | Yes/NR | 5.15 | No | No | 104.7 | 331 | 0.35 |
| | 0.008-in- | | | dimples | | | | | | | |
| | thick | | | | | | | | | | |
| 51 | Copper | 0.005 | Ni—P-PTFE | Round | Yes/NR | 5.15 | No | No | 104.7 | 331 | 0.35 |
| | 0.008-in- | | | dimples | | | | | | | |
| | thick | | | | | | | | | | |
| 54 | Copper | 0.0001 | Lead-free | Round | 0.67 | 5.15 | No | No | 104.7 | 331 | 0.35 |
| | 0.008-in- | | Ni—P-PTFE | dimples | | | | | | | |
| | thick | | | | | | | | | | |
| 61 | Copper | 0.0001 | Lead-free | Vertical | 0.76 | 5.15 | No | No | 104.7 | 331 | 0.35 |
| | 0.008-in- | | Ni—P-PTFE | grooves | | | | | | | |
| | thick | | | | | | | | | | |

Section 3. Heat Transfer in Dimpled-Naval Brass 464 Plates

Naval brass 464 plates (Cu 59.62 wt %, Zn 39.2 wt %, Sn 0.5-1 wt %, Fe wt % Max 0.1, Pb wt % Max 0.2) had thermal conductivity k=67 Btu/(h⊙ft⊙° F.). Bare surface on the condensing chamber produced filmwise condensation, whereas thin hydrophobic coating promoted dropwise condensation. This experiment allows the benefits of dropwise condensation to be quantified.

3.1. Bare Naval Brass 464

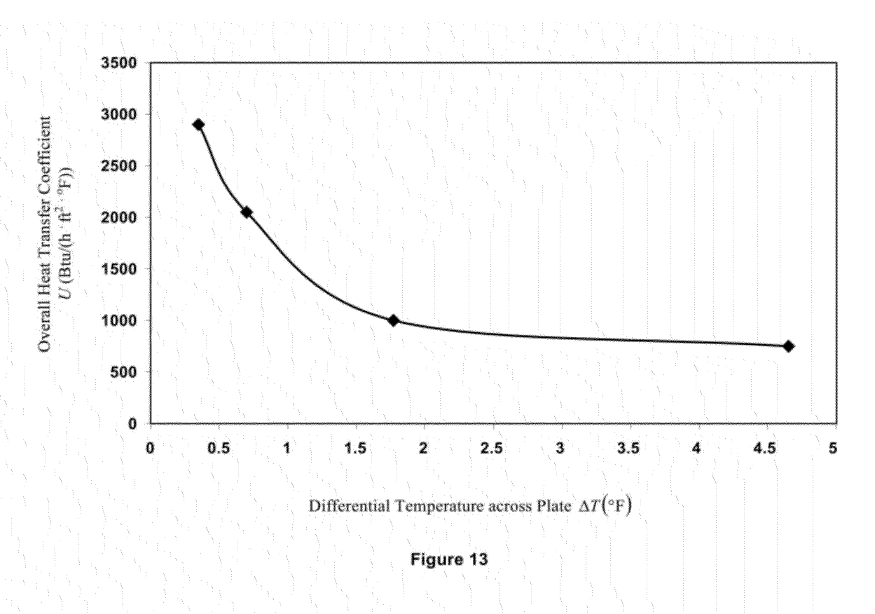

A bare 0.030-in-thick plate was tested. The water-side surface was modified with sand-blasting to favor nucleation during pool boiling. The steam side was supplied with saturated steam at T=331° F. and P=104.7 psia. The ΔT ranged from 0.5 to 4.7° F. The effect of shearing steam on the condensing surface was also studied. FIG. 13 shows the results for R=1.0 lb shearing steam/lb condensate. There was no forced convection on the liquid side. Data show relatively high heat transfer coefficients for filmwise condensation U≈2,900 Btu/(h⊙ft²⊙° F.) at ΔT=0.35° F., as compared to conventional heat exchangers for which U≈1,000 Btu/(h⊙ft²⊙° F.). For this case, heat transfer was enhanced by shearing steam on the condensing surface and nucleation in the boiling chamber. There are significant scaling effects on bare naval brass 464 after it was exposed to boiling at ˜330° F.

3.2. Thin Hydrophobic Coating on Naval Brass 464

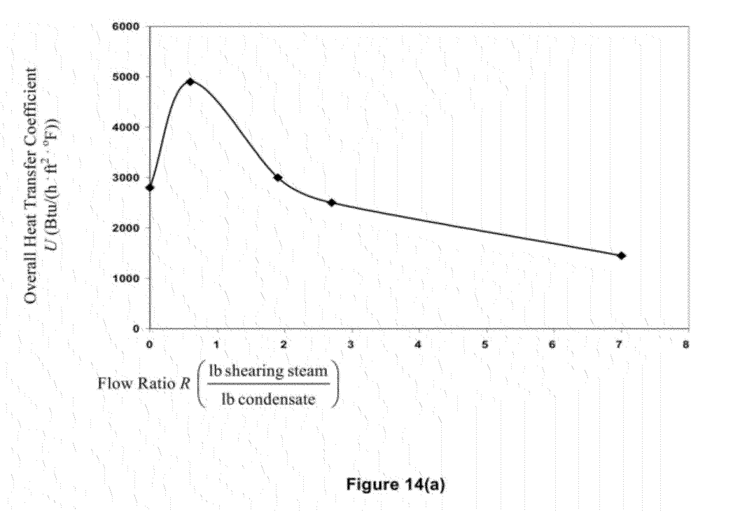

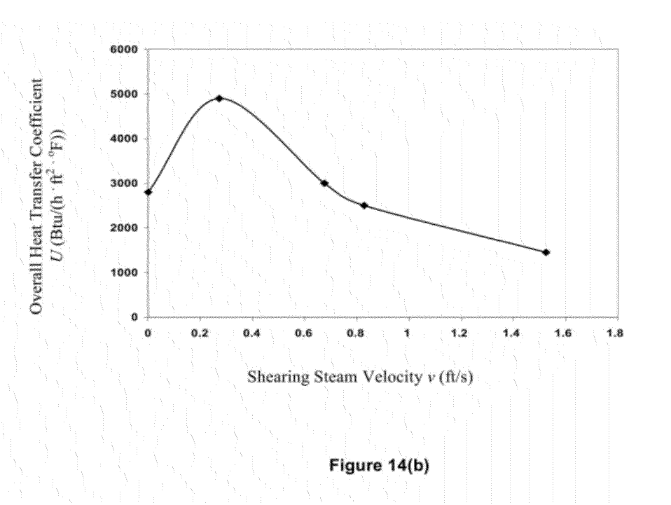

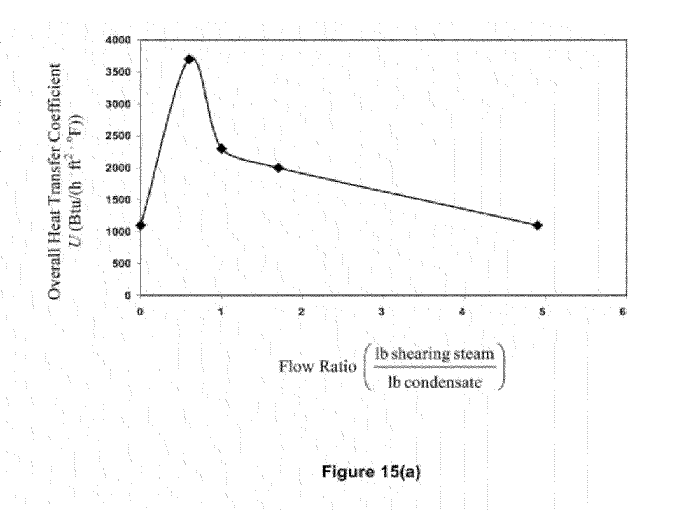

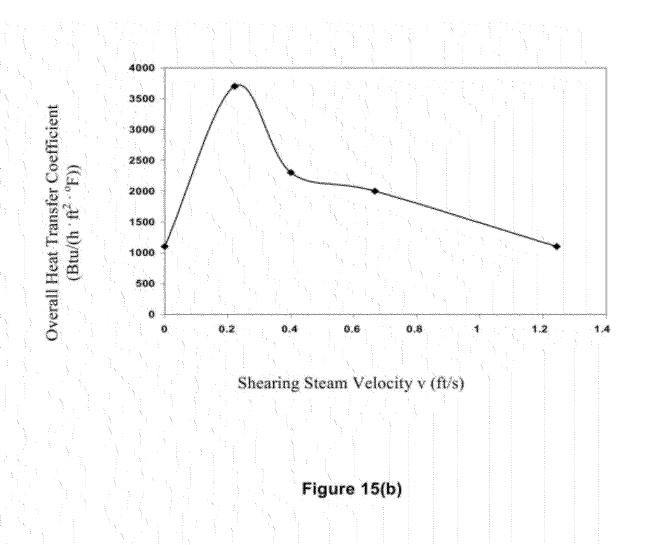

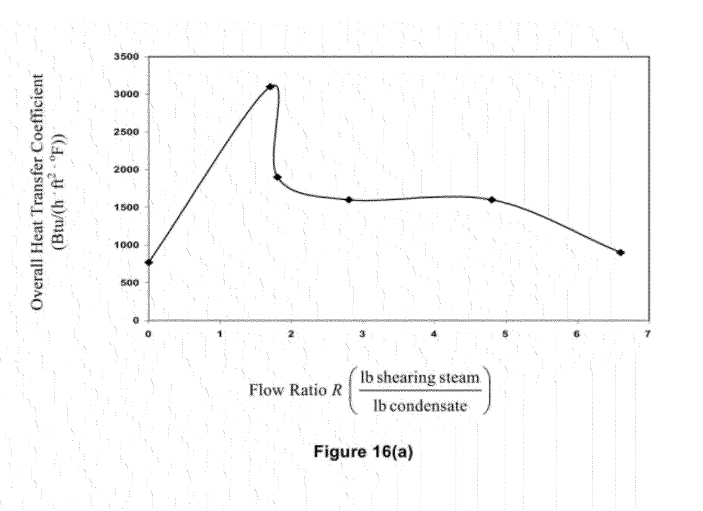

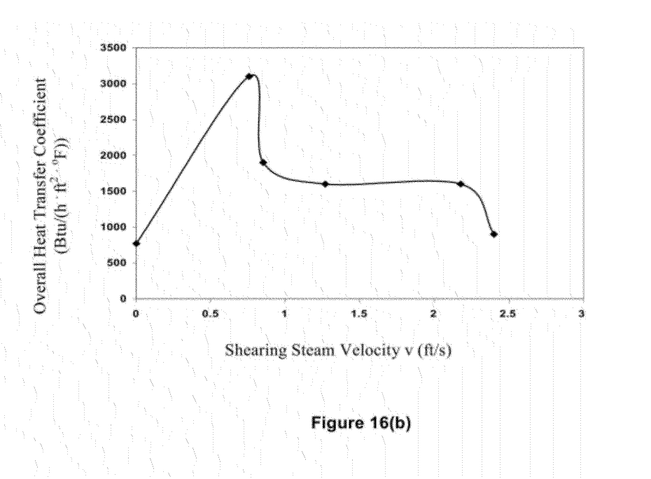

Naval brass 464 surfaces were modified using Ni—P-PTFE hydrophobic coating. The test was performed with natural convection in the condensing chamber. Shearing steam was provided on the condensing side. FIGS. 14 (104.7 psia), 15 (76.7 psia), and 16 (59.2 psia) show variations of the overall heat transfer coefficient with shearing steam for given ΔT. FIGS. 14a, 15a, and 16a present the heat transfer coefficient as a function of R, whereas FIGS. 14b, 15b, and 16b present the heat transfer coefficient as function of shear velocities. In each figure, it is apparent that there is an optimal flow ratio R for each condition.

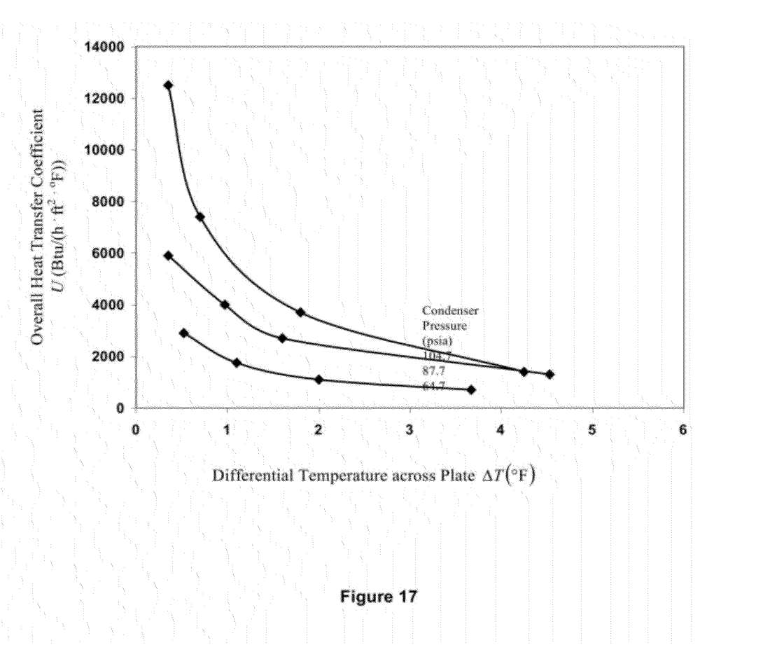

FIG. 17 shows comparable results for the test plate that was sand-blasted on the water side and coated on both sides with 0.000025-in Ni—P-PTFE hydrophobic coating operating at different saturated steam pressures. For this case, the best heat transfer coefficient was U=12,500 Btu/(h⊙ft²⊙° F.) (T=331° F., P=104.7 psia, ΔT=0.35° F.). A coated brass plate has significantly less corrosion than a bare brass plate.

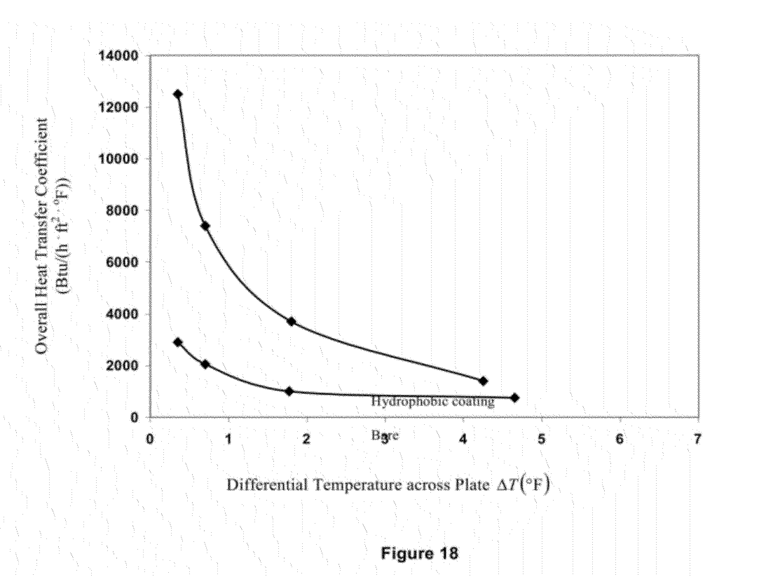

FIG. 18 compares the performance of coated and uncoated plates at 104.7 psia. At low ΔT (<1° F.), the hydrophobic coating increased the heat transfer coefficient by 4.3 times.

3.3. Effect of Forced Convection on the Water Side

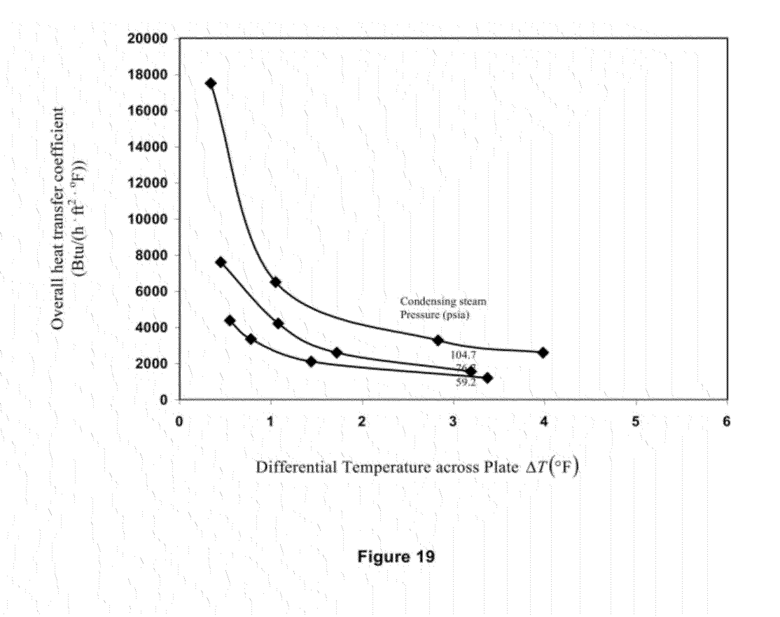

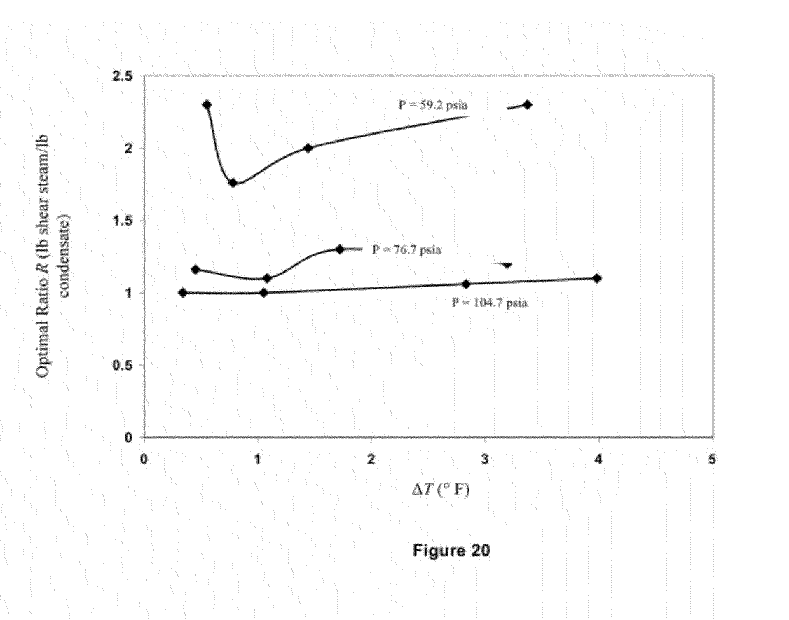

In addition to shearing steam over the condensing surface, forced convection on the liquid side of the test plate was induced by a centrifugal circulating pump. FIG. 19 shows that forced convection increases the best overall heat transfer coefficient to U=17,500 Btu/(h⊙ft²⊙° F.)=331° F., P=104.7 psia, ΔT=0.35° F.). FIG. 20 shows the optimal values of R used to obtain the data in FIG. 19. Interestingly, the present experimental study shows that the condensation heat transfer coefficient has its maximum value when R≈1 lb shearing steam/lb condensate at 104.7 psia. The optimal shearing steam velocity along the condensing surface for these operating conditions is ν=0.53 ft/s.

The following empirical equations describe each curve shown in FIG. 19:

U=7064(ΔT)^{-0.832} (P=104.7 psia) (3.1)

U=4119(ΔT)^{-0.819} (P=76.7 psia) (3.2)

U=2810(ΔT)^{-0.714} (P=59.2 psia) (3.3)

These equations may be used to calculate the heat flux:

q=UΔT=7064(ΔT)^{1-0.832}=7064(ΔT)^{0.198} (P=104.7 psia) (3.4)

q=UΔT=4119(ΔT)^{1-0.819}=4119(ΔT)^{0.180} (P=76.7 psia) (3.5)

q=UΔT=2810(ΔT)^{1-0.772}=2810(ΔT)^{0.286} (P=59.2 psia) (3.6)

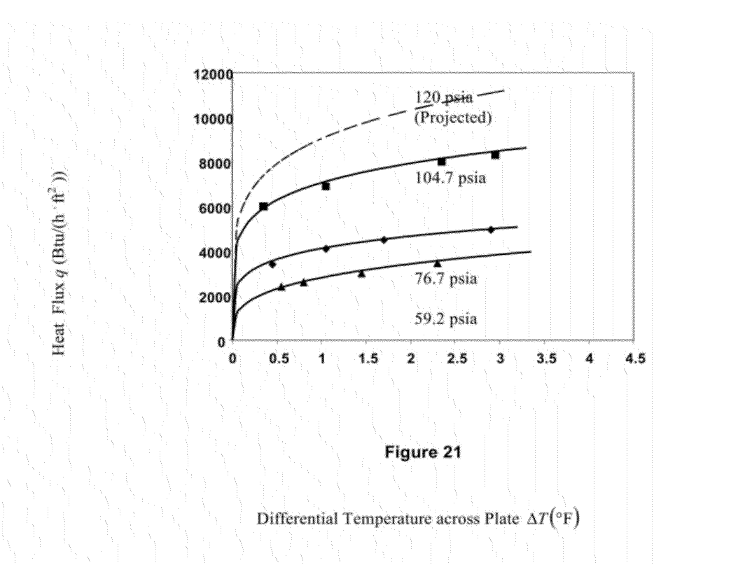

FIG. 21 shows heat flux q across the plate for different ΔT and P. The data show that the heat flux increases very sharply with ΔT when ΔT<˜0.30° F. At larger ΔT, the heat flux reaches a limiting value, likely resulting from the limited rate that droplets flow under the influence of gravity. From an engineering perspective, heat exchangers should be operated with ΔT≈0.35° F.; higher ΔT does not increase heat flux substantially, but does increase compressor power in mechanical vapor-compression (MVC) applications.

3.4. Correlation of Heat Exchanger Performance with Pressure

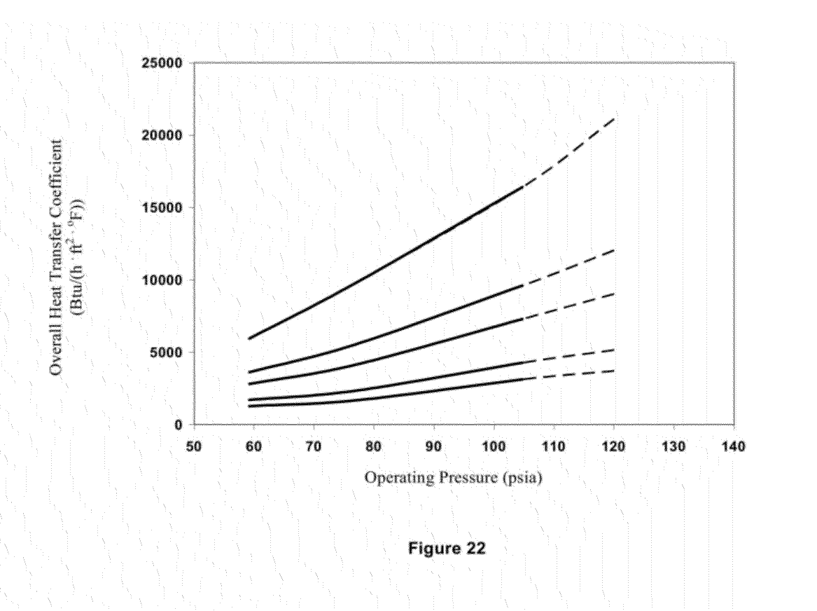

Previously, FIG. 19 showed heat transfer coefficient U as a function of ΔT for a constant P. FIG. 22 shows the same data where U is a function of P for a given ΔT. The following correlations were used to construct FIG. 22:

U=4.271(P)^{1.777} (ΔT=0.35° F.) (3.7)

U=3.323(P)^{1.712} (ΔT=0.70° F.) (3.8)

U=2.916(P)^{1.679} (ΔT=1.0° F.) (3.9)

U=2.265(P)^{1.615} (ΔT=2.0° F.) (3.10)

U=1.956(P)^{1.577} (ΔT=3.0° F.) (3.11)

High operating pressures allow advanced vapor-compression desalination systems to use smaller compressors.

FIG. 22 shows the projected heat transfer coefficient for a working pressure P=120 psia, which the literature suggests is the maximum pressure where dropwise condensation occurs. (Note: This assumption must be tested but it is not possible for the current source of steam, which is limited to 104.7 psia). Accordingly, for operating pressure P=120 psia and ΔT=0.35° F., the estimated heat transfer coefficient is calculated from Equation 3.7:

U=4.271(120)^{1.777}≈21,100 Btu/(h⊙ft²⊙° F.)

Section 4. Investigation of Thin Copper Plates

Equation 1.1 shows that for high heat transfer coefficients on both the condensing (h_{cond}) and boiling (h_{boiling}) sides, the material resistance (x/k) limits the overall heat transfer coefficient. Therefore, reducing the material thickness x and increasing the thermal conductivity k will enhance the overall heat transfer coefficient. A 0.008-in-thick copper plate fully coated with Ni—P-PTFE thin-coating was tested (multi-purpose copper alloy 110, Cu>99.0%, cold rolled, soft annealed, excellent soldering property, k=231 Btu/(h⊙ft⊙° F.), McMaster-Carr No. 8944K36).

4.1. Experimental Results

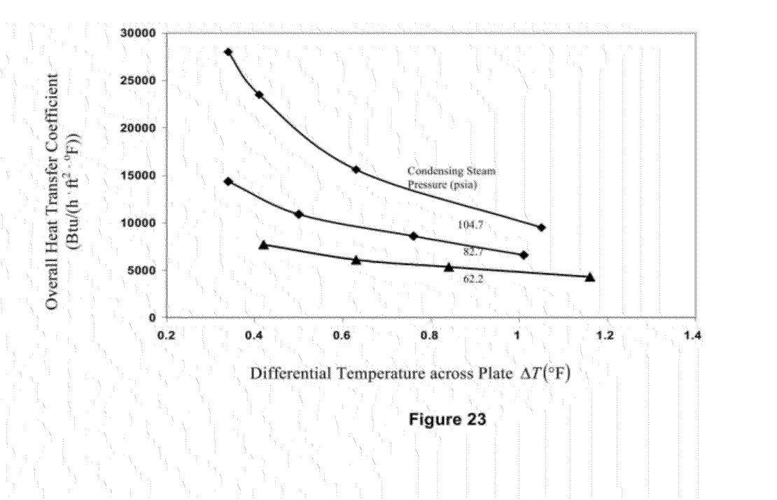

FIG. 23 shows the overall heat transfer coefficients corresponding to different temperature differences across the plate at various constant saturated steam pressures.

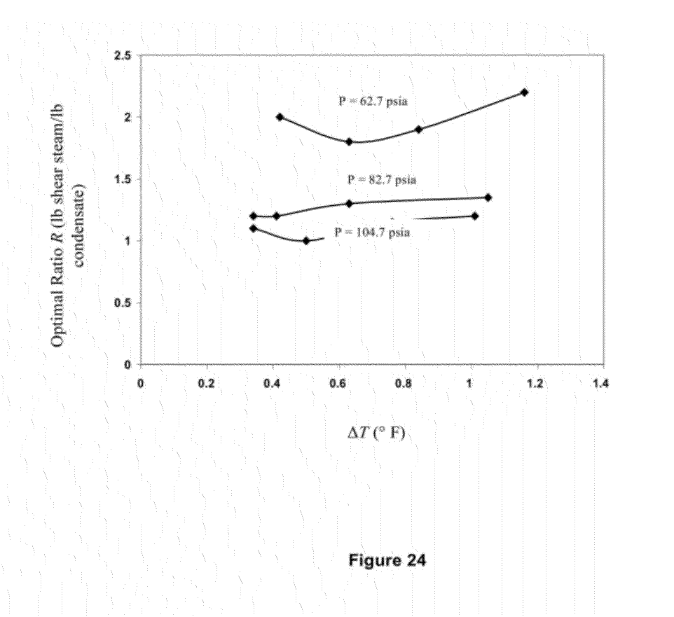

Forced convection is imposed on the saturated liquid side. FIG. 24 shows the optimal values of R used to obtain the data in FIG. 23 The separation f was 0.25 in (see FIG. 12), and the plate is 10-in wide; therefore, the cross-sectional area in the liquid side is 2.5 in² or 0.173 ft². During the experiment, flow meter F (see FIG. 12) indicated that the pump circulated a maximum of 40 gal/min, which was used in the experiment; therefore, the saturated liquid moved upwards on the boiling surface with the following calculated velocity:

$${v}_{sat liq} = \frac{Q}{A} \\ {v}_{sat liq} = \frac{40 \frac{gal}{min} \times \frac{{ft}^{3}}{7.48 gal} \times \frac{min}{60 s}}{0.0173 {ft}^{2}} = 5.15 \frac{ft}{s} \qquad ( 4.1 )$$

For these operating conditions, the optimal shearing steam velocity along the condensing surface was ν=1.4 ft/s.

The following empirical equations describe the curves shown in FIG. 4.1:

U=9978(ΔT)^{-0.959} (P=104.7 psia) (4.2)

U=6824(ΔT)⁻⁰⁶⁹² (P=82.7 psia) (4.3)

U=4737 (ΔT)^{-0.564} (P=62.2 psia) (4.4)

These equations may be used to calculate the heat flux:

q=UΔT=9978(ΔT)^{1-0.959}=9978(ΔT)^{0.046} (P=104.7 psia) (4.5)

q=UΔT=6824(ΔT)^{1-0.692}=6824(ΔT)^{0.308} (P=82.7 psia) (4.6)

q=UΔT=4737(ΔT)^{1-0.564}=4737(ΔT)^{0.436} (P=62.7 psia) (4.7)

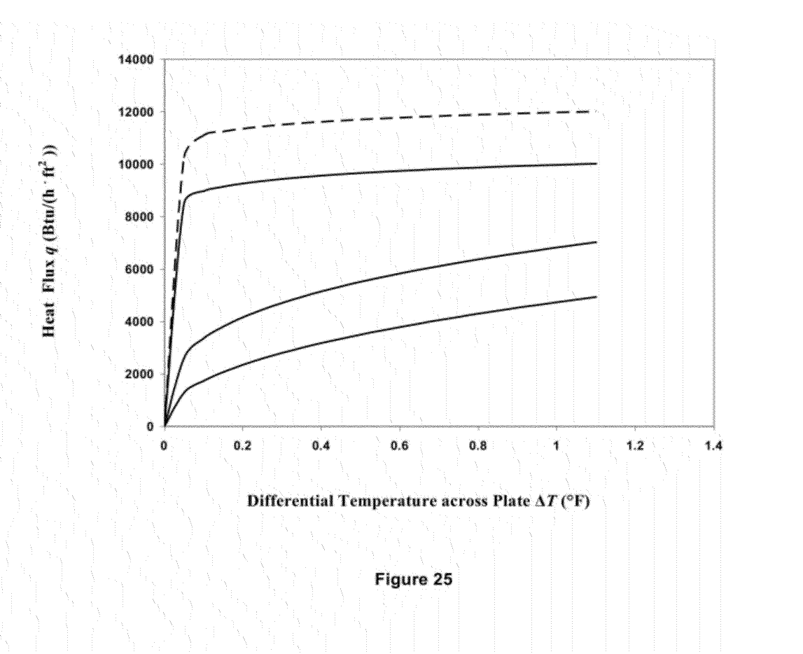

FIG. 25 shows heat flux q across the plate for different ΔT and P. Similar to naval brass, copper data show that with dropwise condensation, the heat flux increases sharply with ΔT when ΔT<˜0.30° F. At larger ΔT, the heat flux reaches a limiting value. Therefore, copper heat exchangers should be operated with ΔT≈0.35° F.; higher ΔT does not increase heat flux substantially, but does increase compressor power in mechanical vapor-compression (MVC) applications.

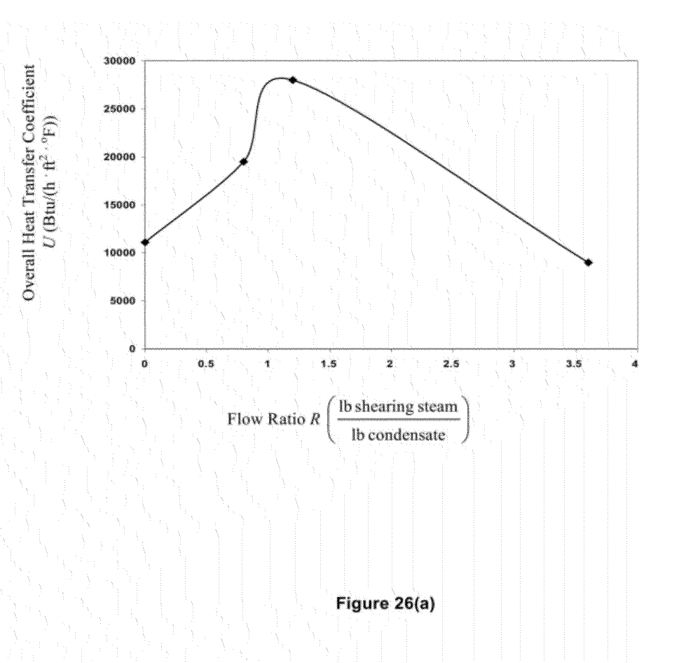

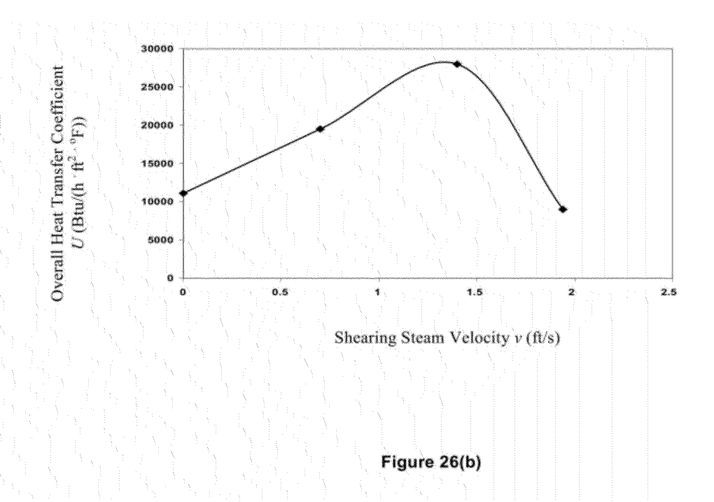

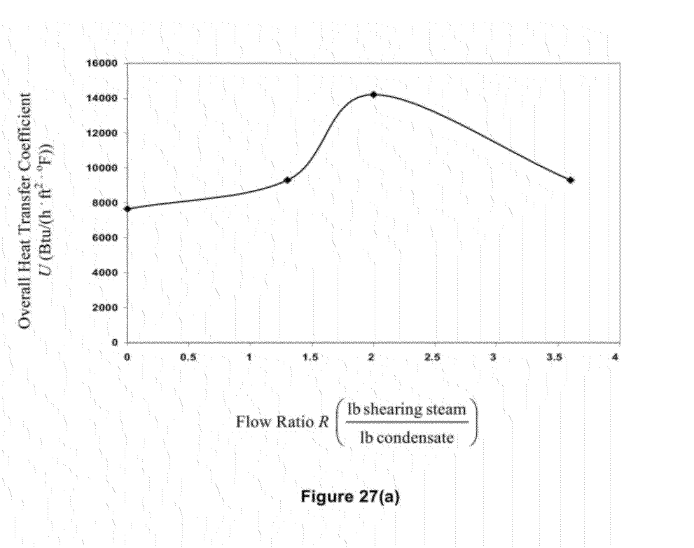

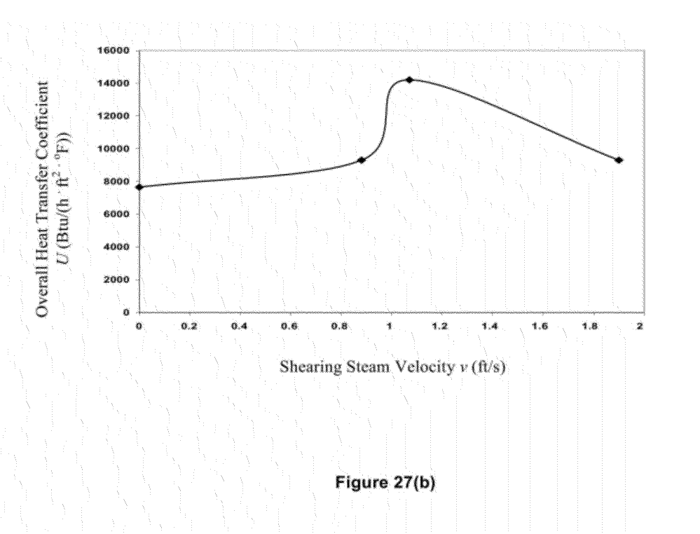

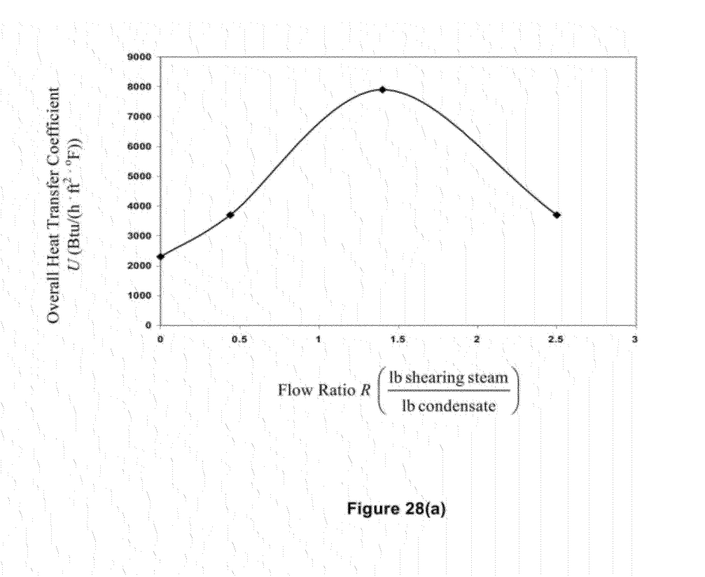

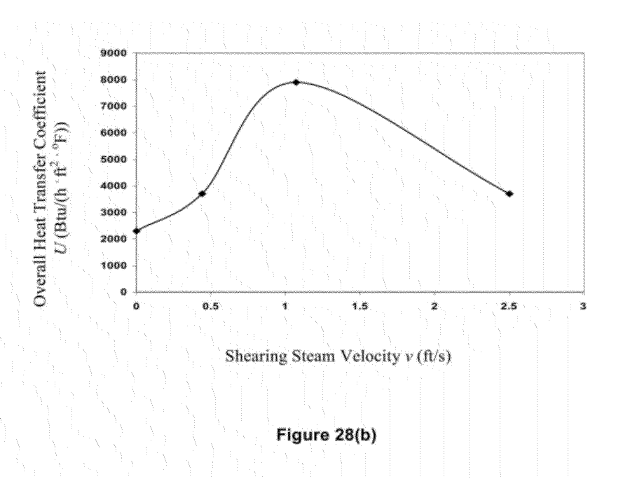

Using 0.000025-in hydrophobic coating with forced convection on the saturated liquid side, FIGS. 26 (104.7 psia), 27 (82.7 psia), and 28 (62.7 psia) show variations of the overall heat transfer coefficient with shearing steam for given ΔT. FIGS. 26a, 27a, and 28a present the heat transfer coefficient as a function of R, whereas FIGS. 26b, 27b, and 28b present the heat transfer coefficient as function of shear velocities. In each figure, is consistently apparent that there is an optimal flow ratio R and an optimal shear steam velocity for each condition. The design point (U=28,000 Btu/(h⊙ft2⊙° F.)) requires shearing velocity ν=1.4 ft/s and flow ratio R=1.4 lb shearing steam/lb condensate at P=104.7° F.

4.2. Correlation of Thin Copper Heat Exchanger Performance with Pressure

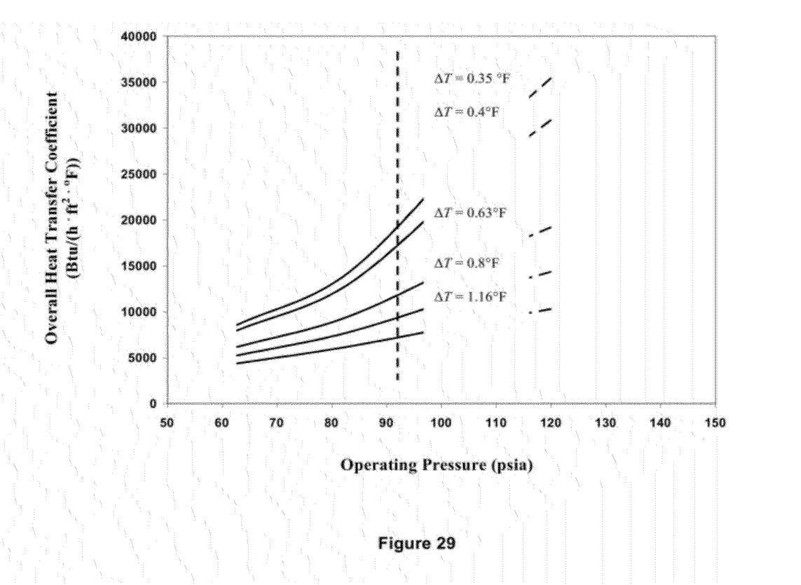

Previously, FIG. 23 showed heat transfer coefficient U as a function of ΔT for a constant P. FIG. 29 shows the same data where U is a function of P for a given ΔT. The following correlations were used to construct FIG. 29:

U=0.746(P)^{2.249} (ΔT=0.35° F.) (4.8)

U=1.058(P)^{2.147} (ΔT=0.40° F.) (4.9)

U=3.659(P)^{1.178} (ΔT=0.63° F.) (4.10)

U=7.379(P)^{1.582} (ΔT=0.8° F.) (4.11)

U=17.18(P)^{1.335} (ΔT=1.16° F.) (4.12)

FIG. 29 shows the projected heat transfer coefficient for working pressure P=120 psia.

4.3. Effect of PTFE Boiling Stones into Convective Boiling Side

The following factors affect the modes of condensation and boiling: surface sub-cooling, wall superheat, physical and chemical properties of the surface, and heat flux. Active nucleation sites on the boiling side promoted by PTFE boiling stones overcome bubble surface tension and thereby increase the heat flux across the plate. For a given ΔT, the boiling-side heat transfer coefficient increases, which increases the overall heat transfer coefficient. Additionally, PTFE boiling stones rub against the heat exchanger wall and reduce scale deposits.

In addition to its non-wettability property, Ni—P-PTFE hydrophobic coating also provides surfaces that resist abrasion (0.03 milligrams loss per 1,000 cycles using CS Wheel Taber Abrasion) and corrosion (>1,000 h, ASTM B 117 5% salt water at 35° C.). All these properties benefit MVC desalination. Experiments on heat exchangers show that the coating prevents chemical fouling and biofouling on the boiling surface. Newer non-toxic Ni—P-PTFE coatings employ lead-free technology to comply with stringent drinking water standards (NSF STD 61).

Copper, the plate substrate, does not resist salt water corrosion so active cathode protection may be needed as well to ensure long periods of operation. To some degree, the Ni—P—PTFE coating will resist corrosion, abrasion, and fouling. To obtain sustainable adhesion of hydrophobic layer to the substrate, multi-layer coatings should be applied by installing several Ni—P-PTFE baths with different ratios of cationic surfactant to PTFE particles.

If the plates are soldered together, the coating should be applied to the whole cassette of heat exchanger plates which will prevent damage to coating from the high temperatures employed by the soldering process.

4.4. Experimental Results with PTFE Boiling Stones

Experiments with 3.6 wt % PTFE boiling stones in the liquid side of the apparatus were performed.

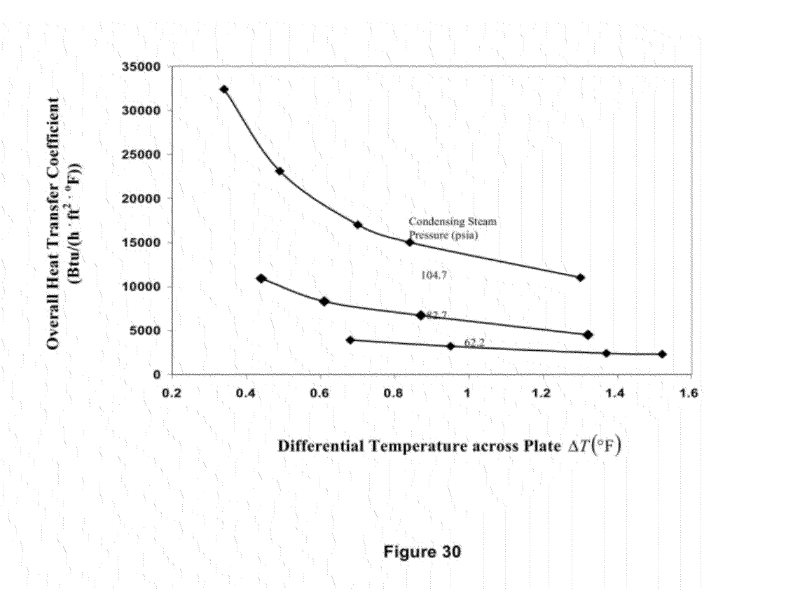

A 0.008-in-thick copper plate (k=231 Btu/(h⊙ft²⊙° F.)) was tested. The experiment protocol was described in Section 2. The plate was fully coated with 0.000025-in Ni—P-PTFE hydrophobic coating. FIG. 30 shows the overall heat transfer coefficients corresponding to different temperature gradients across the plate at different constant saturated steam pressures.

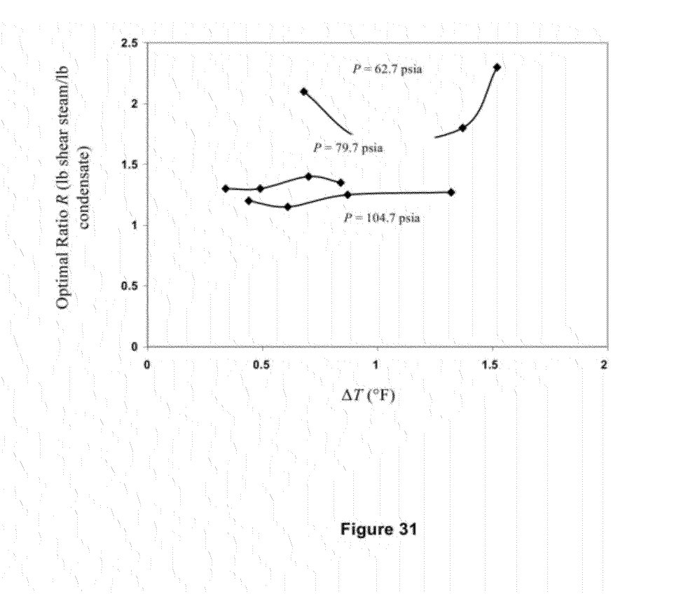

Forced convection was imposed in the saturated liquid side with ν_{sat liq}=5.15 ft/s. FIG. 31 shows the optimal values of R used to obtain the data in FIG. 30.

The optimal shearing steam velocity along the condensing surface for T=331° F., and P=104.7 psia was ν=1.6 ft/s.

The following empirical equations describe each of the curves shown in FIG. 30:

U=13190(ΔT)^{-0.805} (P=104.7 psia) (4.13)

U=5731(ΔT)^{-0.788} (P=79.7 psia) (4.14)

U=3030(ΔT)^{-0.6785} (P=62.7 psia) (4.15)

These equations may be used to calculate the heat flux:

q=UΔT=13190(ΔT)^{1-0.805}=13190(ΔT)^{0.194} (P=104.7 psia) (4.16)

q=UΔT=5731(ΔT)^{1-0.788}=5731(ΔT)^{0.212} (P=79.7 psia) (4.17)

q=UΔT=3030(ΔT)^{1-0.678}=3030(ΔT)^{0.321} (P=62.7 psia) (4.18)

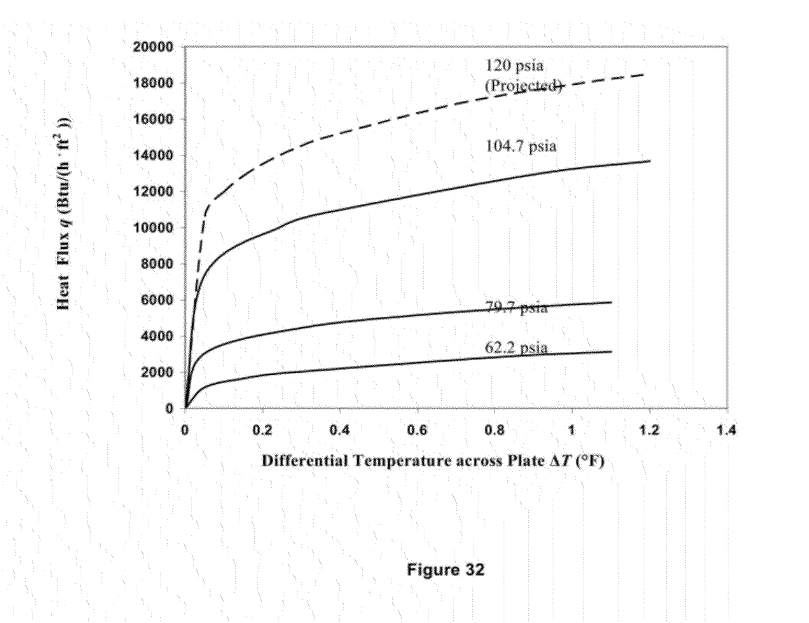

FIG. 32 shows heat flux q across the plate for different ΔT and P. Similar to the naval brass plate and thin copper reported earlier, data for copper with PTFE boiling stones in the saturated side show that the heat flux increases sharply with ΔT when ΔT<˜0.30° F. At larger ΔT, the heat flux reaches a limiting value. Therefore, copper heat exchangers should be operated with ΔT≈0.35° F.; higher ΔT does not increase heat flux substantially, but does increase compressor power in mechanical vapor-compression (MVC) applications.

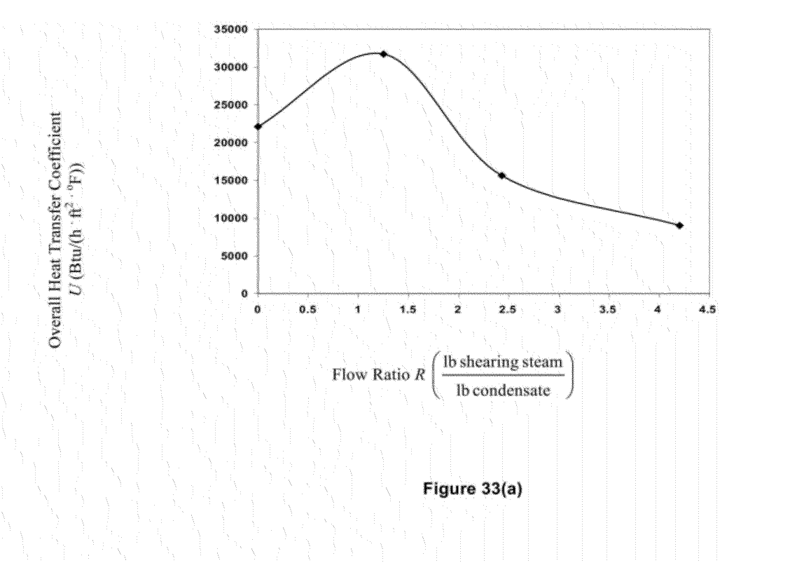

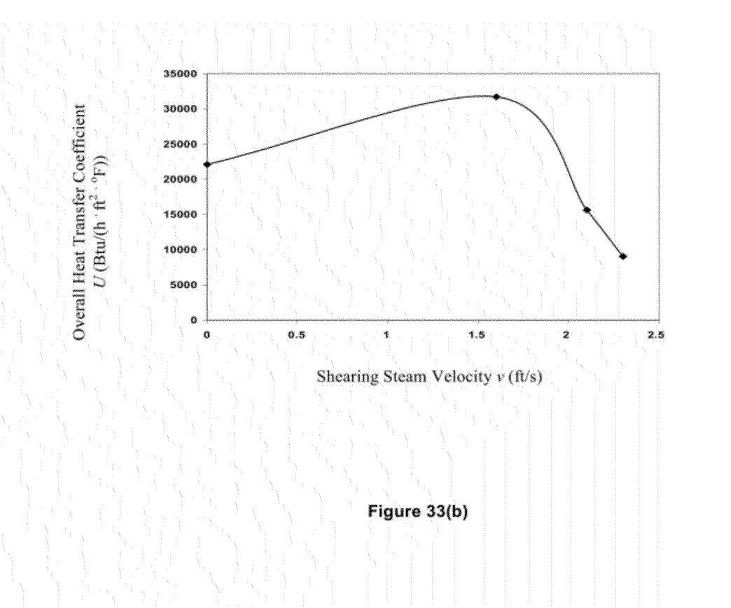

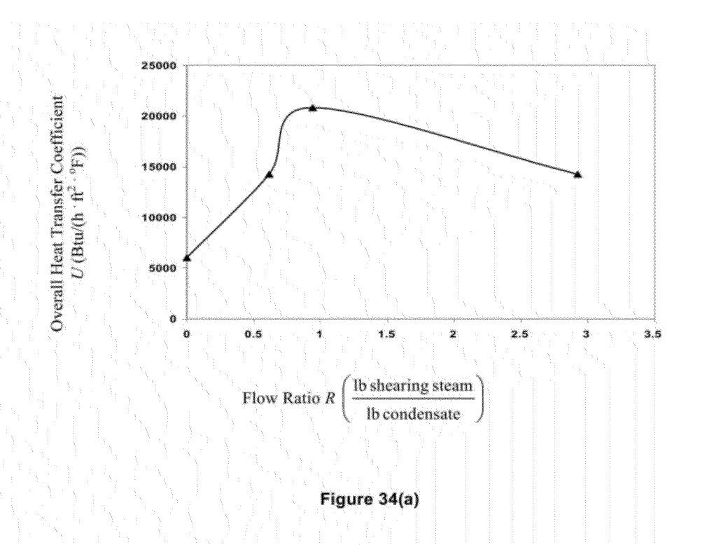

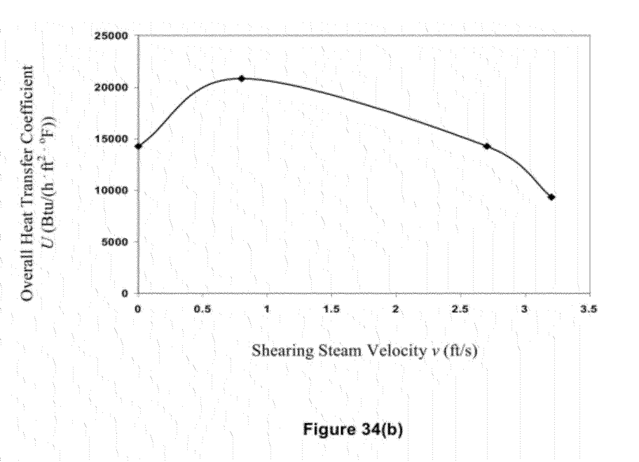

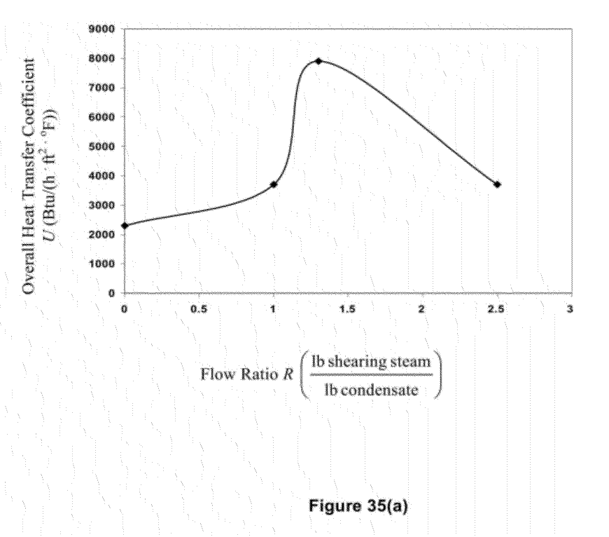

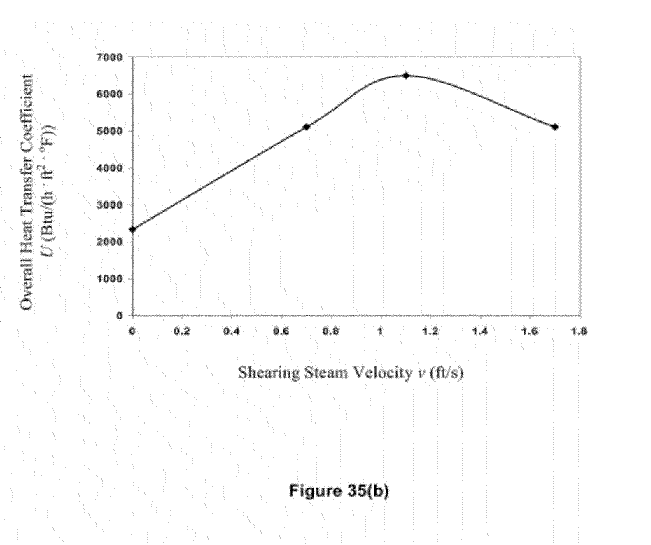

Using 0.000025-in hydrophobic coating with forced convection and PTFE boiling stones (3.6 wt %) on the saturated liquid side, FIGS. 33 (104.7 psia), 34 (82.7 psia), and 35 (62.7 psia) show variations of the overall heat transfer coefficient with shearing steam for a given ΔT. FIGS. 33a, 34a, and 35a present the heat transfer coefficient as a function of R, whereas FIGS. 33b, 34b, and 35b present the heat transfer coefficient as function of shear velocities. In each figure, it is consistently apparent that there is an optimal flow ratio R and an optimal shear steam velocity for each condition. At P=104.7 psia, the optimal design point (U=32,000 Btu/(h⊙ft²⊙° F.)) requires shear velocity ν=1.6 ft/s and R=1.2 lb shearing steam/lb condensate.

4.5. Correlation of Heat Exchanger Performance with Pressure

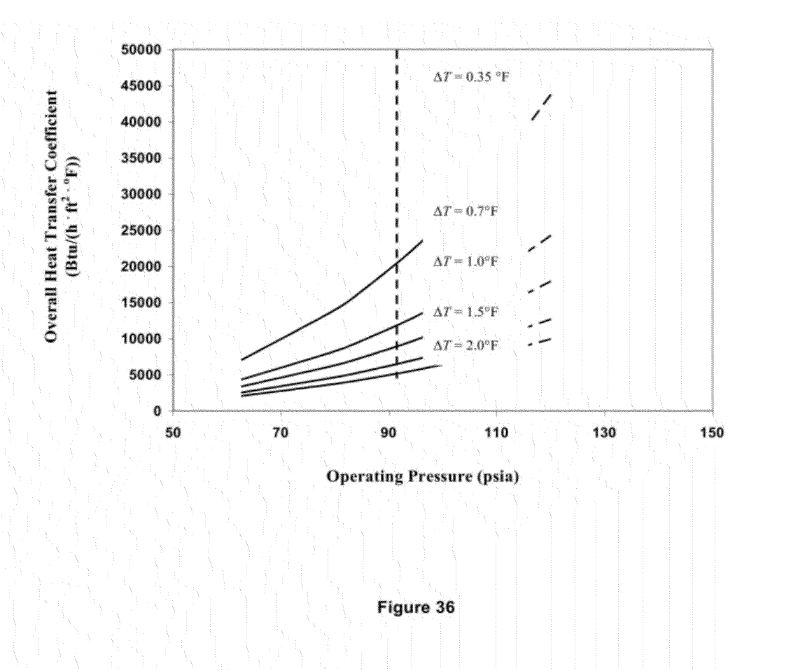

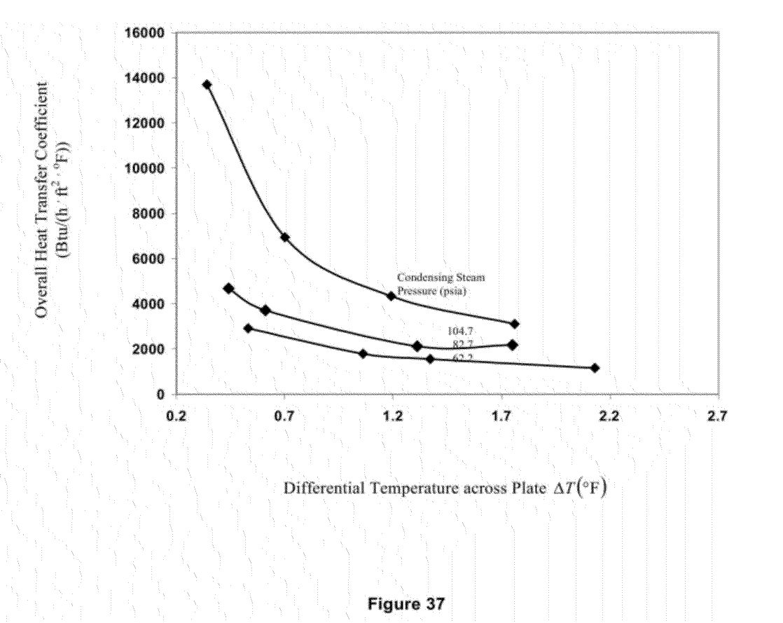

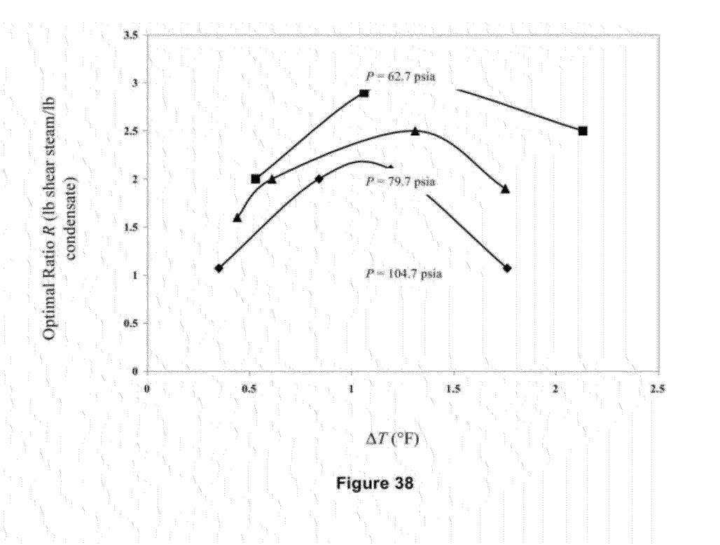

Previously, FIG. 30 showed heat transfer coefficient U as a function of ΔT for a constant P. FIG. 36 shows the same data where U is a function of P for a given ΔT. The following correlations were used to construct FIG. 36:

U=0.0630(P)^{2.809} (ΔT=0.35° F.) (4.19)

U=0.0737(P)^{2.654} (ΔT=0.70° F.) (4.20)

U=0.0799(P)^{2.573} (ΔT=1.0° F.) (4.21)

U=0.0876(P)^{2.482} (ΔT=1.5° F.) (4.22)

U=0.0935(P)^{2.413} (ΔT=2.0° F.) (4.23)

FIG. 36 shows the projected heat transfer coefficient for a working pressure P=120 psia.

Section 5. Experimental Investigation of Titanium Plates

The low surface energy of titanium promotes dropwise condensation which increases the heat flux. Furthermore, the high resistance of titanium to abrasion and fouling prevents buildup of corrosion products and minimizes external fouling films. Therefore, the resulting overall heat transfer rate of titanium surfaces is often comparable to that of metals with higher thermal conductivity. Additionally, titanium is easy to maintain, which makes it particularly useful in applications in oilfield produced water and carbon sequestration technologies where more aggressive contaminants are found.

5.1. Experimental Results

FIG. 37 shows the overall heat transfer coefficients corresponding to different temperature differences across the plate at different constant saturated steam pressures.

Forced convection is imposed in the saturated liquid side with v_{sat liq}=5.15 ft/s.

The optimal shearing steam velocity along the condensing surface was ν=0.5 ft/s (T=331° F., P=104.7 psia, ΔT=0.35° F.).

The following empirical equations describe each of the curves shown in FIG. 37:

U=−6483 ln(ΔT)+5892 (P=104.7 psia) (5.1)

U=2785(ΔT)^{-0.596} (P=79.7 psia) (5.2)

U=1900(ΔT)^{-0.659} (P=62.7 psia) (5.3)

These equations may be used to calculate the heat flux:

q=UΔT=[−6483 ln(ΔT)+5892](ΔT) (P=104.7 psia) (5.4)

q=UΔT=2785(ΔT)^{1-0.596}=2785(ΔT)^{0.403} (P=79.7 psia) (5.5)

q=UΔT=1900(ΔT)^{1-0.659}=1900 (P=62.7 psia) (5.6)

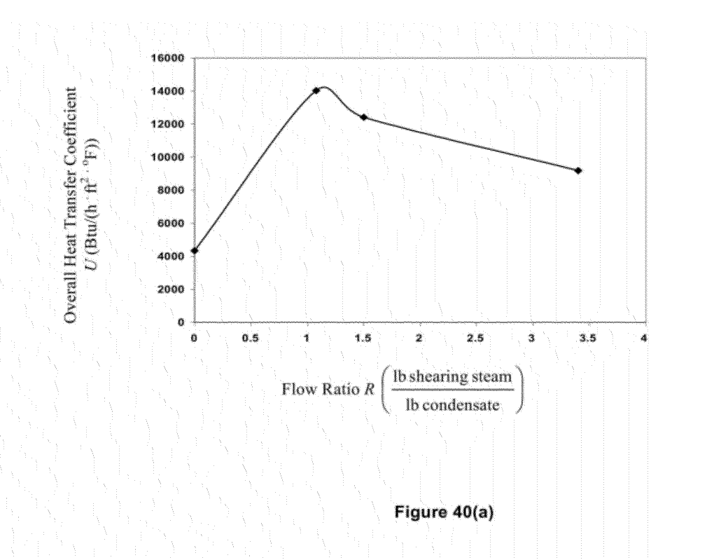

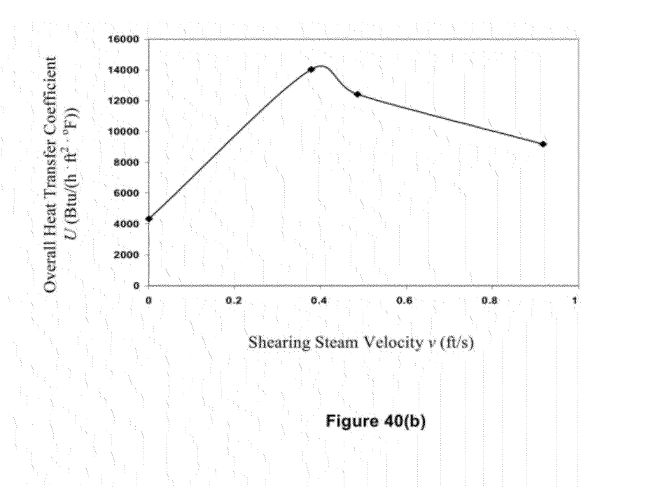

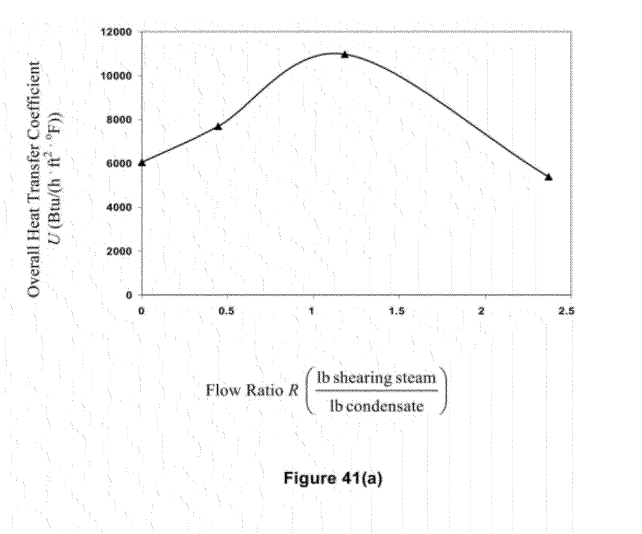

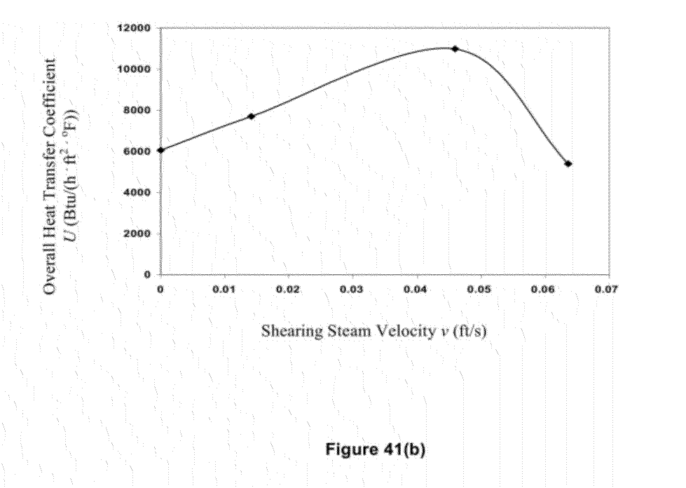

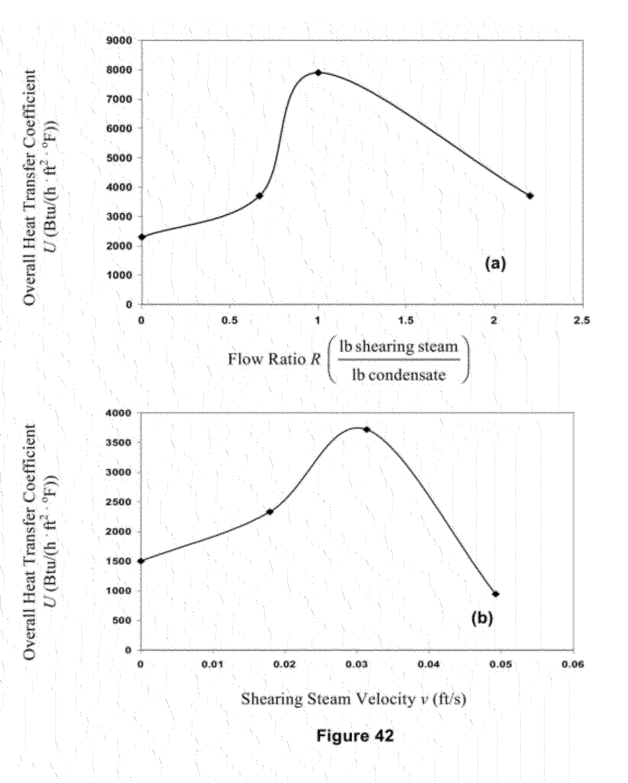

FIGS. 40 (104.7 psia), 41 (82.7 psia), and 42 (62.7 psia) show variations of the overall heat transfer coefficient with shearing steam for a given ΔT. FIGS. 40a, 41a, and 42a present the heat transfer coefficient as a function of R, whereas FIGS. 40b, 41b, and 42b present the heat transfer coefficient as function of shear velocities. In each figure, is consistently apparent that there is an optimal flow ratio R and an optimal shearing steam velocity for each condition. At P=104.7 psia, the design point (U=13,700 Btu/(h⊙ft²⊙° F.)) requires shearing steam velocity ν=0.5 ft/s and the flow ratio R=1.5 lb shearing steam/lb condensate.

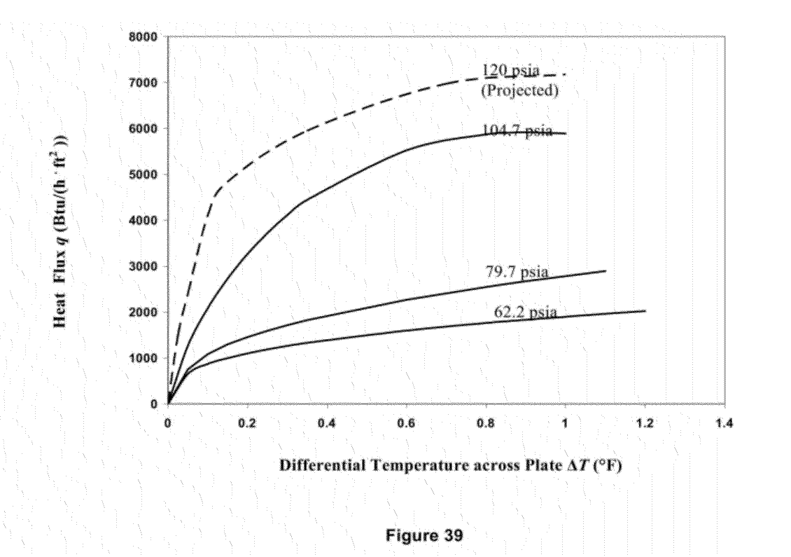

FIG. 39 shows the projected heat transfer coefficient for a working pressure P=120 psia.

5.2. Correlation of Heat Exchanger Performance with Pressure

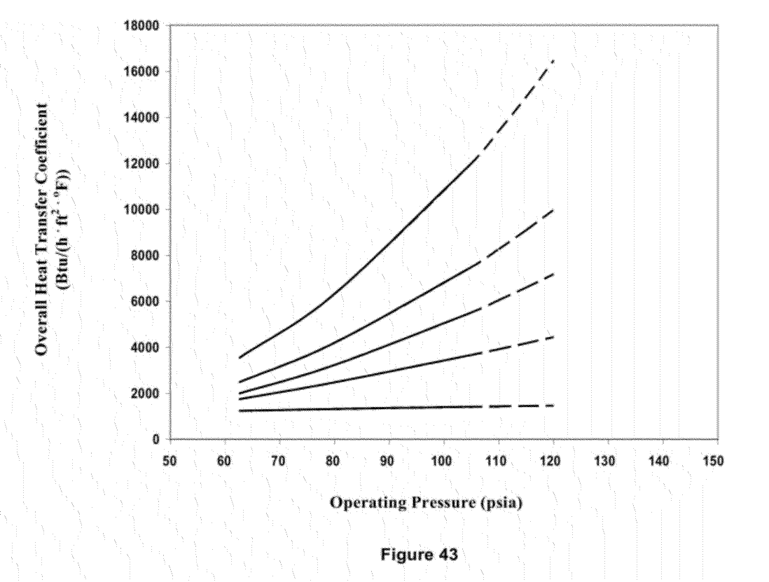

Previously, FIG. 37 showed heat transfer coefficient U as a function of ΔT for a constant P. FIG. 43 shows the same data where U is a function of P for a given ΔT. The following correlations were used to construct FIG. 43:

U=0.1985(P)^{2.366} (ΔT=0.35° F.) (5.7)

U=0.3564(P)^{2.139} (ΔT=0.70° F.) (5.8)

U=0.5636(P)^{1.974} (ΔT=1.0° F.) (5.9)

U=4.462(P)^{1.442} (ΔT=1.5° F.) (5.10)

U=411.2(P)^{0.266} (ΔT=2.0° F.) (5.11)

Section 6

Experimental investigation of 0.008-in-thick copper plates with round-shaped vertical grooves

Round-shaped vertical grooves on the condensing surface help channel the condensing steam so it sheds quickly, which increases the heat flux. The literature suggests that vertical grooves deliver about 25% higher overall heat transfer coefficients. For dropwise condensation, the condensation period involves forming microscopic droplets on the condensation surface, followed by droplet growth, coalescence/growth, and downflow. Liquid conduction resistance dominates dropwise condensation; therefore, reducing the condensation period is an important factor that increases the heat flux associated with dropwise condensation. Vertically grooved hydrophobic surfaces reduce the condensation period and hence enhances heat transfer. Additionally, this study measures the effects of shearing steam on hydrophobic vertically grooved surfaces on thin copper plates.

6.1. Experimental Results

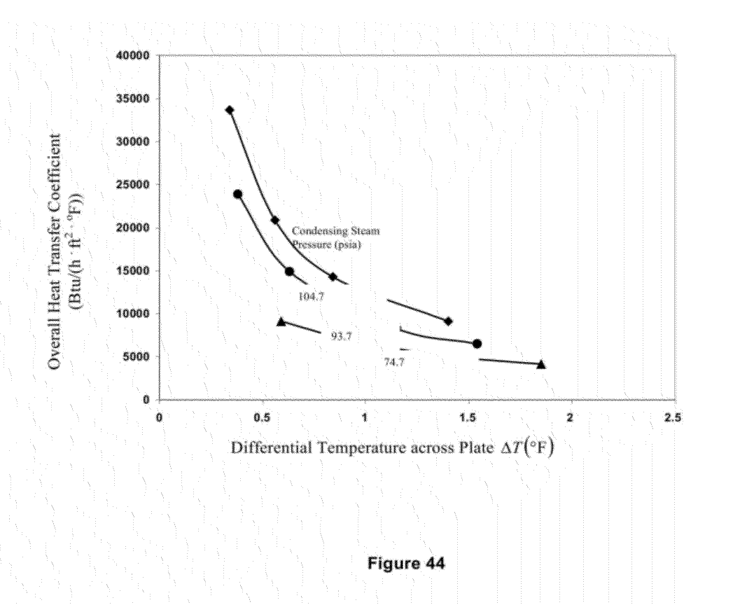

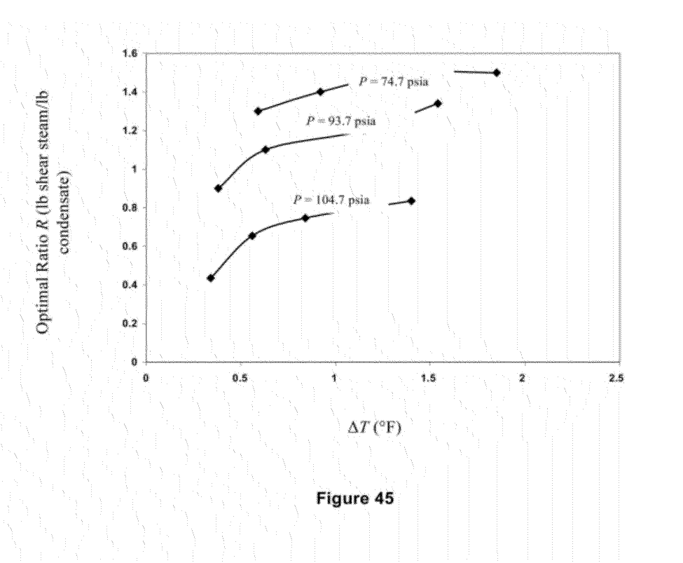

FIG. 44 shows the overall heat transfer coefficients corresponding to different temperature differences across the plate at different constant saturated steam pressures. Forced convection is imposed in the saturated liquid side with ν_{sat liq}=5.15 ft/s.

The following empirical equations describe each of the curves shown in FIG. 44:

U=12290(ΔT)^{-0.925} (P=104.7 psia) (6.1)

U=9596(ΔT)^{-0.941} (P=93.7 psia) (6.2)

U=6396(ΔT)^{-0.698} (P=74.7 psia) (6.3)

These equations may be used to calculate the heat flux:

q=UΔT=12290(ΔT)^{1-0.925}=12290(ΔT)^{0.097} (P=104.7 psia) (6.4)

q=UΔT=9596(ΔT)^{1-0.940}=9596(ΔT)^{0.059} (P=93.7 psia) (6.5)

q=UΔT=6396(ΔT)^{1-0.698}=6396(ΔT)^{0.302} (P=74.7 psia) (6.6)

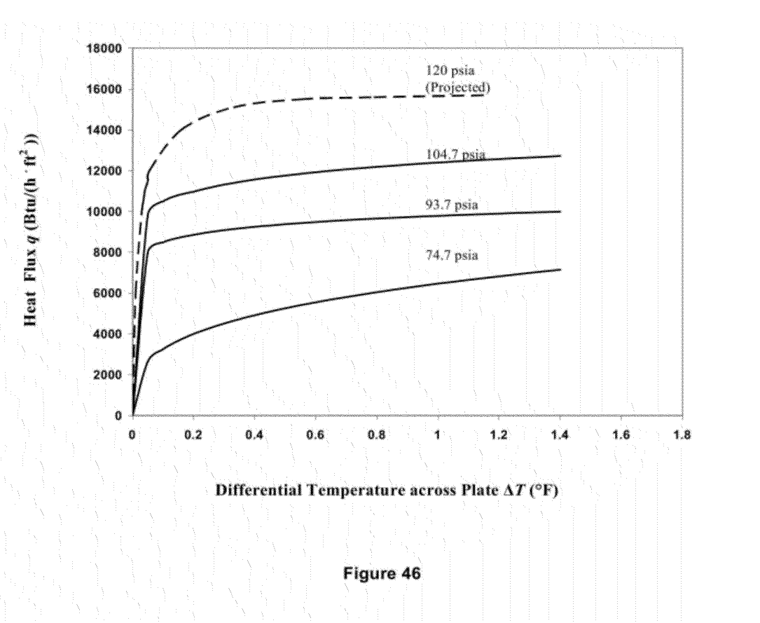

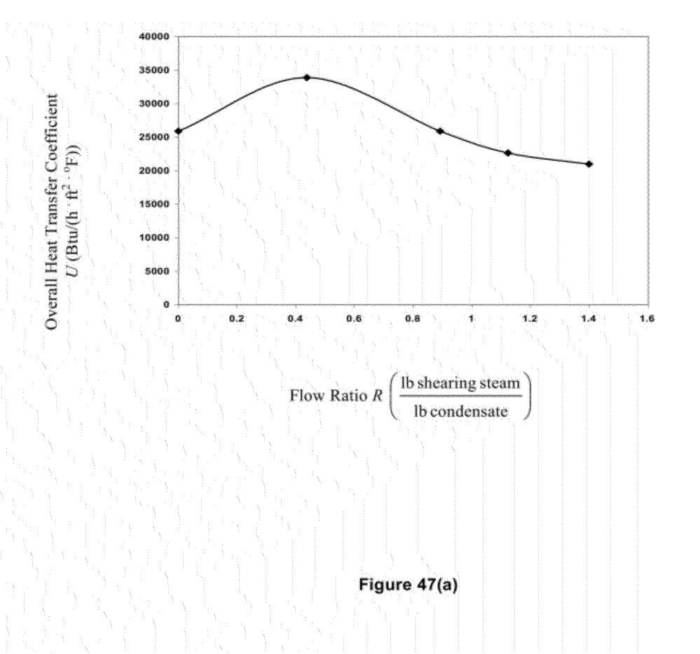

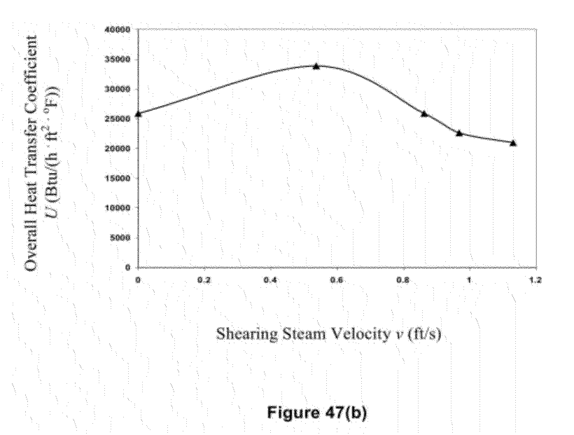

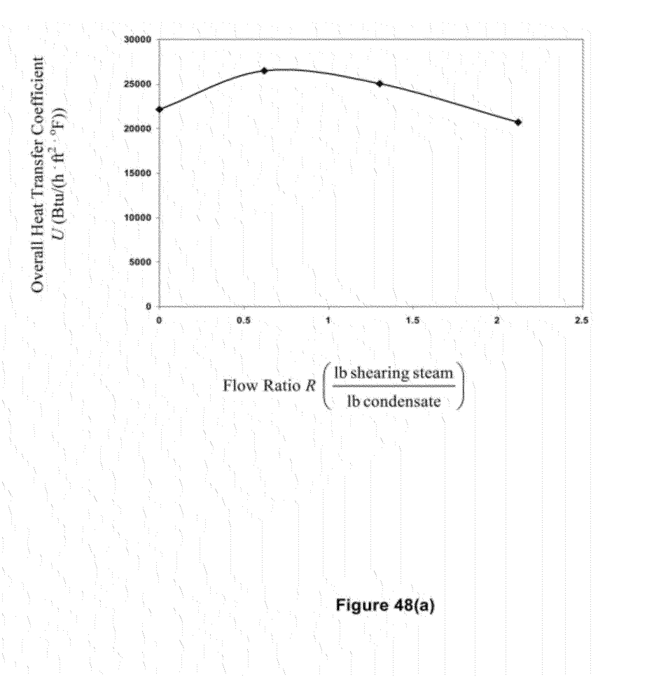

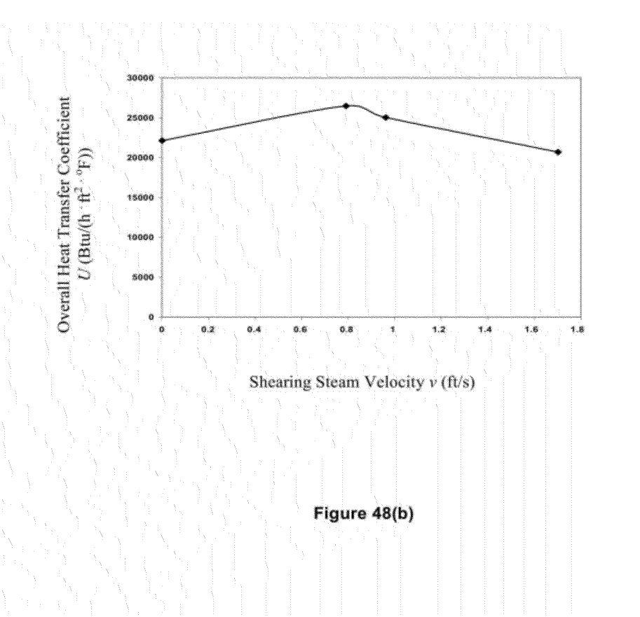

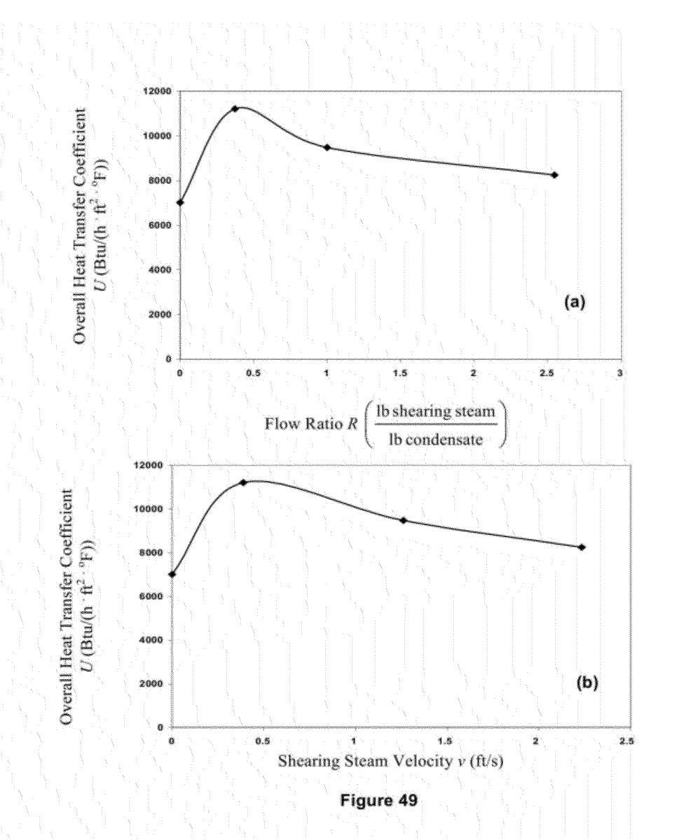

FIGS. 46 (104.7 psia), 47 (82.7 psia), and 48 (62.7 psia) show variations of the overall heat transfer coefficient with shearing steam for given ΔT. FIGS. 46a, 47a, and 48a present the heat transfer coefficient as a function of R, whereas FIGS. 46b, 47b, and 48b present the heat transfer coefficient as function of shearing velocities. In each figure, it is consistently apparent that there is an optimal flow ratio R and an optimal shearing steam velocity for each condition. At P=104.7 psia, the design point (U=33,700 Btu/(h⊙ft²⊙° F.)) requires shear velocity ν=0.53 ft/s and the flow ratio R=1.5 lb shearing steam/lb condensate.

6.2 Correlation of Heat Exchanger Performance with Pressure

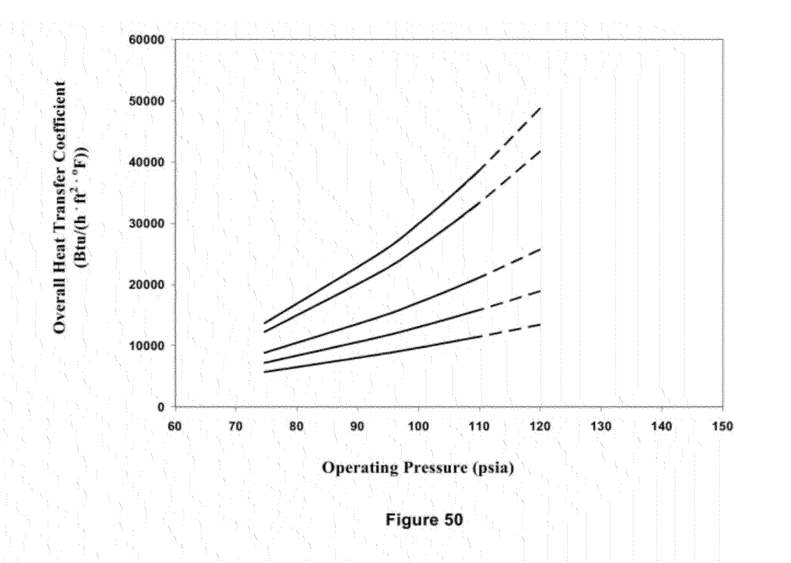

Previously, FIG. 44 showed heat transfer coefficient U as a function of ΔT for a constant P. FIG. 50 shows the same data where U is a function of P for a given ΔT. The following correlations were used to construct FIG. 50:

U=0.1275(P)^{2.682} (ΔT=0.35° F.) (6.7)

U=0.1766(P)^{2.584} (ΔT=0.40° F.) (6.8)

U=0.5349(P)^{2.251} (ΔT=0.63° F.) (6.9)

U=1.079(P)^{2.041} (ΔT=0.84° F.) (6.10)

U=2.371(P)^{1.805} (ΔT=1.16° F.) (6.11)

FIG. 50 shows the projected heat transfer coefficient for a working pressure P=120 psia.

Section 7. Effect of Coating Thickness

During this study, the thermal performance of 0.008-in-thick copper substrates was measured with hydrophobic Ni—P-PTFE coatings of the following thickness: (a) 0.00005-in, (b) 0.0005-in, and (c) 0.005-in. The results are compared to the performance of the 0.000025-in coating used in previous studies.

7.1. Experimental Results

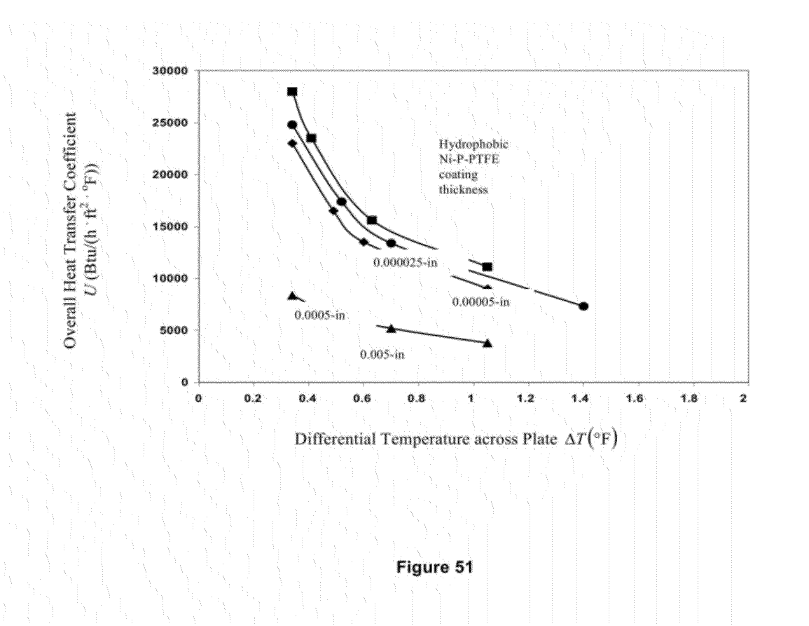

FIG. 51 shows the overall heat transfer coefficients measured at a constant saturated steam pressure P=104.7 psia corresponding to different temperature differences across the plate for 0.008-in-thick copper substrates with different hydrophobic Ni—P-PTFE coating thicknesses.

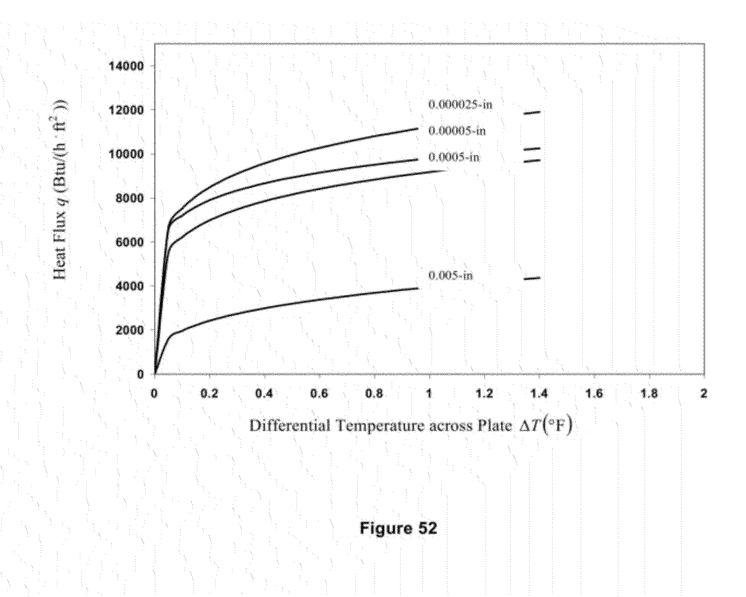

FIG. 52 shows measured heat fluxes across copper substrates 0.008-in thick coated with hydrophobic Ni—P-PTFE coating of different thicknesses.

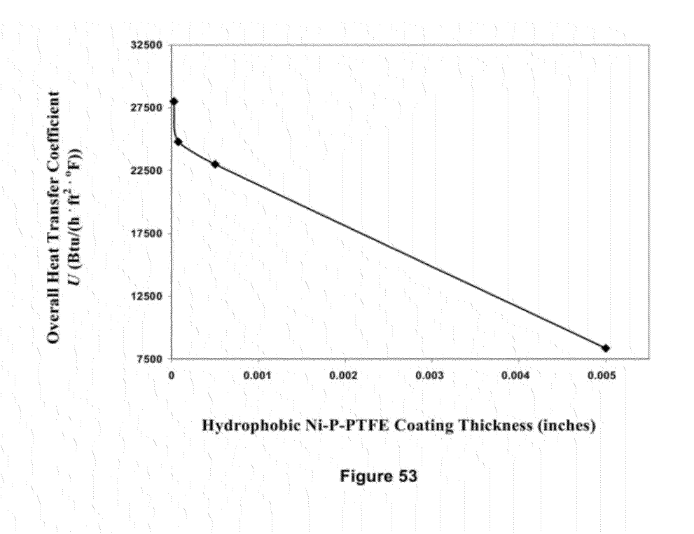

FIG. 53 shows the trends of Variation of heat transfer coefficients with respect to thicknesses of the hydrophobic Ni—P-PTFE coating.

Thermal Conductivity Calculation Based on Low Limiting Values

For high-phosphorous electroless Ni—P-PTFE hydrophobic coating, the literature reports a thermal conductivity k=0.013 cal/(cm⊙s⊙° C.) (3.14 Btu/(h⊙ft⊙° F.)). The lowest measured overall heat transfer coefficient (U=8,360 Btu/(h⊙ft2⊙° F.)) corresponds to 0.005-in coating thickness. Assuming the resistance of the boiling, liquid and condensing steam are negligible, analysis of low limiting values shows that

$$\frac{1}{U} = {( \frac{x}{k} )}_{cooper} + {( \frac{x}{k} )}_{coating}$$

$$\frac{1}{8360 \frac{Btu}{h \cdot ft \cdot ° F .}} = {( \frac{\frac{0.008 in}{12 in \text{/} ft}}{231 \frac{Btu}{h \cdot ft \cdot ° F .}} )}_{cooper} + {( \frac{\frac{0.005 in}{12 in \text{/} ft}}{k} )}_{coating}$$

$${k}_{coating} = 3.6 \frac{Btu}{h \cdot ft \cdot ° F .}$$

This agrees with the literature value within 15%.

Section 8. Experimental Investigation of Lead-Free Ni—P-PTFE Coating

Desalination technologies for municipal drinking water require NSF STD 61 certification. One of the most observed contaminants during the toxicology review is lead, which unfortunately is commonly used for the hydrophobic Ni—P-PTFE coating. To overcome this problem, a lead-free chemistry should be employed.

In the lead-free coating bath, it was observed that PTFE precipitated on the surface. The reason is yet unknown; however, this effect allowed more PTFE particles to deposit at the surface, which enhanced the hydrophobic effect of the coating. The following data show the overall heat transfer coefficient was increased.

8.1 Experimental Results of Round-Dimpled Plates

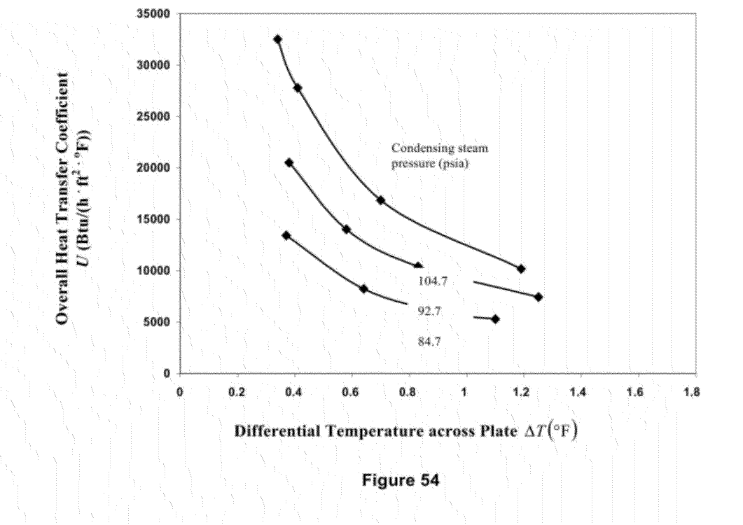

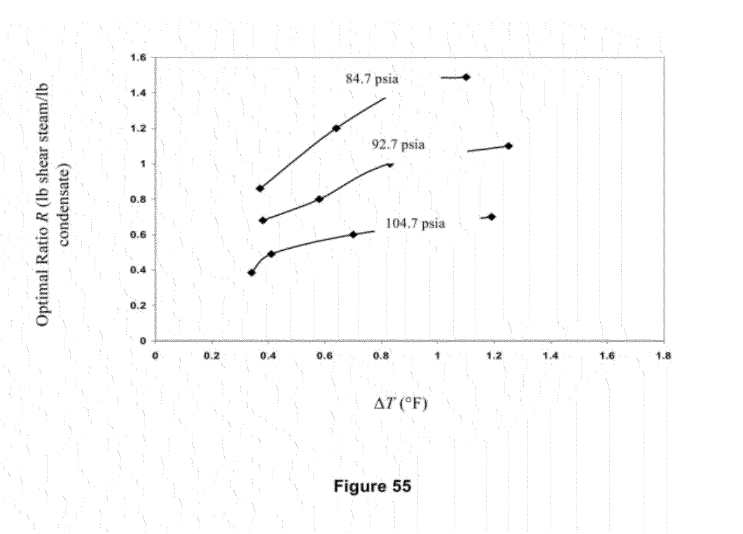

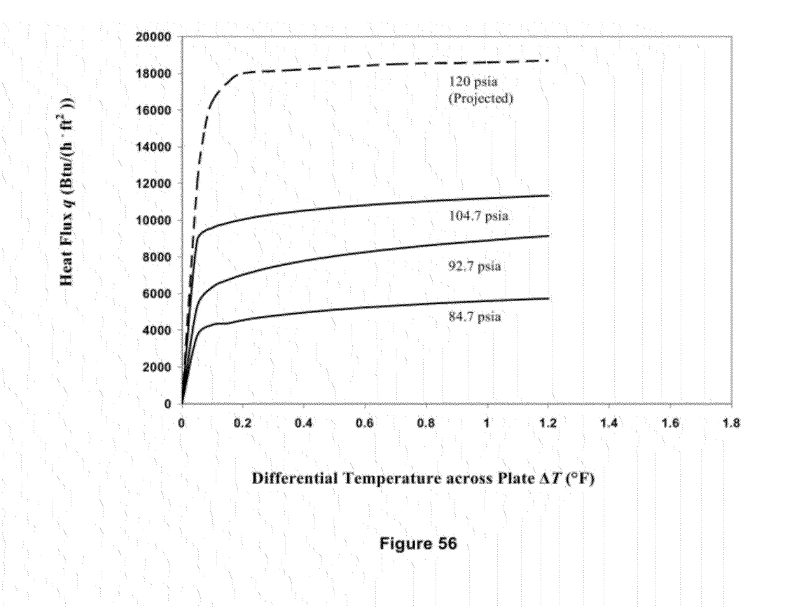

FIG. 54 shows the overall heat transfer coefficients corresponding to different temperature differences across the plate at different constant saturated steam pressures. Forced convection was imposed on the Saturated liquid side with ν_{sat liq}=5.15 ft/s.

The following empirical equations describe the curves shown in FIG. 54:

U=11990(ΔT)^{-0.932} (P=104.7 psia) (8.1)

U=8898(ΔT)^{-0.853} (P=92.7 psia) (8.2)

U=5599(ΔT)^{-0.870} (P=84.7 psia) (8.3)

These equations may be used to calculate the heat flux:

q=UΔT=1199(ΔT)^{1-0.932} (P=104.7 psia) (8.4)

q=UΔT=8898(ΔT)^{1-0.853} (P=92.7 psia) (8.5)

q=UΔT=5599(ΔT)^{1-0.870} (P=84.7 psia) (8.6)

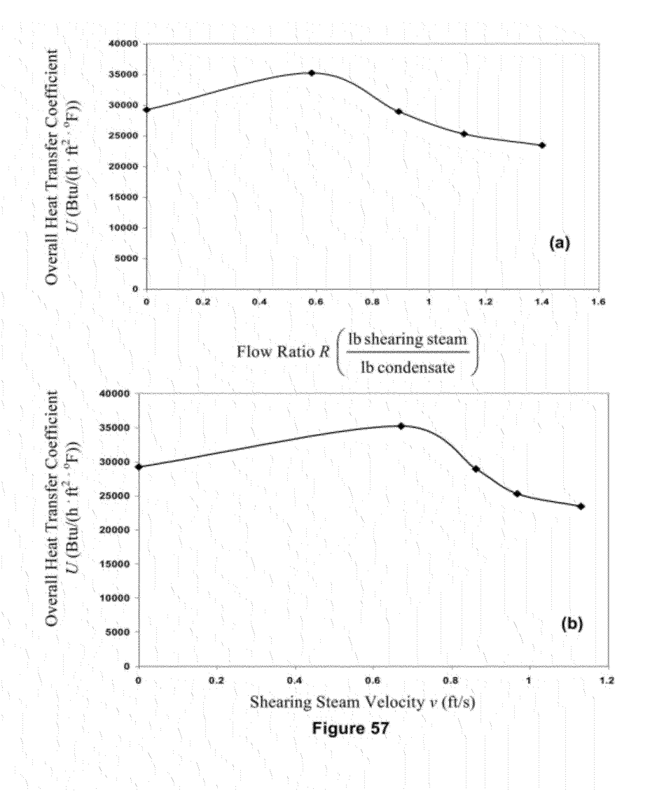

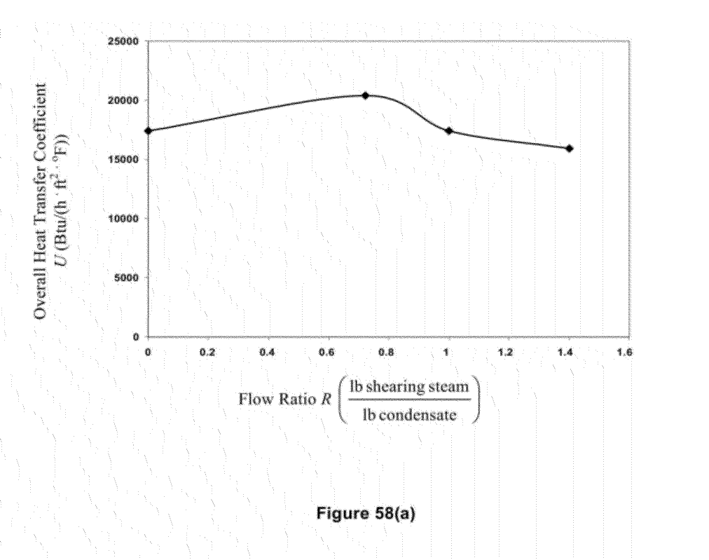

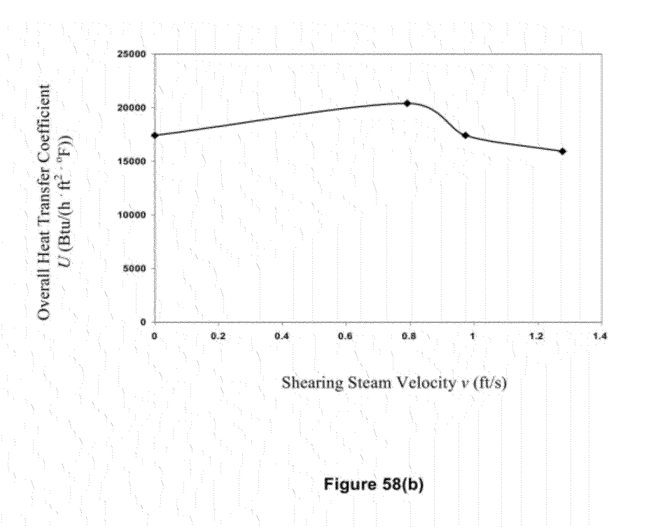

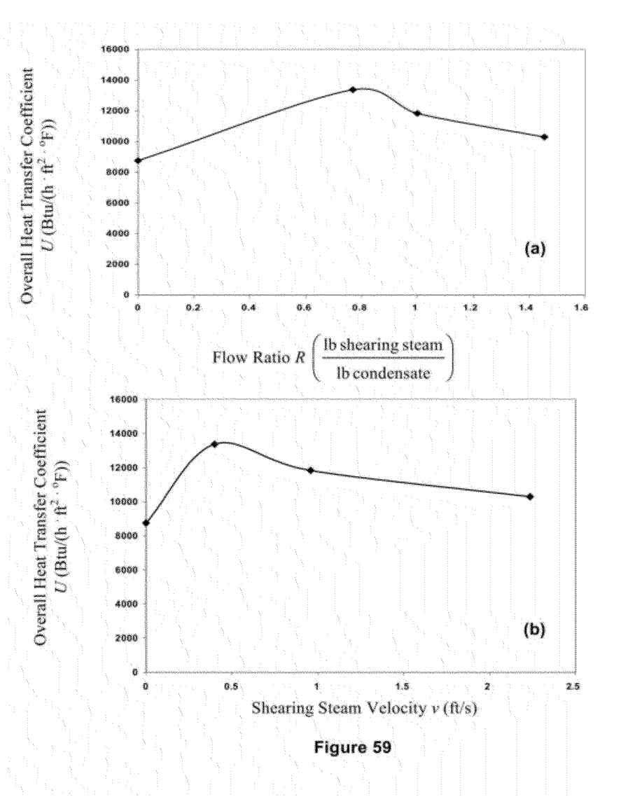

FIGS. 57 (104.7 psia), 58 (92.7 psia), and 59 (84.7 psia) show variations of the overall heat transfer coefficient with shearing steam for a given ΔT. FIGS. 57a, 58a, and 59a present the heat transfer coefficient as a function of R, whereas FIGS. 57b, 58b, and 59b present the heat transfer coefficient as function of shearing velocities. In each figure, it is consistently apparent that there is an optimal flow ratio R and an optimal shearing steam velocity for each condition. At P=104.7 psia, the design point (U=32,500 Btu/(h⊙ft²⊙° F.)) requires shear velocity ν=0.67 ft/s and the flow ratio R=0.5 lb shearing steam/lb condensate.

8.2 Correlation of Heat Exchanger Performance with Pressure

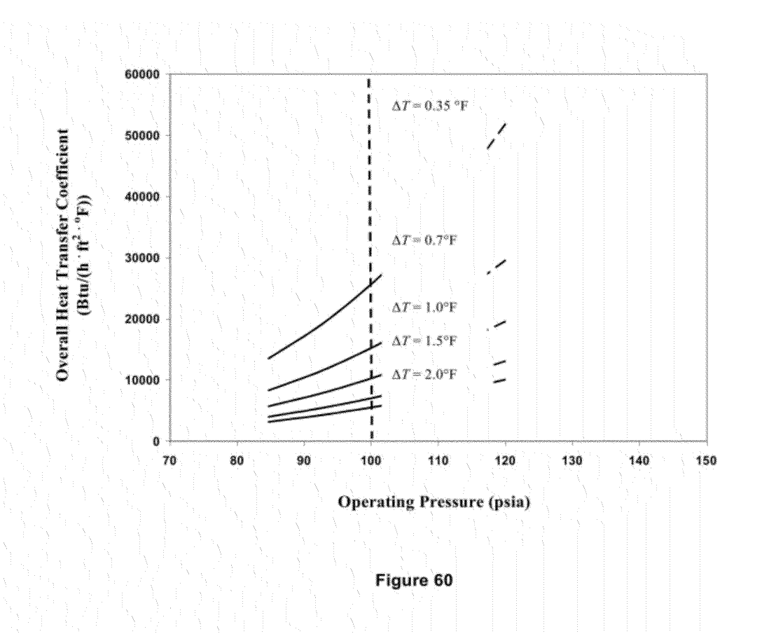

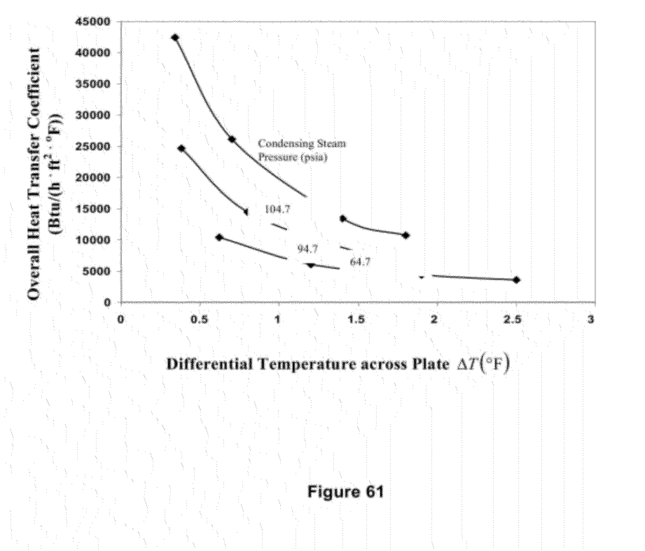

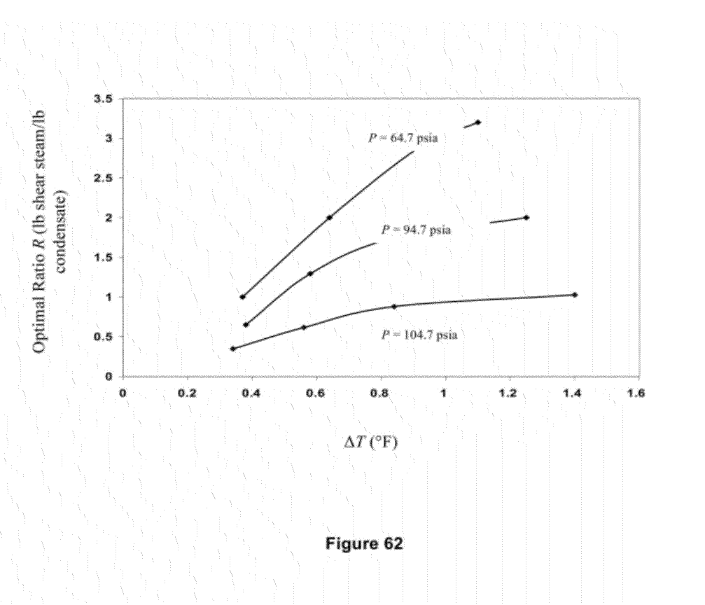

Previously, FIG. 54 showed heat transfer coefficient U as a function of ΔT for a constant P. FIG. 60 shows the same data where U is a function of P for a given ΔT. The following correlations were used to construct FIG. 60:

U=0.000534(P)^{3.855} (ΔT=0.35° F.) (8.7)

U=0.000768(P)^{3.640} (ΔT=0.70° F.) (8.8)

U=0.000923(P)^{3.529} (ΔT=1.00° F.) (8.9)

U=0.00117(P)^{3.403} (ΔT=1.50° F.) (8.10)

U=0.00133(P)^{3.314} (ΔT=2.00° F.) (8.11)

8.3 Copper Plates 0.008-in-Thick with Round-Shaped Vertical Grooves Coated with 0.0001-in Thick Lead-Free Hydrophobic Ni—P-PTFE Coating

Lead-free hydrophobic 0.0001-in-thick Ni—P-PTFE coating was applied on 0.008-in-thick copper plates with round-shaped vertical grooves. This new coating chemistry delivered 25% higher heat transfer coefficient. As was observed with other heat exchanger plates, there is a specific shearing steam velocity where the heat exchanger performance is maximal.

8.4. Experimental Results

FIG. 61 shows the overall heat transfer coefficients corresponding to different temperature differences across the plate at different constant saturated steam pressures. Forced convection is imposed in the saturated liquid side with ν_{sat liq}=5.15 ft/s.

The following empirical equations describe each of the curves shown in FIG. 61:

U=18000(ΔT)^{-0.836} (P=104.7 psia) (8.12)

U=11400(ΔT)^{-0.826} (P=94.7 psia) (8.13)

U=7140(ΔT)^{-0.764} (P=64.7 psia) (8.14)

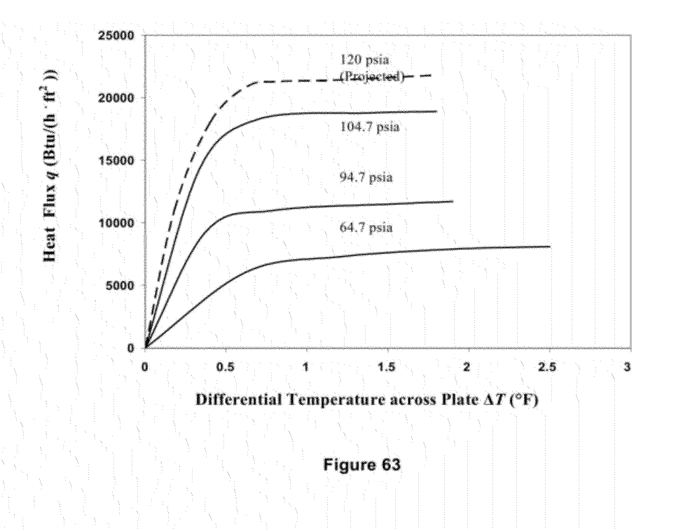

These equations may be used to calculate the heat flux (FIG. 63):

q=UΔT=18000(ΔT)^{1-0.836}=18000(ΔT)^{0.164} (P=104.7 psia) (8.15)

q=UΔT=11400(ΔT)^{1-0.826}=11400(ΔT)^{0.174} (P=93.7 psia) (8.16)

q=UΔT=7140(ΔT)^{1-0.764}=7140(ΔT)^{0.236} (P=64.7 psia) (8.17)

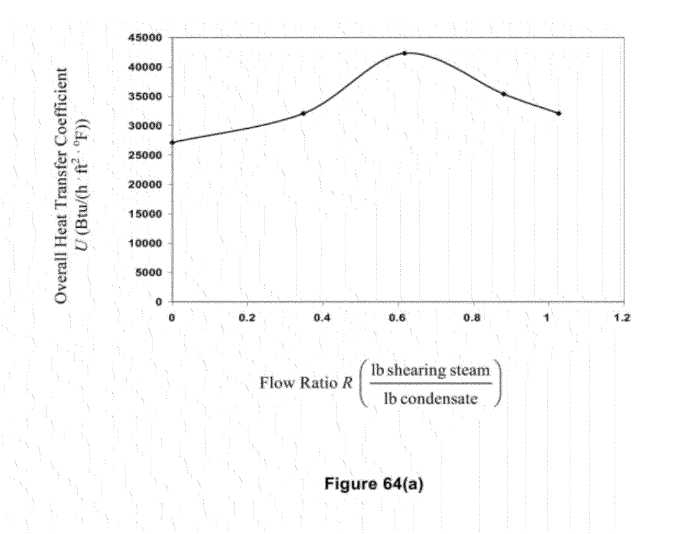

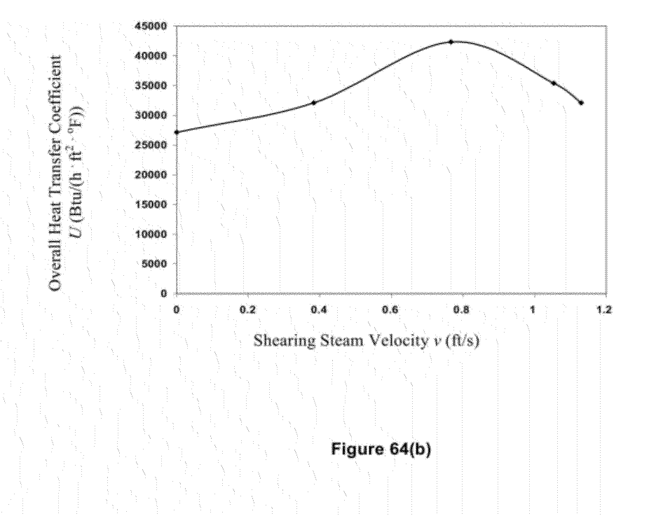

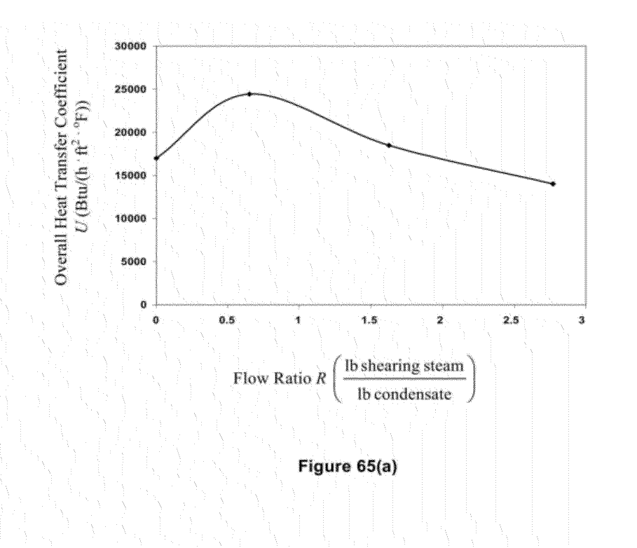

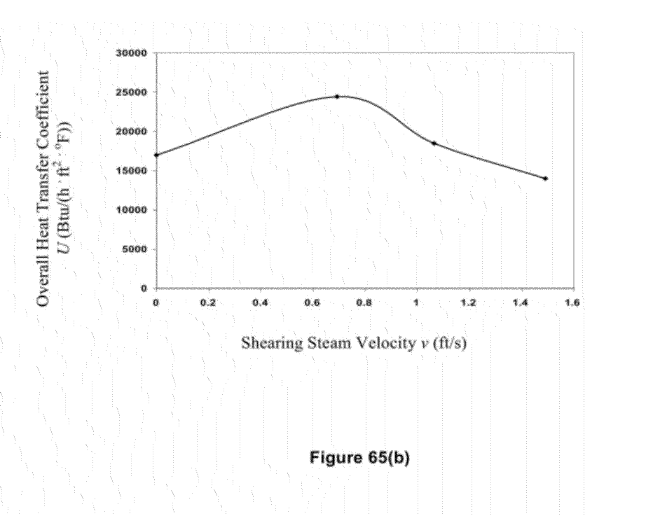

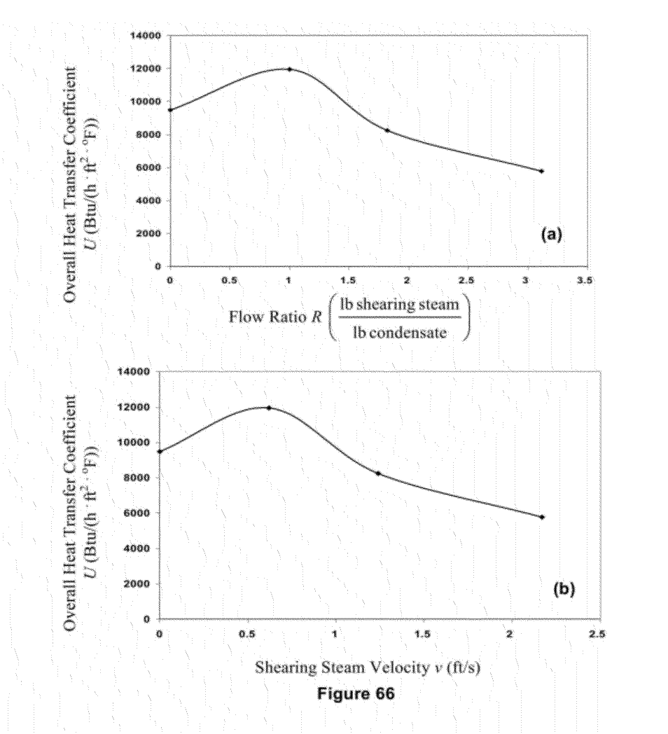

FIGS. 64 (104.7 psia), 65 (94.7 psia), and 66 (64.7 psia) show variations of the overall heat transfer coefficient with shearing steam for given ΔT. FIGS. 64a, 65a, and 66a present the heat transfer coefficient as a function of R, whereas FIGS. 64b, 65b, and 66b present the heat transfer coefficient as function of shearing velocities. In each figure, it is consistently apparent that there is an optimal flow ratio R and an optimal shearing steam velocity for each condition. At P=104.7 psia, the design point (U=42,400 Btu/(h⊙ft²⊙° F.)) requires shear velocity ν=0.76 ft/s and the flow ratio R=0.6 lb shearing steam/lb condensate.

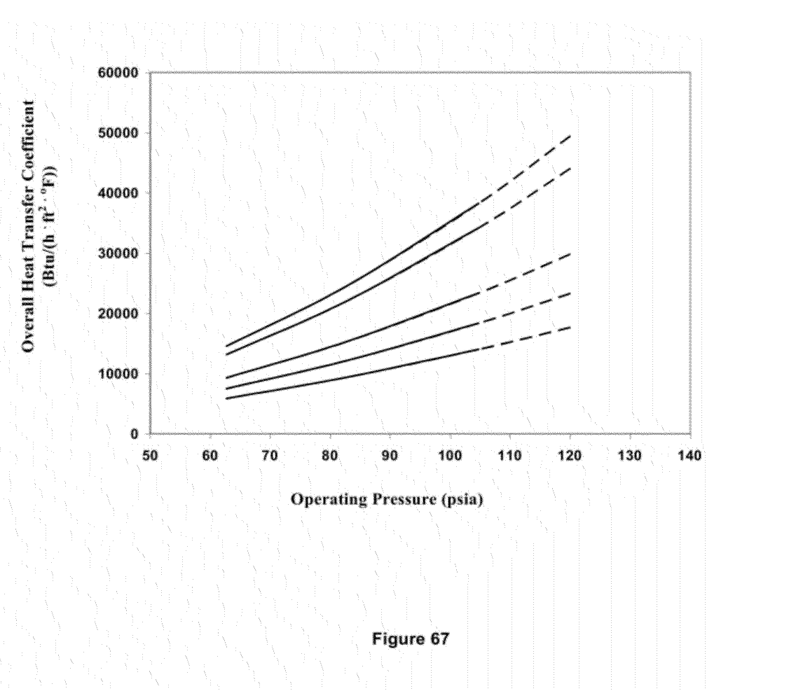

FIG. 67 shows the projected heat transfer coefficient for working pressure P=120 psia.

8.5 Correlation of Heat Exchanger Performance with Pressure

Previously, FIG. 61 showed heat transfer coefficient U as a function of ΔT for a constant P. FIG. 67 shows the same data where U is a function of P for a given ΔT. The following correlations were used to construct FIG. 67:

U=5.941(P)^{1.886} (ΔT=0.35° F.) (8.18)

U=5.842(P)^{1.865} (ΔT=0.40° F.) (8.19)

U=5.518(P)^{1.796} (ΔT=0.63° F.) (8.20)

U=5.322(P)^{1.751} (ΔT=0.84° F.) (8.21)

U=5.101(P)^{1.702} (ΔT=1.16° F.) (8.22)

Section 9. Conclusions

An experimental investigation of hydrophobic heat exchangers was performed on the test apparatus described in FIG. 12. Naval brass, copper, and titanium plates were tested. The plates have the following advanced features:
Sand-blasting on naval brass plate to promote nucleate boiling
Ni—P-PTFE hydrophobic coating on naval brass and copper plates to promote dropwise condensation
Titanium grade 2 surface which resists corrosion and exhibits hydrophobic behavior
Forced convection in the boiler
PTFE boiling stones to enhance boiling heat transfer coefficient in the boiler
Dimples or vertical round-shape grooves as spacers
Forced-convection shearing steam in the condenser

Table 4 summarizes the results obtained in this disclosure

TABLE 4
Summary of results obtained in this disclosure

| | | | | | | | | | Min. | | Overall |
|---|---|---|---|---|---|---|---|---|---|---|---|
| | | | | | Shear- | Liquid | | | ΔT | Max. | Heat |
| | | Coating | | | ing | con- | Liquid- | | across | steam | Transfer |
| | | thickness | Coating | Surface | steam | vection | side | Boiling | plates | pressure | Coefficient |
| Fig. | Substrate | (inches) | chemistry* | geometry | (ft/s) | (ft/s) | nucleation | stones | (° F.) | (psia) | (Btu/(h⊙ft²⊙° F.) |
| 13 | Naval brass 464 | No | Ni—P-PTFE | Round | 0.25 | No | Sand | No | 0.5 | 104.7 | 2,900 |
| | 0.030-in-thick | | | dimples | | | blasted | | | | |
| 17 | Naval brass 464 | 0.000025 | Ni—P-PTFE | Round | 0.25 | No | Sand | No | 0.35 | 104.7 | 12,500 |
| | 0.030-in-thick | | | dimples | | | blasted | | | | |
| 19 | Naval brass 464 | 0.000025 | Ni—P-PTFE | Round | 0.25 | 10.3 | Sand | No | 0.35 | 104.7 | 17,500 |
| 21* | 0.030-in-thick | | | dimples | | | blasted | | | 120.0** | 21,100* |
| 23 | Copper | 0.000025 | Ni—P-PTFE | Round | 1.4 | 5.15 | No | No | 0.35 | 104.7 | 28,000 |
| 29* | 0.008-in-thick | | | dimples | | | | | | 120.0** | 35,500* |
| 30 | Copper | 0.000025 | Ni—P-PTFE | Round | 1.6 | 5.15 | No | Yes | 0.35 | 104.7 | 32,000 |
| 32* | 0.008-in-thick | | | dimples | | | | | | 120.0** | 43,750* |
| 37 | Titanium | No | Ni—P-PTFE | Round | 0.5 | 5.15 | No | No | 0.35 | 104.7 | 13,700 |
| | 0.005-in-thick | | | dimples | | | | | | 120.0*** | |
| 44 | Copper | 0.000025 | Ni—P-PTFE | Vertical | 0.53 | 5.15 | No | No | 0.35 | 104.7 | 33,700 |
| 46* | 0.008-in-thick | | | grooves | | | | | | 120.0* | 48,000* |
| 51 | Copper | 0.000075 | Ni—P-PTFE | Vertical | NR | 5.15 | No | No | 0.35 | 104.7 | 24,800 |
| | 0.008-in-thick | 0.0005 | | grooves | NR | | | | | | 23,000 |
| | | 0.005 | | | NR | | | | | | 8,360 |
| 54 | Copper | 0.0001 | Ni—P-PTFE | Round | | 5.15 | No | No | 0.35 | 104.7 | 32,500 |
| 56* | 0.008-in-thick | | Lead-free | dimples | | | | | | 120.0** | 50,000 |
| 61 | Copper | 0.0001 | Ni—P-PTFE | Vertical | 0.76 | 5.15 | No | No | 0.35 | 104.7 | 42,400 |
| 63* | 0.008-in-thick | | Lead-free | grooves | | | | | | 120.0** | 49,500 |

*Microplating Inc.
**Extrapolated;
***This calculated value is limited by substrate (titanium) thermal resistance;
NR = Not reported.

Compared to naval Brass, copper has superior thermal conductivity, which is essential in this application because the steam-side and liquid-side heat transfer coefficients are so high. Unfortunately, copper does not resist the corrosion effect of salt water compared to naval brass 464. Although Ni—P-PTFE coating will resist wear, corrosion, and fouling, galvanic protection may be needed as well.

Table 5 summarizes literature results. The best heat transfer coefficient shown in the literature was U=3,000 Btu/(h⊙ft²⊙° F.) for ΔT=3.7 to 12.7° F. and P=43.7 psia. In contrast, in the present study, the best heat transfer coefficient was 42,400 Btu/(h⊙ft²⊙° F.) for ΔT=0.35° F. and P=104.7 psia.

Using thin copper with round-shape vertical grooves has multiple benefits: (1) reduce material cost, (2) pack more heat exchanger area into a given heat exchanger volume, (3) easier formation of dimples, and (4) enhance the overall heat transfer coefficient.

Bare grade-2 titanium plates promote dropwise condensation and resists corrosion abrasion and fouling.

Using titanium allows MVC to treat water that has aggressive contaminants such as (1) produced water from oil wells and (2) evacuated brine from natural reservoirs that will be injected with compressed carbon dioxide for carbon sequestration.

High operating pressures have high heat transfer coefficients and they allow mechanical vapor-compression desalination systems to use smaller compressors.

TABLE 5
Summary of literature results

| | | | | | | | | | Heat | |
|---|---|---|---|---|---|---|---|---|---|---|
| | | Coating | | | | | | | transfer | |
| | Substrate | & | | | Liquid- | | | | coefficient | Dropwise |
| Literature | Metal & | Coating | Surface | Shearing | side | Nucleation | ΔT | Pₛₐₜ | Btu/(h | condensation |
| Reference | Thickness | thickness | geometry | steam | agitation | sites | (° F.) | (psia) | ft² ° F.) | (DWC) |
| 1 | Cu | Ni—Cu-P- | 0.6 × 0.4 in | No | No | No | NR | Pool | NR | NR |
| | SS 304 | PTFE | vertical | | | | | boiling | | |
| | 0.014 in | 0.0009 in | coupon | | | | | 29.4 | | |
| 2 | Cu; SS 304 | Ni—Cu-P- | 0.6 × 0.4 in | No | No | No | NR | Pool | 1230 | No |
| | LC steel | PTFE | vertical | | | | | boiling | | |
| | 0.014 in | 0.00001- | coupon | | | | | 29.4 | | |
| | | 0.0001 in | | | | | | | | |
| 3 | Cu | Ni—P- | 0.6 × 0.4 in | No | No | No | NR | Pool | NR | No |
| | SS 304 | PTFE | vertical | | | | | boiling | | |
| | 0.014 in | Various | coupon | | | | | 29.4 | | |
| 4 | SS 316 | Ni—P- | corrugated | No | Yes | No | 3.7-12.7 | 43.5 | 3000 | Yes |
| | NR | PTFE | plate-and- | | (Oil) | | | | | |
| | | NR | frame HX | | | | | | | |
| 5 | SS 304 | Ni—Cu-P- | 0.6 × 0.4 in | No | No | No | NR | 29.4 | NR | No |
| | 0.04 in | PTFE | vertical | | | | | | | |
| | | 0.0009 in | coupon | | | | | | | |
| 6 | Cu | Ni—P- | 0.6 × 0.4 in | No | No | No | NR | 29.2 | 890 on | NR |
| | SS 304 | PTFE | vertical | | | | | | coated SS | |
| | 0.014 in | NR | coupon | | | | | | 304 | |
| | | | | | | | | | heater | |
| 7 | SS 304 | Ni—P- | rotating | No | No | No | NR | 29.2 | Not | NR |
| | NR | PTFE | cylinder | | | | | | reported | |
| | | NR | | | | | | | | |
| 8 | SS 316 | Ni—P- | conventional | No | No | No | NR | 29.2 | Ni—P-PTFE | NR |
| | NR | PTFE | heat | | | | | | improved | |
| | | 0.00005- | exchangers | | | | | | processing | |
| | | 0.0009 in | | | | | | | skim milk | |
| | | | | | | | | | and tomato | |
| | | | | | | | | | juice | |
| 9 | Cu | Ni—Cu—P- | 0.6 × 0.4 in | No | No | No | NR | 29.2 | NR | NR |
| | 0.014 in | PTFE | vertical | | | | | | | |
| | | 0.0009 in | coupon | | | | | | | |

Section 10. Other Applications

Ni—P-PTFE Lead-Free Coating Technology

Recent developments in coating technology show electroless Ni—P-PTFE coating may be applied with lead-free chemistry, which complies with the requirements of NSF Standard 61 for drinking water.

Ni—Cu—P-PTFE Coatings

Experimental results show the corrosion resistance of Ni—Cu—P-PTFE composite coatings is superior to that of Ni—P-PTFE composite coating. Pool boiling tests at atmospheric pressure show 22-μm layer of Ni—Cu—P-PTFE coating has very low surface energy (18 mN/m), thus enhancing the hydrophobic properties of the thin Ni—P-PTFE layer. Additionally, incorporating Cu into the composite coating increases its thermal conductivity.

Carbon Nanotubes (CNT)

Literature reports continuous dropwise condensation of water vapor was observed on a superhydrophobic surfaces with short carbon nanotubes (CNT) deposited on micromachined posts, a two-tier texture mimicking lotus leaves.

On a roughened hydrophobic surface, a liquid drop may exhibit either the Cassie state where the drop sits on the air-filled textures or the Wenzel state where the drop wets cavities of the textures. To date, none of the reported condensation on engineered superhydrophobic surfaces exhibits a sustained Cassie state; instead, the condensate drops partially or fully penetrates into the cavities over the course of condensation.

The apparent contact angle of a roughened hydrophobic surface is enhanced in both the Cassie and Wenzel states; however, the Cassie state is the preferred superhydrophobic state in which a drop has a much smaller contact angle hysteresis and therefore a higher mobility. Continuous dropwise condensation of steam was achieved on a two-tier texture surface, which retains superhydrophobicity during and after condensation. On such micro-nano-structured surfaces, the condensate drops prefer the Cassie state, which is thermodynamically more stable than the Wenzel state. With a hexadecanethiol coating, superhydrophobicity is retained during and after condensation and rapid drop enabled.

On a silicon (Si) substrate, squarely positioned pillars were etched at the center by deep reactive ion etching. The etched Si substrates were coated with a thin layer of chromium Cr (100 nm) and then nickel Ni (20 nm) as catalyst. The CNTs were grown by plasma-enhanced chemical vapor deposition. The substrate was then hydrophobicized either by a 10-nm layer of parylene C coating or by a 10-nm layer of gold coated with a monolayer of 1-hexadecanethiol.

No reports were given on heat transfer coefficients attained. Monolayer coatings should exercise minimum thermal resistance. For the present application, the goal is to apply the described technology to copper substrates.

Ni—P-PTFE-CNT Super-Hydrophobic Composite Coating

Electroless Ni—P—carbon nanotube composite coatings were fabricated successfully and characterized for corrosion applications. Literature shows studies measuring the highest critical pressure that nanocavities of the CNT arrays may sustain before the condensing steam penetrates them. Because the critical pressure is a function of the saturated steam temperature, and our latent heat exchanger requires high pressures, it is our initiative to incorporate PTFE particles in the composite coating. We have confirmed with our coating supplier the chemical compatibility of the composites.

### Example 4

### Coatings Comprising Electroless Nickel

In addition to Ni—P-PTFE coatings, with PTFE (polytetrafluoroethylene, or Teflon) as the hydrophobic additive, other coatings comprising electroless nickel (Ni) may also be used as the hydrophobic coating in the heat exchanger (heat exchange system) of this disclosure. Some examples of coatings comprising electroless nickel are Ni—B-PTFE, Ni—P—BN, and Ni—B—BN.

These alternative coatings comprise, in addition to electroless nickel (Ni), phosphorous (P) or boron (B), depending on the reducing agent. As the matrix of the coating deposits on the surface, it entrains finely divided solids that are added to the bath. PTFE acts as the hydrophobic additive; boron nitride (BN) may also function as the hydrophobic additive. Furthermore, silica (Si) as a finely divided solid may also be added, which imparts abrasion resistance to the coating. The electroless bath may contain other components, such as buffers, wetting agents, and chelating agents.

Electroless nickel-based plating is an autocatalytic process where the substrate (copper or low-carbon steel) develops a potential when it is dipped in a bath (Table 6). Because of the developed potential, both positive and negative ions are attracted towards the substrate surface and release their energy through a charge transfer process. Nickel and other components (phosphorous, boron) deposit on the surface. To the bath, fine suspensions of solid additives—such as polytetrafluoroethylene (PTFE, or Teflon), boron nitride, silica—can be added, which become part of the matrix that deposits on the solid surface.

Tribology properties desired. Desalination/dewatering applications require corrosion resistance, abrasion resistance, and hydrophobicity to handle corrosive salty fluids at high temperature moving with relatively high velocities. The quaternary alloy Ni—P—BN—Si has the following properties:

Nickel—High lubricity, corrosion resistance

Phosphorous—Enhances corrosion resistance

Boron Nitride—A synthetic ceramic that is both oleophobic and hydrophobic

Silica—Reduces friction, enhances hardness and wear resistance

The later two components are added as fine suspensions that are entrained in the nickel coating as it deposits on the surface.

TABLE 6
Components of the electroless bath

| Component | Function |
|---|---|
| Nickel ion | Source of metal |
| Reducing agent | Source of electrons |
| Complexants | Stabilizes the solution |
| Accelerators | Activates reducing agents |
| Buffers | Controlling pH (long term) |
| pH regulators | Regulates pH of solution (short term) |
| Stabilizer | Prevents solution breakdown |
| Wetting agents | Increases wettability of the surfaces |

Reducing agents. Depending on the reducing agent used, the baths used for depositing Ni—B alloy can be acidic or alkaline. Table 7 describes the bath composition.

TABLE 7
Reducing agents for electroless nickel plating

| Deposit | Reducing agent | Remarks |
|---|---|---|
| Ni—P | Sodium hypophosphite | Acid or alkaline bath |
| | (NaH₂PO₂) | (2-17% P) |
| Ni—B | Sodium borohydride | Acid or alkaline bath |
| | (NaBH₄) | |
| | Dimethylamine borane | Alkaline bath (0.5-10% B) |
| | (DMAB) | |

Sodium hypophosphite. Commercially, hypophosphite baths are the most common baths used because of higher deposition rates.

(a) Electrochemical mechanism. The catalytic oxidation of hypophosphite yields electrons at the catalytic surface, which in turn reduce nickel and hydrogen ions:

H₂PO₂⁻+H₂O→H₂PO₃⁻+2H⁺+2e⁻

Ni²⁺+2e⁻→Ni

2H⁺+2e⁻→H₂(g)

H₂PO₂⁻+2H⁺+e⁻→P+2H₂O

(b) Atomic hydrogen mechanism. Atomic hydrogen is released because of the catalytic dehydrogenation of hypophosphite molecules adsorbed at the surface. The adsorbed active hydrogen reduces nickel at the surface of the catalyst.

H₂PO₂⁻+H₂O→HPO₃²⁻+H⁺+2H_{ads}

2H_{ads}+Ni²⁺→Ni+2H⁺

At the catalyst surface, some of the absorbed hydrogen simultaneously reduces a small amount of hypophosphite to water, hydroxyl ion, and phosphorus.

H₂PO₂⁻+H_{ads}→H₂O+OH⁻+P

Some of the reducing potential is lost as hydrogen gas:

H₂PO₂⁻+H₂O→H⁺+HPO₃²⁻+H₂(g)

Sodium borohydride. Sodium borohydride is the most powerful reducing ion agent available. It can provide four electrons rather than the two electrons provided by sodium hypophosphite. Borohydride-reduced baths are preferred to dimethylamine borane baths.

Borohydrate ions hydrolyze in acid or neutral solutions and will yield boride in the presence of nickel ions; hence, pH control is important to avoid decomposing the bath solution.

The formation of nickel boride is suppressed by maintaining the pH of the solution between 12 and 14. Nickel is the reaction product.

Furthermore, electroless nickel coatings reduced with sodium borohydride have better tribological properties (hardness, wear resistance) than those of deposits reduced with other boron compounds or with sodium hypophosphite.

The following is the main reaction that drives the nickel ion reduction. It releases four electrons.

BH₄⁻+4OH⁻→BO₂⁻+2H₂O+2H(g)+4e⁻

The presence of boron in the coating is from the following reaction:

BH₄⁻→B+2H₂(g)+e⁻

The reduction reactions are

Ni²⁺+2e⁻→Ni

2H₂O+2e⁻→2OH⁻+H₂(g)

Chelating/Complexing agent. The functions of the chelating/complexing agents are:

a) Exert buffering action that prevents the pH of the solution from falling too fast

b) Prevent the precipitation of nickel salts, such as basic salts or phosphites

c) Reduce the concentration of free nickel ions by forming meta-stable complexes

d) Influence the reaction mechanism and hence the deposit rate

When borohydride is used as reducing agent, ethylenediamine is the complexing agent with an optimum concentration of 90 g/L.

Buffer agent. Ammonium fluoride improves the deposition rate and the buffering capability of Ni—P bath.

Wetting agents (surfactants). The function of the surfactant is to lower the surface tension of the bath allowing easier spreading and promoting the coating deposition reaction between the bath solution and the substrate (e.g., carbon steel).

Cetyltrimethylammonium bromide (CTAB) improves the surface finish and the hardness. It increases the phosphorus content (hence corrosion resistance) of the Ni—P coating with concentration exceeding about 0.6 g/L.

Effects of annealing on the coating. Heat exposure affects the thickness, hardness, and morphology of the coating. Heat exposure at 400° C. for 1 h promotes nickel grain growth, which results in maximal hardness of electroless nickel coating. However, heat exposure at higher temperatures and longer times leads to progressive decrease of hardness. Boron nitride helps solve the problem. Ni—B coatings exposed to 350-400° C. for 1 h transforms the ammorphous phase to crystalline nickel and nickel boride (Ni₃B and Ni₂B) phases. Annealing at temperatures higher than 450° C. causes crystalline nickel to grow and converts from Ni₂B phase to the more metastable Ni₃B phase. Atmosphere-controlled thermal treatments produce better corrosion resistance in electroless Ni—B coatings because of nitrogen diffusion. Nitridation by heat treating the coating in a nitrogen atmosphere in vacuum, increases the microhardness of Ni—P coatings up to 1500 HV 100.

### REFERENCES

[1] A. E. Bergles, ExHFT for fourth generation heat transfer technology, Experimental Thermal and Fluid Science, 26 (2002) 335-344.
[2] X. Ma, J. Chen, D. Xu, J. Lin, C. Ren, Z. Long, Influence of processing conditions of polymer film on dropwise condensation heat transfer, International Journal of Heat and Mass Transfer 45 (2002) 3405-3411
[3] J. R. Lara, G. Noyes, M. T. Holtzapple, An investigation of high operating temperatures in mechanical vapor-Compression desalination, Desalination, 227 (2008) 217-232.
[4] A. K. Das, P. K. Das; P. Saha, Heat transfer during pool boiling based on evaporation from micro and macro layer, Int. J. Heat Mass Transfer, 49 (2006) 3487-3499.
[5] B. Boesmans, J. Berghmans, Level swell in pool boiling with liquid circulation, Int. J. Heat Mass Transfer 38 (1995) 989-998.
[6] T. Kumada, H. Sakashita, H. Yagamishi, Pool boiling heat transfer-I. Measurement and semi-empirical relations of detachment frequencies of coalescent bubbles, Int. J. Heat Mass Transfer, 38 (1995) 969-977.
[7] T. Kumada, H. Sakashita, Pool boiling heat transfer-II. Thickness of liquid microlayer formed beneath vapor masses, Int. J. Heat Mass Transfer, 38 (1995) 979-987.
[8] Y.-X. Wang, J. L. Plawsky, P. C. Wayner, Jr., Optical measurement of micro scale transport processes in dropwise condensation, Microscale Thermo physical Engineering, 5 (2001) 55-69.
[9] C. Yamali, H. Merte, Jr., Influence of sleeping on dropwise condensation with varying body force and surface sub cooling, Int. J. Heat Mass Transfer, 42 (1999) 2943-2953.
[10] A. S. Lexmond, C. W. M. van der Geld, The effect of fluid flow on the detachment of drops in the wake of a flat plate, Experimental Thermal and Fluid Science, 29 (2005) 363-370.
[11] A. S. Lexmond, C. W. M. van der Geld, The effect of plate thickness, surface tension and fluid flow on detachment of drops from plate, Experimental Thermal and Fluid Science, 29 (2005) 813-819.
[12] M. Izumi, S. Kumagai, R. Shimada, N. Yamakawa, Heat transfer enhancement of dropwise condensation on a vertical surface with round shaped grooves, Experimental Thermal and Fluid Science, 28 (2004) 243-248.
[13] M. Monde, Critical heat flux in saturated forced convective boiling on a heated disk with an impinging jet. Warme-and Stoffubertragung 19, (1985) 205-209.
[14] H. Honda, J. J. Wei, Enhanced boiling heat transfer from electronic components by use of surface microstructures. Experimental Thermal and Fluid Science 28 (2004) 159-169.
[15] Microplating Inc. http://www.microplating.com/HTML/nickel-teflon.html.
[16] Q. Zhao, Y. Liu, H. Müller-Steinhagen, G. Liu, Graded Ni—P-PTFE coatings and their potential applications, Surface and Coatings Technology, 155 (2002) 279-284. Tech Metals, Inc, http://techmetals.com/EngineeredFinishes/TM117p.pdf
[17] Teadit N. A. http://www.teadit-na.com/teadit.htm
[18] M. S. Peters, K. D. Timmerhaus, and R. E. West, Plant Design and Economics for Chemical Engineers, 5th ed., McGraw Hill, New York, 2003.
[19] J. B. Dolloff, N. H. Metzger and L. H. S. Roblee, Jr., Dropwise condensation of steam at elevated pressures, Chem. Eng. Sci., 24 (1969) 571-583.
[20] J. W. Rose, Dropwise condensation theory and experiment: a review, Journal of Power and Energy, 16 (2002) 115-128.
[21] X. Ma, D. Xu, J. Lin, Catastrophe characteristics of the condensation and pool boiling phenomena, Int. J. Heat and Mass Transfer, 37 (1993) 533-535.
[22] J. N. Balaraju, T. S, N. Sankara Narayanan, S. K. Seshadri, Electroless Ni—P composite coatings, Journal of Applied Electrochemistry, 33, (2003) 807-816.
[23] J. N. Balaraju, K. S. Rajam, Electroless Deposition and Characterization of High Phosphorus Ni—P—Si3N4 Composite Coatings, Int. J. Electrochem. Sci., 2 (2007) 747-761.
[24] A. Ramalhoa, J. C. Miranda, Friction and wear of electroless NiP and NiP+PTFE coatings, Wear, 259 (2005) 828-834.
[25] Telephone conversation with Bill Naschak, Engineering Manager of Endura Coatings. www.enduracoatings.com
[26] Q. Zhao, Effect of surface free energy of graded Ni—P-PTFE coatings on bacterial adhesion, Surface & Coatings Technology, 185 (2004) 199-204
[27] G. Kear, B. D. Barker, F. C. Walsh, Electrochemical corrosion of unalloyed copper in chloride media-a critical review, Corrosion Science, 46 (2004) 109-135.
[28] M. Izumi, S. Kumagai, R. Shimada, N. Yamakawa, Heat transfer enhancement of dropwise condensation on a vertical surface with round shaped grooves, Experimental Thermal and Fluid Science, 28 (2004) 243-248
[29] J. W. Rose, Condensation heat transfer fundamentals, Trans IChemE 76 (1998) 143-152.
[30] C-H, Chen, Q Cai, C Tsai, C-L Chen, G Xiong, Y Yu, and Z. Ren, Dropwise condensation on superhydrophobic surfaces with two-tier roughness, Applied Physics Letters 90, 173108 2007.
[31] M. Murphey, A. Rabroker, M. Holtzapple, 30-hp Desalination Compressor, Final Report, StarRotor Corporation, 1805 Southwood Dr. College Station, Tex. 77840.
[32] Q. Zhao, Y. Liu, Electroless Ni—Cu—P-PTFE composite coatings and their anticorrosion properties, Surface and coatings Technology 200 (2005) 2510-2514
[33] Titanium Metals Corporation, Titanium, Products and Applications. November 2004, http://www.timet.com/fab-p09.htm.
[34] Z. Yang, H. Xu, Y-L. Shi, M-K. Li, Y. Huang, H-L. Li, The Fabrication and corrosion behavior of electroless Ni—P—carbon nanotube composite coatings, Materials Research Bulleting 40 (2005) 1001-1009.
[35] A. Misra, J. Giri, C. Daraio, Hydrogen evolution on hydrophobic aligned carbon nanotube, American. Chemical Society Vol. 3 No. 12 (2009) 3903-3908.
[36] Y. C. Hong, D. H. Shin, S. C. Cho, H. S. Uhm, Surface transformation of carbon nanotube powder into super-hydrophobic and measurement of wettability, Chemical Physics Letters 427 (2006) 390-393.
[37] L. Liu, J. Zhao, P. Culligan, Y. Qiao, X. Chen, Thermally Responsive Fluid Behaviors in Hydrophobic Nanopores, American Chemical Society. Langmuir 25(19) (2009) 11862-11868.
[38] http://repository.tamu.edu/bitstream/handle/1969.1/3340/etd-tamu-2005C-ITDE-LaraRuiz.pdf;jsessionid=323A4BCA2DC07BAF8282B0C8F23DFAFA?sequence=1
[39] http://www.bod.de/index.php?id=1132&objk_id=197387
[40] http://oai.dtic.mil/oai/oai?verb=getRecord&metadataPrefix=html&identifier=ADA085052
[41] Sahoo P., Kalyan Das S. Tribology of electroless nickel coatings. Materials and Design, 32: 1760-1775 (2011).
[42] Delaunois F., Petitjean J. P., Lienard P, Jacob-Duliere M., Autocatalytic electroless nickel-boron plating on light alloys. Surface Coatings Technology 124 (2-3): 201-9 (2000).
[43] Anik M, Korpe E., Sen E., Effecet of coating bath composition on the properties of electroless nickel boron films. Surface Coatings Technology 202(9): 1718-27 (2008).
[44] Ying H. J. Yan M. Ma T. Y. Wu J. M. Yu L. Q. Effects of NH4F on the deposition rate and buffering capabilities of electroless Ni—P platiing solution. Surface Coatings Technolgy 202 (2): 217-21 (2008).
[45] Eolansezhian R, Ramamoorthy B, Kesavan Nair P, Effect of surfactants on the mechanical propoerties of electroless (Ni—P) coating. Surface Coatings Technology 203(5-7): 709-12 (2008).
[46] Elansezhian R, Ramamoorthy B, Nair P K, The influence of SDS and CTAB surfactants on the surface morphology and surface topography of electroless Ni—P deposits. Journal of Materials Processing Technology, 209(1): 233-40 (2009).
[47] Ashssi-Sorhabi H, Rafizadeh S H, Effect of coating time and heat transfer on structures and corrosion characteristics of electroless Ni—P alloy deposits. Surface Coatings Technology 176(3): 318-26 (2003).
[48] Krishnaveni K, Sankara Narayanan T S N, Seshadri S K, Electroless Ni—B coatings; preparation and evaluation of hardness and wear resistance. Surface Coatings Technology 190(1): 115-21 (2005).
[49] Kanta A F, Vitry V, Delaunois F, Effect of thermochemical and heat treatment on structures and corrosion characteristics of electroless nickel-boron. Matterials Letters 63(30): 2662-5 (2009).

### REFERENCES FOR TABLES 1 And 5

1. Q. Zhao, Y. Liu, Investigation of graded Ni—Cu—P-PTFE composite coatings with antiscaling properties, Applied Surface Science 229 (2004) 56-62.
2. Q. Zhao, Y. Liu, S. Wang, Surface modification of water treatment equipment for reducing CaSO₄ scale formation, Desalination 180 (2005) 133-138.
3. Muller, V. Berndt, Theoretical and experimental study on dropwise condensation in plate heat exchangers. 5th European Thermal-Sciences Conference, The Netherlands, 2008
4. Q. Zhao, H. Muller, Graded Ni—P-PTFE coatings and their potential applications. Surface and Coatings Technology 155 (2002) 279-284
5. Q. Zhao, Y. Liu Development and evaluation of Ni—Cu—P-PTFE composite coatings to minimize microbial adhesion. ECI Symposium Series, Volume RP2: Proceedings of 6th International Conference on Heat Exchanger Fouling and Cleaning, Germany, Jun. 5-10, 2005
6. A. Ramalhoa, J. C. Miranda Friction and wear of electroless NIP-PTFE coatings, Wear, 259 (2005) 828-834.
7. A. Leipertz, A. P. Froba, Improvement of condensation heat transfer by surface modifications. Heat Transfer Engineering, 29(4):343-356, 2008
8. S. Balasubramanian, V. M. Puri, Thermal energy savings in pilot-scale plate heat exchanger system during product processing using modified surfaces. Journal of Food Engineering 91 (2009) 608-611
9. Q. Zhao, Y. Liu, E. W. Abel, Effect of Cu content in electroless Ni—Cu—P-PTFE composite coatings on their anti-corrosion properties. Materials Chemistry and Physics 87 (2004) 332-335

### REFERENCES FOR TABLE 2

a. Q. Zhao, Y. Liu, “Electroless Ni—Cu—P-PTFE composite coatings and their anticorrosion properties” Surface & Coatings Technology 200 (2005) 2510-2514
b. Y. Z. Zhang, Y. Y. Wu, K. N. Sun, M. Yao, “Characterization of electroless Ni—P-PTFE composite deposits”. Journal of Materials Science Letters 17 (1998) 119-122

Various dimensions, sizes, quantities, volumes, rates, and other numerical parameters and numbers have been used for purposes of illustration and exemplification of the principles of the invention, and are not intended to limit the invention to the numerical parameters and numbers illustrated, described or otherwise stated herein. Likewise, unless specifically stated, the order of steps is not considered critical. The different teachings of the embodiments discussed below may be employed separately or in any suitable combination to produce desired results.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide exemplary, procedural or other details supplementary to those set forth herein.

What is claimed is:

1. A heat exchanger comprising
at least one pipe having a centerline, an inlet and an outlet; and
a multiplicity of tubes, wherein each tube comprises a centerline, an inner surface, an outer surface, and groves in the direction of the centerline of the tubes;
wherein the multiplicity of tubes are placed inside said pipe and the centerline of each tube is perpendicular to the centerline of said pipe.

2. The heat exchanger of claim 1 wherein the thickness of the tube wall is no greater than 0.01 inch.

3. The heat exchanger of claim 1 wherein the pipe is set up horizontally.

4. The heat exchanger of claim 1 comprising a multiplicity of baffles wherein the spacing between the baffles decreases in the direction of from the inlet to the outlet of the pipe.

5. The heat exchanger of claim 1 wherein said tubes are made of a metal or alloy with a thermal conductivity that is no less than that of copper.

6. The heat exchanger of claim 1 further comprising a galvanic protection mechanism.

7. The heat exchanger of claim 1 further comprising a hydrophobic coating on the outer surface of each of the tubes or on both the inner surface and the outer surface of each of the tubes.

8. The heat exchanger of claim 7 wherein said hydrophobic coating comprises electroless nickel (Ni) or carbon nanotubes or both.

9. The heat exchanger of claim 8 wherein said hydrophobic coating further comprises Teflon (PTFE), phosphorous (P), boron (B), boron nitride (BN), silica (Si), or combinations thereof.

10. The heat exchanger of claim 7 wherein said hydrophobic coating comprises Ni-PTFE, Ni—P-PTFE, Ni—B-PTFE, Ni—P—BN, or Ni—B—BN.

11. The heat exchanger of claim 1 further comprising a jet ejector.

12. The heat exchanger of claim 11 wherein said jet ejector is on the liquid-phase side.

13. The heat exchanger of claim 1 further comprising inflatable seals.

14. The heat exchanger of claim 1 wherein the inner surface of said tubes comprises sand-blasted surface.

15. The heat exchanger of claim 1 further comprising boiling chips placed inside of the tubes during use of the heat exchangers.

16. The heat exchanger of claim 1 comprising both the sand-blasted surface on the inner surface of the tubes and the boiling chips during use.

17. The heat exchanger of claim 1 further comprising a multiplicity of fittings configured to attach each of the tubes to a tube sheet, wherein said fitting comprises
an attaching mechanism configured to attach said fitting to each of said tubes; and
a penetration mechanism configured to penetrate said tube sheet, wherein said penetration mechanism comprises a sealing mechanism and a securing mechanism.

18. The heat exchanger of claim 1 wherein said tubes are replaced with plates having a top surface and a bottom surface.

19. The heat exchanger of claim 18 wherein said plates have dimples.

20. The heat exchanger of claim 18 further comprising a hydrophobic coating on the top surface or on both the top surface and the bottom surface of each of said plates.

21. The heat exchanger of claim 18 wherein the bottom surface of each of said plates comprises sand-blasted surface.

22. The heat exchanger of claim 1 further comprising a nucleation promoter.

23. The heat exchanger of claim 22 wherein said nucleation promoter comprises a salt nucleation promoter or a sugar nucleation promoter.

24. A heat exchange system comprising the heat exchanger of claim 1, wherein said heat exchanger is configured to receive an incoming feed stream and to discharge a vapor stream.

25. The heat exchange system of claim 24 further comprising a nucleation promoter fluidly connected to said heat exchanger.

26. The heat exchange system of claim 24 further comprising a filter utilized in conjunction with said boiling chips.

27. The heat exchange system of claim 24 wherein at least a portion of the discharged vapor stream exchanges heat with the incoming feed stream or is mixed with the incoming feed stream or both.

28. The heat exchange system of claim 24 further comprising a jet ejector configured to promote vapor circulation.

29. The heat exchange system of claim 24 further comprising a preheater configured to receive said incoming feed stream upstream of said heat exchanger and to receive the discharged vapor stream from said heat exchanger, wherein said incoming feed stream is heated by the discharged vapor stream.

30. A process wherein the heat exchanger of claim 1 is utilized.

31. The process of claim 30, comprising the separation of a volatile component from a non-volatile component in a mixture.

32. The process of claim 31 wherein said non-volatile component comprises a salt or a sugar.

33. The process of claim 31 wherein said volatile component comprises water.

34. The process of claim 30 wherein dropwise condensation takes place.

35. The process of claim 30 wherein desalination takes place.

36. The process of claim 30 comprising liquid-gas separation.

37. A method of using a heat exchanger,
wherein an aqueous solution and steam are present in said heat exchanger;
wherein said heat exchanger comprises a hydrophobic coating; and
wherein the operating pressure of the heat exchanger is greater than 50 psia.

38. The method of claim 37 wherein said hydrophobic coating comprises electroless nickel (Ni) or carbon nanotubes or both.

39. The method of claim 37 wherein said hydrophobic coating is exposed to the steam in the heat exchanger.

40. The method of claim 37 wherein said hydrophobic coating promotes drop-wise condensation.

41. The method of claim 37 further comprising utilizing a nucleation promoter.

42. The method of claim 37 further comprising utilizing boiling chips in conjunction with a filter.

43. The method of claim 37 further comprising
discharging steam from the heat exchanger; and
utilizing at least a portion of said discharged steam to preheat the aqueous solution or mixing at least a portion of said discharged steam with the aqueous solution or both.

44. The method of claim 37 further comprising utilizing a jet ejector on the solution side or a jet ejector to promote steam circulation or both.

45. A method of using a heat exchanger,
wherein a vapor phase and a liquid phase are present in said heat exchanger;
wherein said heat exchanger comprises a hydrophobic coating; and
wherein the overall heat exchange coefficient is greater than 3000 Btu/(h·ft²·° F.).

46. The method of claim 45 wherein said hydrophobic coating comprises electroless nickel (Ni) or carbon nanotubes or both.

47. The method of claim 45 wherein said heat exchanger comprises a multiplicity of tubes or plates.

48. The method of claim 47 wherein said tubes or plates are made of copper.

49. The method of claim 45 wherein the hydrophobic coating is exposed to the vapor phase in the heat exchanger.

50. The method of claim 45 wherein said hydrophobic coating promotes drop-wise condensation.

51. The method of claim 45 further comprising utilizing a nucleation promoter.

52. The method of claim 45 further comprising utilizing boiling chips in conjunction with a filter.

53. The method of claim 45 further comprising
discharging a vapor stream from the heat exchanger; and
utilizing at least a portion of said discharged vapor stream to preheat the liquid phase or mixing at least a portion of said discharged steam with the liquid phase or both.

54. The method of claim 45 further comprising utilizing a jet ejector on the liquid-phase side or a jet ejector to promote vapor circulation or both.
